(19) United States
(12) Patent Application Publication
(10) Pub. No.: US 2018/0338881 A1
(43) Pub. Date: Nov. 29, 2018

(54) ASSIST DEVICE

(71) Applicant: JTEKT CORPORATION, Osaka-shi (JP)

(72) Inventors: Kazuyoshi OHTSUBO, Chiryu-shi (JP); Hiromichi OHTA, Kariya-shi (JP); Hisataka SATO, Toyota-shi (JP)

(73) Assignee: JTEKT CORPORATION, Osaka-shi (JP)

(21) Appl. No.: 15/987,465

(22) Filed: May 23, 2018

(30) Foreign Application Priority Data
May 26, 2017 (JP) 2017-105013
Nov. 10, 2017 (JP) 2017-217563

(51) Int. Cl. A61H 1/02

(52) U.S. Cl. CPC A61H 1/0262; A61H 2201/1207; A61H 2201/5069; A61H 2201/1652; A61H 2201/5007; A61H 2201/1463

(57) ABSTRACT

An assist device includes a body wearing unit configured to be worn on a body of a user including a region around an assist target body part of the user; and an actuator unit configured to be attached to the body wearing unit and to the assist target body part so as to assist a motion of the assist target body part. The body wearing unit includes a main frame having a pivot shaft portion, and a sub-frame connected to the pivot shaft portion and configured to pivot around an axis of the pivot shaft portion. The sub-frame is pivotable so as to fit a body size of the user.

### INCORPORATION BY REFERENCE

The disclosure of Japanese Patent Application No. 2017-217563 filed on Nov. 10, 2017 including the specification, drawings and abstract is incorporated herein by reference in its entirety.

### BACKGROUND

### 1. Technical Field

The disclosure relates to an assist device that assists the motion of an assist target body part of a user.

### 2. Description of Related Art

For example, a motion assist device described in Japanese Unexamined Patent Application Publication No. 2015-208795 (JP 2015-208795 A) includes a back face frame extending along the up-down direction of the back of a user, and a waist support portion provided below the back face frame so as to surround the waist side parts and the waist rear part of the user. Shoulder belts are provided in the upper end of the back face frame, and a waist belt is provided inside the waist support portion. Further, a crotch structure disposed at the crotch of the user is connected to the lower part of the rear side of the waist support portion. Thigh restraining portions operating to restrain the front sides of the thighs of the user are attached to the right and left sides of the waist support portion.

### SUMMARY

In the motion assist device described in JP 2015-208795 A, the shape of the waist support portion is fixed. Therefore, in a case where the user has a small body size or the user is slender, the waist support portion cannot be closely fitted to the user. As a result, a gap may be formed between the waist support portion and the waist of the user (that is, between the thigh restraining portion and the waist of the user), and thus, the motion assist device may be displaced with respect to the body of the user in various directions. As a result, the assist torque cannot be transmitted efficiently.

The disclosure provides an assist device that is closely fitted to the body of a user more appropriately so as to transmit an assist torque efficiently.

An aspect of the disclosure relates to an assist device including a body wearing unit configured to be worn on a body of a user including a region around an assist target body part of the user; and an actuator unit configured to be attached to the body wearing unit and to the assist target body part so as to assist a motion of the assist target body part. The body wearing unit includes a main frame having a pivot shaft portion, and a sub-frame connected to the pivot shaft portion and configured to pivot around an axis of the pivot shaft portion. The sub-frame is pivotable so as to fit a body size of the user.

In the configuration, the sub-frame pivots relative to the main frame so as to fit the body size of the user. Thus, the assist device can be closely fitted to the body of the user more appropriately, and accordingly, the assist torque can be transmitted efficiently.

In the above-described aspect, the main frame may include a right pivot shaft portion as the pivot shaft portion disposed at a right side of a back side of the user, and a left pivot shaft portion as the pivot shaft portion disposed at a left side of the back side of the user; the sub-frame may include a right sub-frame connected to the right pivot shaft portion and a left sub-frame connected to the left pivot shaft portion; and the sub-frame may be pivotable so as to fit a width of a waist of the user.

In the configuration, the right sub-frame is provided on the right side of the main frame, the left sub-frame is provided on the left side of the main frame, and the right sub-frame and the left sub-frame pivot relative to the main frame so as to fit the width of the waist of the user. Thus, the assist device can be closely fitted to the body (in this case, the waist) of the user more appropriately.

In the above-described aspect, the actuator unit may include a right actuator unit to be worn on the assist target body part at a right side of the user, and a left actuator unit to be worn on the assist target body part at a left side of the user; the right sub-frame may be configured such that a first end portion of the right sub-frame is connected to the right pivot shaft portion and a second end portion of the right sub-frame is provided with a right sub pivot shaft portion; the right actuator unit may be connected to the right sub pivot shaft portion via a right connecting portion configured to pivot around a pivot axis of the right sub pivot shaft portion; the left sub-frame may be configured such that a first end portion of the left sub-frame is connected to the left pivot shaft portion and a second end portion of the left sub-frame is provided with a left sub pivot shaft portion; and the left actuator unit may be connected to the left sub pivot shaft portion via a left connecting portion configured to pivot around a pivot axis of the left sub pivot shaft portion.

In the configuration, when the right sub-frame and the left sub-frame are caused to pivot in accordance with the width of the waist of the user, the orientation of the right actuator unit and the orientation of the left actuator unit can be set to desired orientations.

In the above-described aspect, the actuator unit may include a right actuator unit to be worn on the assist target body part at a right side of the user, and a left actuator unit to be worn on the assist target body part at a left side of the user; the right sub-frame may be configured such that a first end portion of the right sub-frame is connected to the right pivot shaft portion and the right actuator unit is connected to a second end portion of the right sub-frame; the right actuator unit may be fixed to the right sub-frame without pivoting relative to the right sub-frame; the left sub-frame may be configured such that a first end portion of the left sub-frame is connected to the left pivot shaft portion and the left actuator unit is connected to a second end portion of the left sub-frame; and the left actuator unit may be fixed to the left sub-frame without pivoting relative to the left sub-frame.

In the configuration, the right actuator unit does not pivot relative to the right sub-frame, and the left actuator unit does not pivot relative to the left sub-frame. Accordingly, it is possible to prevent a decrease in transmission efficiency due to unnecessary pivoting of the right actuator unit and the left actuator unit at the time when the assist torque is transmitted.

In the above-described aspect, the right pivot shaft portion that allows the right sub-frame to pivot relative to the main frame and the left pivot shaft portion that allows the left sub-frame to pivot relative to the main frame may be cylindrical dampers each of which is configured to pivot when a load equal to or greater than a load threshold set in advance is input.

In the configuration, a load equal to or greater than the load threshold is required to cause the right sub-frame to pivot relative to the main frame and a load equal to or greater than the load threshold is required to cause the left sub-frame to pivot relative to the main frame. Accordingly, it is possible to prevent a decrease in transmission efficiency due to unnecessary pivoting of the right sub-frame and the left sub-frame at the time when the assist torque is transmitted.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view for illustrating an example of the overall configuration of an assist device of a first embodiment;

FIG. 2 is a perspective view for illustrating an example of the external appearance of a body wearing unit in the assist device illustrated in FIG. 1;

FIG. 3 is a perspective view for illustrating an example of the external appearance of an actuator unit in the assist device illustrated in FIG. 1;

FIG. 4 is a perspective view for illustrating an example of the external appearance of a frame portion that is a constituent of the body wearing unit;

FIG. 5 is an exploded perspective view for illustrating the structure of the frame portion;

FIG. 6 is a view for illustrating a state where a right sub-frame and a left sub-frame are caused to pivot in accordance with the waist width of the user;

FIG. 7 is a perspective view for illustrating an example of the external appearance of a waist support portion that is a constituent of the body wearing unit;

FIG. 8 is a developed view for illustrating an example of the structure of the waist support portion;

FIG. 9 is a view for illustrating positions of a side upper belt and a side lower belt of the waist support portion with respect to the right top portion of the pelvis of the user;

FIG. 10 is a view for illustrating positions of a rear upper belt, a rear middle belt, and a rear lower belt of the waist support portion with respect to the buttocks of the user;

FIG. 11 is a perspective view for illustrating an example of the external appearance of a back pack portion that is a constituent of the body wearing unit;

FIG. 12 is a perspective view for illustrating an example of the external appearance in a state where a jacket portion that is a constituent of the body wearing unit is connected to the back pack portion;

FIG. 13 is a developed view for illustrating an example of the structure of the jacket portion;

FIG. 14 is a view for illustrating a belt pulling state in which a first example of the jacket portion is closely fitted to the user;

FIG. 15 is a view for illustrating a belt pulling state in which a second example of the jacket portion is closely fitted to the user;

FIG. 16 is a view for illustrating that a thigh wearing portion can move up and down or right and left in a first example of an actuator unit;

FIG. 17 is a perspective view for illustrating a second example of the actuator unit;

FIG. 18 is a view for illustrating that the thigh wearing portion can move up and down or right and left in the second example of the actuator unit;

FIG. 19 is an exploded perspective view for illustrating an example of the internal structure of the actuator unit;

FIG. 20 is a sectional view for illustrating an example of the internal structure of the actuator unit;

FIG. 21 is a sectional view of the assist device taken along a ZY plane passing through a virtual pivot axis and is a sectional view for illustrating an example of the structure of a pivot mechanism;

FIG. 22 is a view for illustrating a state in which a user wearing the assist device stretches the back muscles;

FIG. 23 is a view for illustrating a state in which the user takes a forward-bent posture from the state illustrated in FIG. 22 so that a frame portion and an upper half body wearing portion are caused to pivot around the virtual pivot axis;

FIG. 24 is a view for illustrating the input and output of a control device;

FIG. 25 is a control block diagram of the control device when the kind of motion is “object lift-up/lift-down” or “moving object laterally”;

FIG. 26 is a control block diagram of the control device, when the kind of motion is “walking”;

FIG. 27 is a flowchart for illustrating the entire processing sequence based on the control block diagrams illustrated in FIGS. 25 and 26;

FIG. 28 is a flowchart for illustrating details of “PROCESSING OF INPUT SIGNALS AND SO ON FOR RIGHT ACTUATOR UNIT” in the flowchart illustrated in FIG. 27;

FIG. 29 is a flowchart for illustrating details of “PROCESSING OF INPUT SIGNALS AND SO ON FOR LEFT ACTUATOR UNIT” in the flowchart illustrated in FIG. 27;

FIG. 30 is a flowchart for illustrating details of “WALKING/WORK DETERMINATION” in the flowchart illustrated in FIG. 27;

FIG. 31 is a flowchart for illustrating details of “CALCULATE RIGHT γ” in the flowchart illustrated in FIG. 27;

FIG. 32 is a flowchart for illustrating details of “CALCULATE RIGHT τₛₛ(t)” in the flowchart illustrated in FIG. 27;

FIG. 33 is a view for illustrating an effect of “CALCULATE RIGHT γ” illustrated in FIG. 31;

FIG. 34 is a view for illustrating an effect of “CALCULATE RIGHT τₛₛ(t)” illustrated in FIG. 32;

FIG. 35 is a perspective view for illustrating an example of the overall configuration of an assist device of a second embodiment;

FIG. 36 is a view for illustrating an example in which a right armpit belt and a left armpit belt in a jacket portion of the assist device illustrated in FIG. 35 are changed to a close contact belt around the trunk part of the user;

FIG. 37 is a perspective view for illustrating an example of the external appearance of a body wearing unit in the assist device illustrated in FIG. 35;

FIG. 38 is a perspective view for illustrating an example of the external appearance of an actuator unit in the assist device illustrated in FIG. 35;

FIG. 39 is an exploded perspective view of the assist device illustrated in FIG. 35;

FIG. 40 is a perspective view for illustrating a frame portion in the assist device illustrated in FIG. 35;

FIG. 41 is a developed view for illustrating an example of the structure of a waist support portion in the assist device illustrated in FIG. 35;

FIG. 42 is an enlarged view for illustrating a back pack portion and a region around the back pack portion in the assist device illustrated in FIG. 35;

FIG. 43 is an enlarged view for illustrating the back pack portion and a jacket portion, and a region around the back pack portion and the jacket portion in the assist device illustrated in FIG. 35;

FIG. 44 is a developed view for illustrating an example of the structure of the jacket portion in the assist device illustrated in FIG. 35;

FIG. 45 is a perspective view of the actuator unit (a third example) in the assist device illustrated in FIG. 35;

FIG. 46 is a perspective view for illustrating a fourth example of the actuator unit;

FIG. 47 is a perspective view for illustrating the structure around a thigh wearing portion (a body holding portion);

FIG. 48 is a view for illustrating an example in which a below-knee belt is added to the body holding portion illustrated in FIG. 47;

FIG. 49 is a view for illustrating an example in which a third joint portion of the thigh wearing portion (the body holding portion) is disposed on the front face of the thigh of the user;

FIG. 50 is a view for illustrating an example in which the third joint portion of the thigh wearing portion (the body holding portion) is disposed on the outer side face of the thigh of the user; and

FIG. 51 is a view for illustrating an example in which the third joint portion of the thigh wearing portion (the body holding portion) is disposed on the back face of the thigh of the user.

### DETAILED DESCRIPTION OF EMBODIMENTS

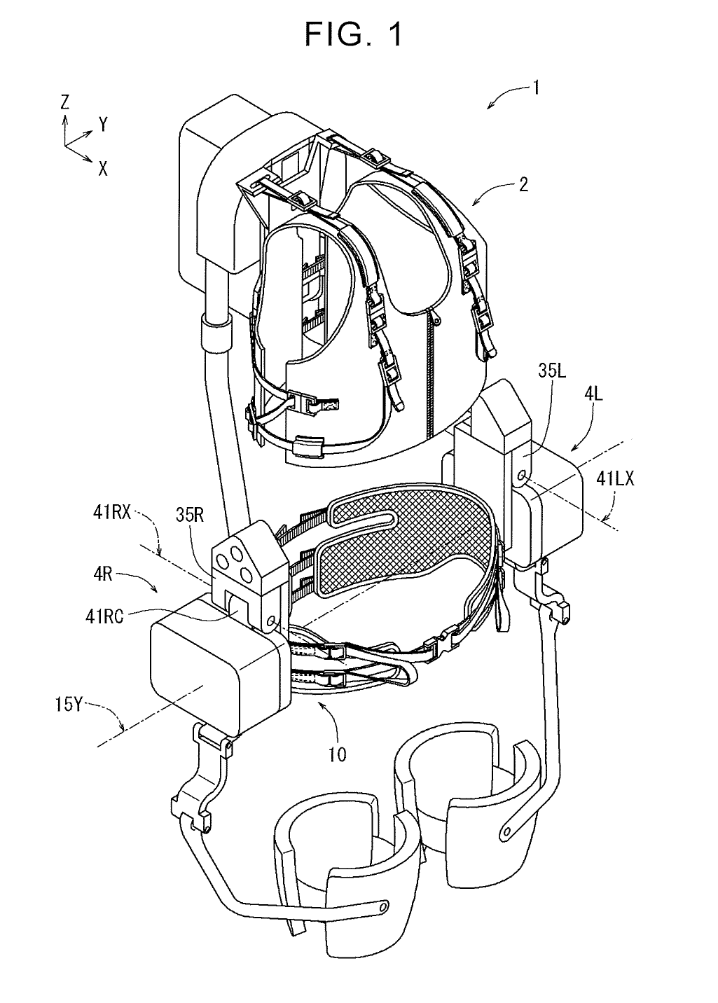

Hereinbelow, the overall structure of an assist device 1 according to a first embodiment will be described with reference to FIGS. 1 to 21. The assist device 1 is, for example, a device that assists pivoting of the thighs relative to the waist when a user lifts up an object (for example, a parcel or baggage) or when the user walks. In the drawings, X-, Y-, and Z-axes are perpendicular to each other, and when viewed from the user wearing the assist device, the X-axis direction corresponds to a forward direction, the Y-axis direction to a leftward direction, and the Z-axis direction to an upward direction.

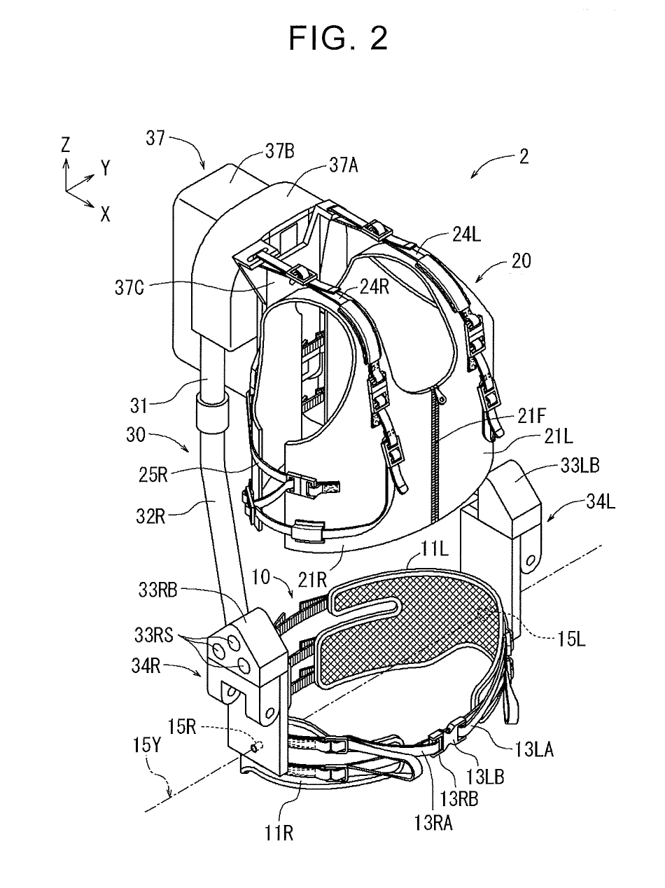

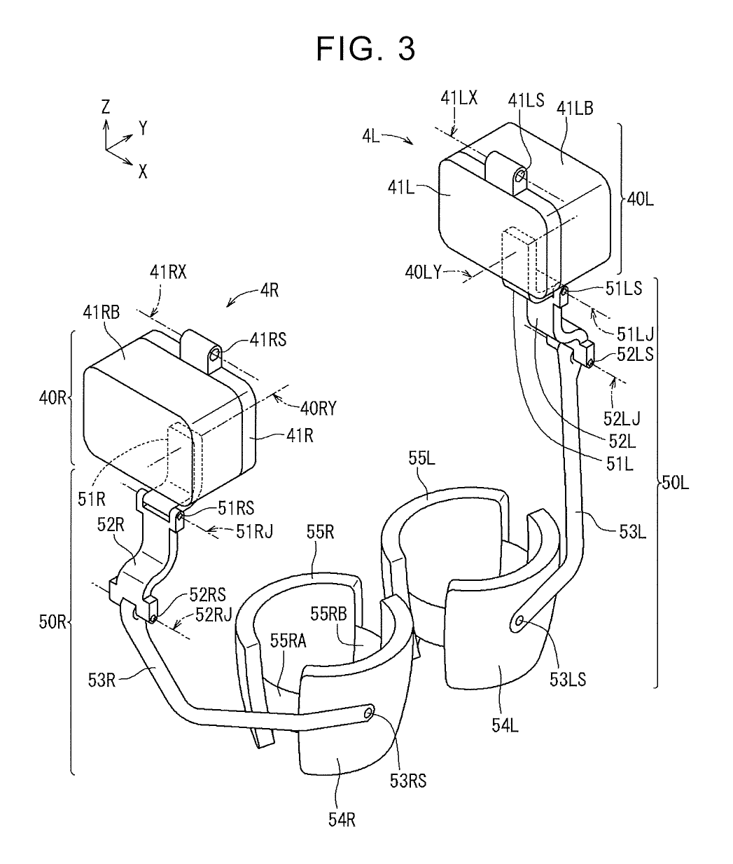

FIG. 1 illustrates the overall external appearance of the assist device 1 of the first embodiment. The assist device 1 includes a body wearing unit 2 (see FIG. 2), a right actuator unit 4R (see FIG. 3), and a left actuator unit 4L (see FIG. 3). The body wearing unit 2 is configured to be worn on the body including regions around assist target body parts (the thighs in an example of the present embodiment) of the user. The right actuator unit 4R and the left actuator unit 4L are attached to the body wearing unit 2 and to the assist target body parts so as to assist the motion of the assist target body parts. The following describes the body wearing unit 2, the right actuator unit 4R, and the left actuator unit 4L sequentially in this order.

The external appearance of the body wearing unit 2 will be described. As illustrated in FIG. 2, the body wearing unit 2 includes a waist support portion 10 to be worn around the waist of the user, a jacket portion 20 to be worn around the shoulders and the chest of the user, a frame portion 30 configured to connect the waist support portion 10 to the jacket portion 20, and a back pack portion 37 attached to the frame portion 30. The frame portion 30 is disposed around the back and the waist of the user.

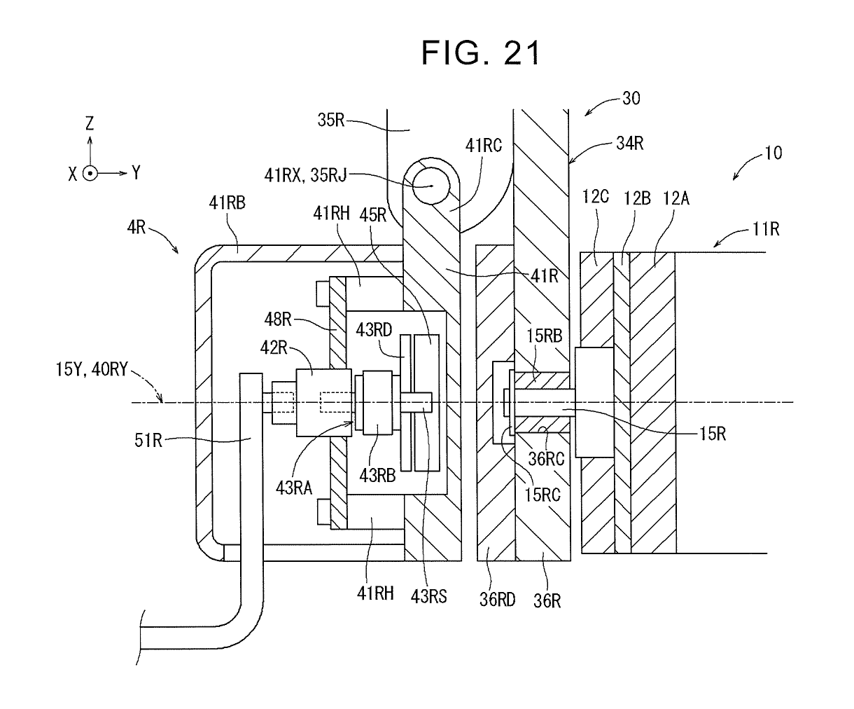

The waist support portion 10 includes a right waist wearing portion 11R to be worn around the waist of the right half of the body of the user, and a left waist wearing portion 11L to be worn around the waist of the left half of the body of the user. Further, as illustrated in FIG. 2, in order to facilitate attaching to and detaching from the user, the right waist wearing portion 11R and the left waist wearing portion 11L respectively include a waist belt holding member 13RB (waist buckle) provided in a length-adjustable right waist fastening belt 13RA and a waist belt holding member 13LB (waist buckle) provided in a length-adjustable left waist fastening belt 13LA. Further, as illustrated in FIG. 2, in the waist support portion 10, a virtual pivot axis 15Y is set so as to extend in the right-left direction of the user at a position in the vicinity of hip joints of the user when the waist support portion 10 is attached to the user. At a crossing position between the virtual pivot axis 15Y and the right waist wearing portion 11R, a pivot shaft portion 15R projecting rightward along the virtual pivot axis 15Y is fixed to a core 12B of the right waist wearing portion 11R (see FIG. 21). Likewise, at a crossing position between the virtual pivot axis 15Y and the left waist wearing portion 11L, a pivot shaft portion 15L projecting leftward along the virtual pivot axis 15Y is fixed to a core of the left waist wearing portion 11L. Note that details of the waist support portion 10 will be described later. Note that the virtual pivot axis 15Y is set at a position between the hip joints and the fifth lumbar vertebra of the user and is kept within a given range by the waist support portion 10.

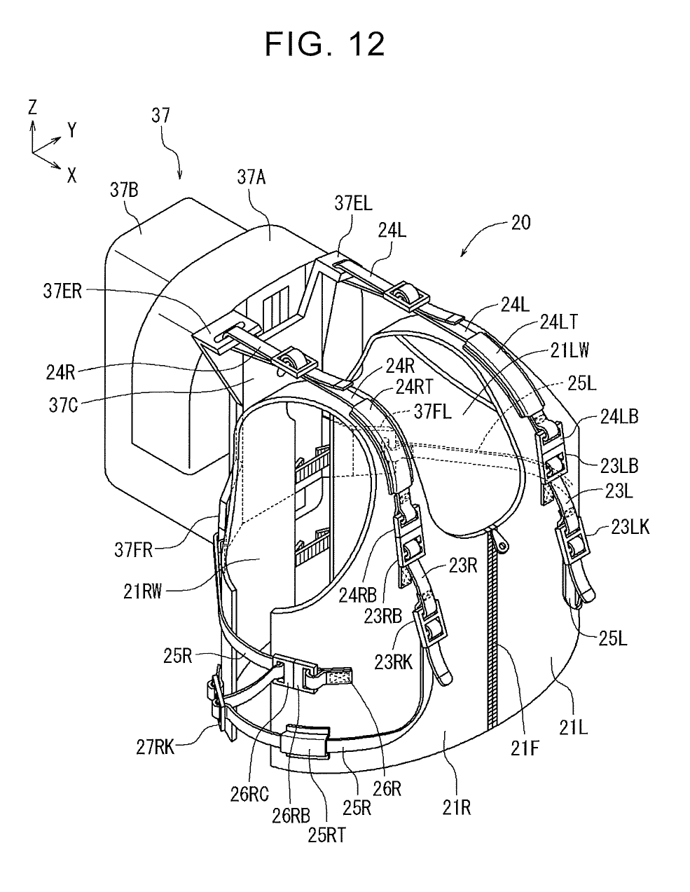

The jacket portion 20 includes a right chest wearing portion 21R to be worn around the chest of the right half of the body of the user, and a left chest wearing portion 21L to be worn around the chest of the left half of the body of the user. The right chest wearing portion 21R is connected to the left chest wearing portion 21L with the use of a fastener 21F, for example, so as to facilitate attaching and detaching of the jacket portion 20 to and from the user. Further, the right chest wearing portion 21R includes a right shoulder belt 24R connected to a back contact portion 37C of the back pack portion 37 fixed to the frame portion 30, and a right armpit belt 25R connected to the back contact portion 37C. Further, the left chest wearing portion 21L includes a left shoulder belt 24L connected to the back contact portion 37C of the back pack portion 37 fixed to the frame portion 30, and a left armpit belt 25L (see FIG. 12) connected to the back contact portion 37C. Note that details of the jacket portion 20 will be described later.

The back pack portion 37 is attached to the upper end of the frame portion 30. The right shoulder belt 24R, the right armpit belt 25R, the left shoulder belt 24L, and the left armpit belt 25L (see FIG. 12) of the jacket portion 20 are connected to the back pack portion 37. Further, a control device including a CPU, a power supply unit, a communication unit, and so on are accommodated in the back pack portion 37. Note that details of the back pack portion 37 will be described later.

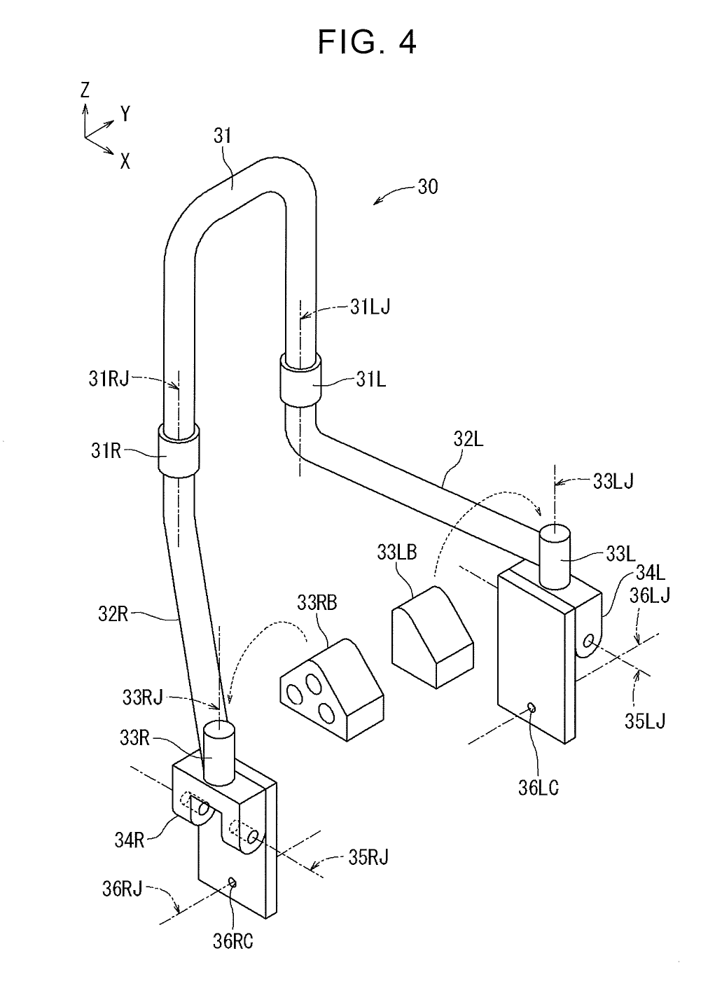

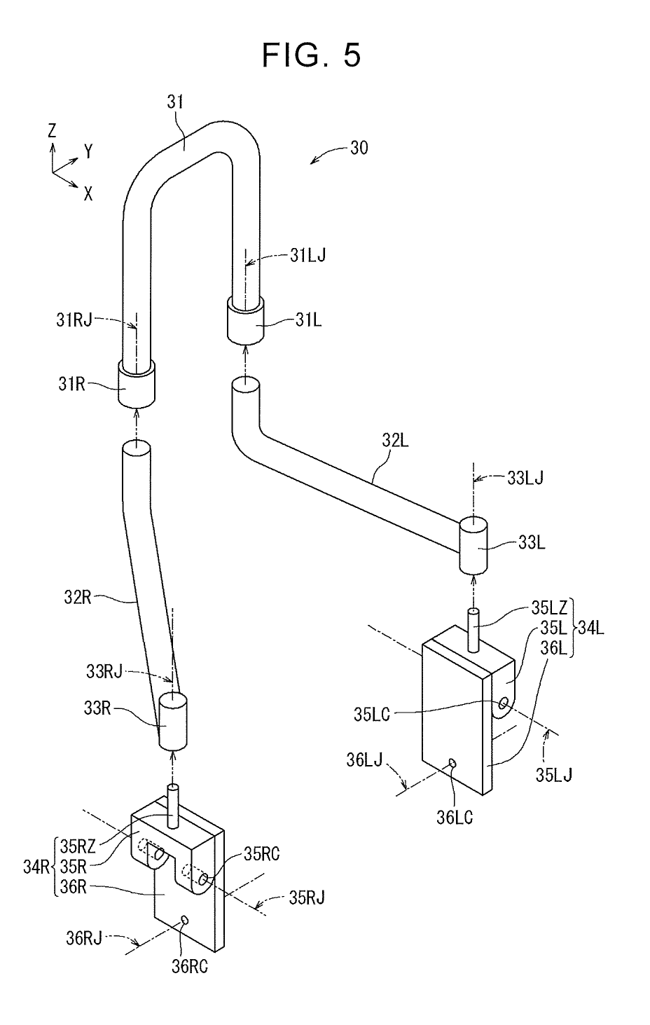

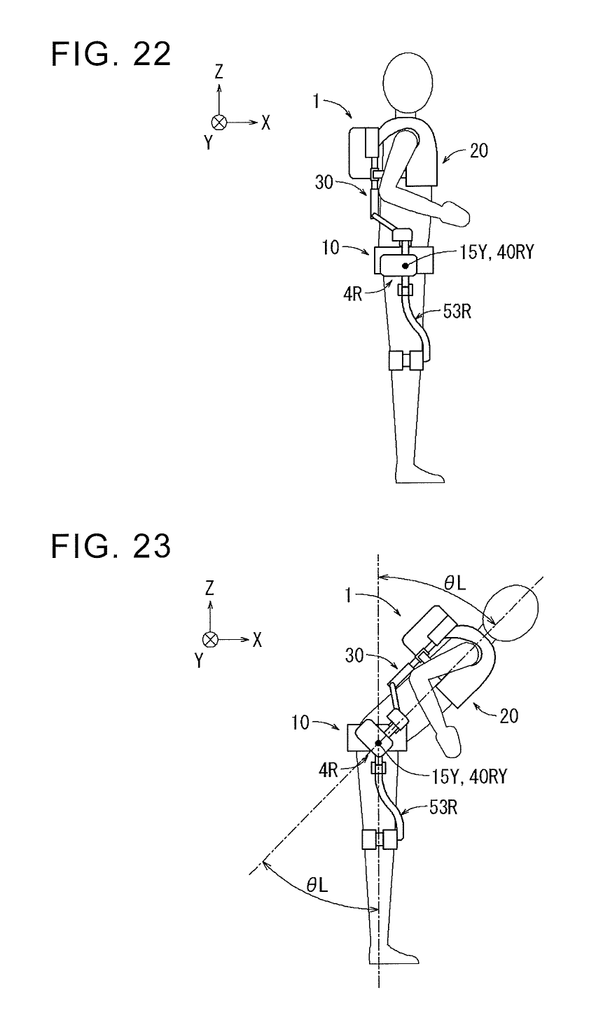

The frame portion 30 includes a main frame 31, a right sub-frame 32R, a left sub-frame 32L (see FIG. 4), a right connecting portion 34R, a left connecting portion 34L, boxes 33RB, 33LB, and so on. As illustrated in FIG. 4, the right sub-frame 32R is connected to the main frame 31 so as to be pivotable, and the right connecting portion 34R is connected to the right sub-frame 32R so as to be pivotable. Similarly, as illustrated in FIG. 4, the left sub-frame 32L is connected to the main frame 31 so as to be pivotable, and the left connecting portion 34L is connected to the left sub-frame 32L so as to be pivotable. Further, the pivot shaft portion 15R (see FIGS. 2, 7) is passed through a shaft hole 36RC (see FIGS. 4, 5) of the right connecting portion 34R, and the pivot shaft portion 15L (see FIGS. 2, 7) is passed through a shaft hole 36LC (see FIGS. 4, 5) of the left connecting portion 34L. Thus, the frame portion 30 and the jacket portion 20 (and the back pack portion 37) can pivot around the virtual pivot axis 15Y relative to the waist support portion 10 (see FIGS. 22, 23). Further, the boxes 33RB, 33LB have a plurality of input portions 33RS configured to, for example, provide instructions regarding operation states of the assist device 1, such as ON/OFF of a power supply and an assist multiplying factor of the assist device 1. Note that details of the frame portion 30 will be described later.

The external appearances of the right actuator unit 4R and the left actuator unit 4L will be described. FIG. 3 illustrates the external appearance of the right actuator unit 4R connected to a right motor connecting portion 35R (see FIG. 5) provided below the box 33RB illustrated in FIG. 2 and the external appearance of the left actuator unit 4L connected to a left motor connecting portion 35L (see FIG. 5) provided below the box 33LB. Note that the left actuator unit 4L is bilaterally symmetric to the right actuator unit 4R, and thus, the left actuator unit 4L is not described in the following description.

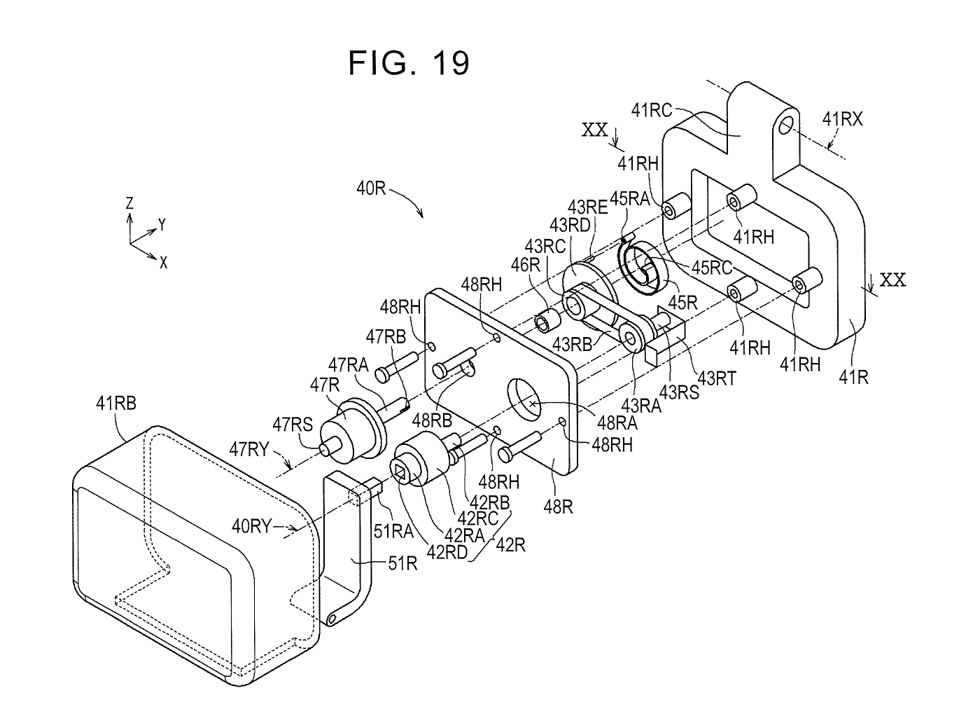

As illustrated in FIG. 3, the right actuator unit 4R includes a torque generating portion 40R and an output link 50R as a torque transmitting portion. The torque generating portion 40R includes an actuator base portion 41R and a cover 41RB. Members housed in the cover 41RB will be described later. As illustrated in FIG. 3, the output link 50R that is a link mechanism of the right actuator unit 4R is attached to the assist target body part so as to pivot around a joint (in this case, the hip joint) of the assist target body part (in this case, the thigh). Note that an assist torque assisting the pivoting of the assist target body part via the output link 50R (50L) is generated by an electric motor 47R (corresponding to an actuator) having an output shaft 47RA in the torque generating portion 40R, as illustrated in FIG. 19.

The output link 50R includes an assist arm 51R (corresponding to a first link), a second link 52R, a third link 53R, and a thigh wearing portion 54R (corresponding to a body holding portion). The assist arm 51R is caused to pivot around a pivot axis 40RY by a combined torque obtained by combining an assist torque generated by the electric motor in the torque generating portion 40R and a user torque generated by the motion of the thigh of the user. A first end portion of the second link 52R is connected to a distal end portion of the assist arm 51R so as to be pivotable around a pivot axis 51RJ, and a first end portion of the third link 53R is connected to a second end portion of the second link 52R so as to be pivotable around a pivot axis 52RJ. The thigh wearing portion 54R is connected to a second end portion of the third link 53R via a third joint portion 53RS (in this case, a spherical joint).

Next, details of the structure of the frame portion 30 will be described with reference to FIGS. 4 to 6. The main frame 31 has a reverse U-shape and includes a connecting portion 31R (corresponding to a right pivot shaft portion) disposed on the right waist on the back side of the user, and a connecting portion 31L (corresponding to a left pivot shaft portion) disposed on the left waist on the back side of the user. Each of the right sub-frame 32R and the left sub-frame 32L has a bar shape partially bent. As illustrated in FIGS. 4 and 5, a first end portion of the right sub-frame 32R is connected to the connecting portion 31R in a first end portion of the main frame 31 so as to be pivotable around a pivot axis 31RJ. Further, a first end portion of the left sub-frame 32L is connected to the connecting portion 31L in a second end portion of the main frame 31 so as to be pivotable around a pivot axis 31LJ. Further, a right connecting shaft 35RZ of the right connecting portion 34R is connected to a connecting portion 33R (corresponding to a right sub pivot shaft portion) in a second end portion of the right sub-frame 32R so as to be pivotable around a pivot axis 33RJ. Further, a left connecting shaft 35LZ of the left connecting portion 34L is connected to a connecting portion 33L (corresponding to a left sub pivot shaft portion) in a second end portion of the left sub-frame 32L so as to be pivotable around a pivot axis 33LJ.

As illustrated in FIG. 5, the right motor connecting portion 35R and a right waist connecting portion 36R are fixed to the right connecting shaft 35RZ. An attachment hole 41RS in the upper end of the right actuator unit 4R illustrated in FIG. 3 is disposed coaxially with an attachment hole 35RC of the right motor connecting portion 35R, and the right actuator unit 4R is attached to the attachment hole 35RC so as to be pivotable around a pivot axis 35RJ (around a pivot axis 41RX in FIG. 3). Similarly, the left motor connecting portion 35L and a left waist connecting portion 36L are fixed to the left connecting shaft 35LZ. An attachment hole 41LS in the upper end of the left actuator unit 4L illustrated in FIG. 3 is disposed coaxially with an attachment hole 35LC of the left motor connecting portion 35L, and the left actuator unit 4L is attached to the attachment hole 35LC so as to be pivotable around a pivot axis 35LJ (around a pivot axis 41LX in FIG. 3). The pivot shaft portion 15R (see FIGS. 2, 21) is passed through the shaft hole 36RC of the right waist connecting portion 36R. Similarly, the pivot shaft portion 15L (see FIG. 2) is passed through the shaft hole 36LC of the left waist connecting portion 36L. Accordingly, the right actuator unit 4R is connected to the connecting portion 33R via the right connecting portion 34R pivoting around the pivot axis 33RJ of the connecting portion 33R. Further, the left actuator unit 4L is connected to the connecting portion 33L via the left connecting portion 34L pivoting around the pivot axis 33LJ of the connecting portion 33L.

Note that, as illustrated in FIG. 21, the pivot shaft portion 15R is fixed to the core 12B of the right waist wearing portion 11R having three layers, i.e., a pad portion 12A, the core 12B, and a cover portion 12C. The pivot shaft portion 15R is passed through the shaft hole 36RC of the right waist connecting portion 36R via a bearing 15RB, and a coming-off preventing ring 15RC is attached to a distal end portion of the pivot shaft portion 15R. Accordingly, an axis 36RJ of the shaft hole 36RC and an axis 36LJ of the shaft hole 36LC illustrated in FIGS. 4 and 5 overlap with the virtual pivot axis 15Y. Further, a cushion 361W is provided between the right waist connecting portion 36R and the actuator base portion 41R. When the assist torque for the user is increased or is changed quickly, the right actuator unit 4R and the left actuator unit 4L may be fixed so as not to pivot around the pivot axes 35RJ, 35LJ. At this time, since the right actuator unit 4R and the left actuator unit 4L are fixed, the cushion 361W may not be provided.

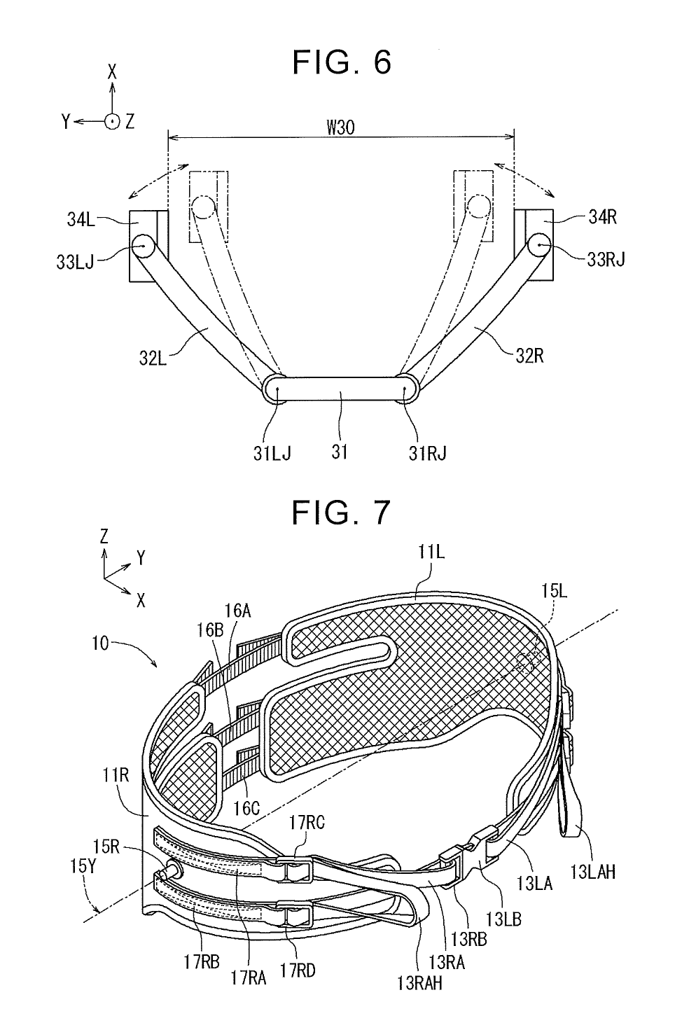

With the configuration, the frame portion 30 is pivotable around the virtual pivot axis 15Y relative to the waist support portion 10 (see FIGS. 22, 23) in FIG. 2. Also, as illustrated in FIG. 6, the right sub-frame 32R is pivotable around the pivot axis 31RJ, and the left sub-frame 32L is pivotable around the pivot axis 31LJ. Therefore, a distance W30 in the right-left direction between the right connecting portion 34R and the left connecting portion 34L can be adjusted freely. Accordingly, the distance W30 can be adjusted in accordance with the waist width of the user, and thus, the assist device 1 can be closely fitted to the body of the user more appropriately. Thus, the assist torque can be transmitted efficiently. Further, the right connecting portion 34R is pivotable around the pivot axis 33RJ and the left connecting portion 34L is pivotable around the pivot axis 33LJ. Accordingly, even if the distance W30 is changed, the swing direction of the assist arm of the right actuator unit (i.e., the direction in which the assist arm of the right actuator unit swings) and the swing direction of the assist arm of the left actuator unit (i.e., the direction in which the assist arm of the left actuator unit swings) can be set to desired directions appropriately. Further, as illustrated in FIG. 6, the main frame 31 is pivotable around the pivot axis 31RJ and pivotable around the pivot axis 31LJ. Accordingly, even if the user twists the upper body to look behind, each of the main frame 31, the right sub-frame 32R, and the left sub-frame 32L can be caused to pivot appropriately so as not to disturb the motion of the user. Further, the space (see FIG. 5) between the pivot axis 31RJ and the pivot axis 31LJ in the main frame 31 expands so as not to disturb the bending motion of the back of the user. The frames, which are disposed on the right and left sides in the space in the main frame 31 so as to be substantially parallel to each other, support the actuator units from right and left of the central part of the back of the user, so as to transmit the assist torque efficiently. Further, the right sub-frame 32R and the left sub-frame 32L curve (in a recessed shape) from the back to the waist of the user so as not to disturb the movement of the elbows and the like of the user (so as not to come into contact with them). Particularly, in an object lift-up/lift-down motion, it is necessary to transmit the assist torque to the back and the legs around the waist efficiently (with a small loss), unlike bipedal upright walking (biped walking performed with the legs and the backbone being erected vertically). The structure of the frame portion 30 can transmit the assist torque efficiently.

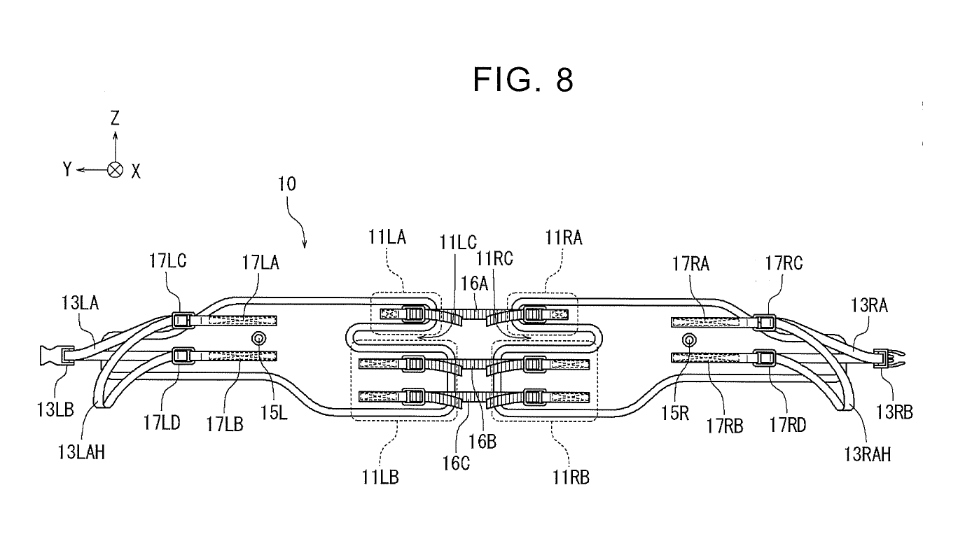

Next, details of the structure of the waist support portion 10 will be described with reference to FIGS. 7 to 10. As illustrated in the developed view of FIG. 8, the waist support portion 10 is belt-shaped and is divided into the right waist wearing portion 11R to be worn on the right waist of the user and the left waist wearing portion 11L to be worn on the left waist of the user. The waist support portion 10 includes a plurality of belts. Further, as described above, the pivot shaft portion 15R is attached to the right waist wearing portion 11R, and the pivot shaft portion 15L is attached to the left waist wearing portion 11L.

For example, as illustrated in FIG. 21, each of the right waist wearing portion 11R and the left waist wearing portion 11L has three layers, i.e., the pad portion 12A having a predetermined thickness and wound around the waist of the user, the core 12B disposed on the outer periphery of the pad portion 12A, and the cover portion 12C disposed on the outer periphery of the core 12B. The pad portion 12A is made of, for example, an elastic member. The core 12B is made of, for example, resin. The cover portion 12C is made of, for example, cloth. A notch portion 11RC is formed in the right waist wearing portion 11R at a position on the back-face side of the user such that the waist wearing portion 11R is divided into a right waist portion 11RA and a right buttock portion 11RB (see FIG. 8). A notch portion 11LC is formed in the left waist wearing portion 11L at a position on the back-face side of the user such that the left waist wearing portion 11L is divided into a left waist portion 11LA and a left buttock portion 11LB (see FIG. 8).

The belts included in the waist support portion 10 include a back waist belt 16A, a buttock upper belt 16B, a buttock lower belt 16C, a right pelvis upper belt 17RA, a right pelvis lower belt 17RB, a left pelvis upper belt 17LA, a left pelvis lower belt 17LB, the right waist fastening belt 13RA, and the left waist fastening belt 13LA. Among the belts thus attached to the waist support portion 10, at least two belts can stretch the width (the length in the Y-axis direction in FIG. 8) of the waist support portion 10 along the circumferential direction of the waist of the user at positions in the vicinity of the right waist, the left waist, or the buttocks of the user.

The back waist belt 16A is, for example, an elastic belt having a stretching property, and is connected to the right waist portion 11RA of the right waist wearing portion 11R and the left waist portion 11LA of the left waist wearing portion 11L so as to adjust an interval (distance) between the right waist portion 11RA of the right waist wearing portion 11R and the left waist portion 11LA of the left waist wearing portion 11L. The buttock upper belt 16B and the buttock lower belt 16C are, for example, elastic belts having a stretching property, and are connected to the right buttock portion 11RB of the right waist wearing portion 11R and the left buttock portion 11LB of the left waist wearing portion 11L so as to adjust an interval (distance) between the right buttock portion 11RB of the right waist wearing portion 11R and the left buttock portion 11LB of the left waist wearing portion 11L. Further, as illustrated in FIG. 10, the buttock upper belt 16B is disposed at a position corresponding to the upper part of the buttocks of the user, and the buttock lower belt 16C is disposed at a position corresponding to the lower part of the buttocks of the user. Further, as illustrated in FIG. 10, the back waist belt 16A is disposed at a position corresponding to the waist above the buttocks of the user and above the buttock upper belt 16B. The waist support portion 10 is closely fitted to the regions in and around the buttocks on the back-face side of the user (so as to wrap the upper part, the middle part, and the lower part of the buttocks) with the use of the back waist belt 16A, the buttock upper belt 16B, and the buttock lower belt 16C so as not to be displaced.

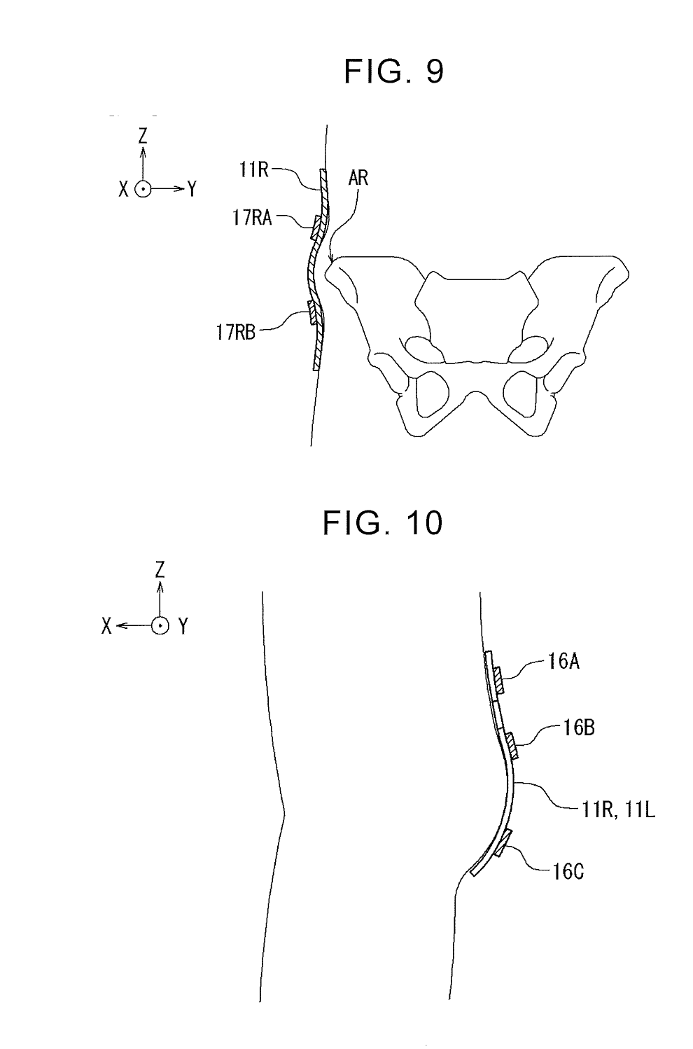

The right pelvis upper belt 17RA is, for example, a belt that is not extendable. As illustrated in FIG. 9, the right pelvis upper belt 17RA is disposed above a right pelvis upper end AR of the user and is attached to the right waist wearing portion 11R so that the width of the right waist wearing portion 11R along the circumferential direction of the waist of the user is extendable. The right pelvis lower belt 17RB is, for example, a belt that is not extendable. As illustrated in FIG. 9, the right pelvis lower belt 17RB is disposed below the right pelvis upper end AR of the user and is attached to the right waist wearing portion 11R so that the width of the right waist wearing portion 11R along the circumferential direction of the waist of the user is extendable. Further, an upper right belt holding member 17RC (upper right adjuster) is connected to a distal end portion of the right pelvis upper belt 17RA, a lower right belt holding member 17RD (lower right adjuster) is connected to a distal end portion of the right pelvis lower belt 17RB, and the right waist fastening belt 13RA connected to the waist belt holding member 13RB (waist buckle) is passed through the upper right belt holding member 17RC (upper right adjuster) and the lower right belt holding member 17RD (lower right adjuster). When the user pulls a tensile portion 13RAH of the right waist fastening belt 13RA, the right pelvis upper belt 17RA, the right pelvis lower belt 17RB, the back waist belt 16A, the buttock upper belt 16B, the buttock lower belt 16C, and the waist support portion 10 can be closely fitted to the body of the user. The tensile portion 13RAH extends from the upper right belt holding member 17RC and the lower right belt holding member 17RD. Further, the parts located above and below the right pelvis upper end AR are wrapped, and thus, the waist support portion 10 can be hardly displaced.

The left pelvis upper belt 17LA is, for example, a belt that is not extendable. The left pelvis upper belt 17LA is disposed above a left pelvis upper end of the user and is attached to the left waist wearing portion 11L so that the width of the left waist wearing portion 11L along the circumferential direction of the waist of the user is extendable. The left pelvis lower belt 17LB is, for example, a belt that is not extendable. The left pelvis lower belt 17LB is disposed below the left pelvis upper end of the user and is attached to the left waist wearing portion 11L so that the width of the left waist wearing portion 11L along the circumferential direction of the waist of the user is extendable. Further, an upper left belt holding member 17LC (upper left adjuster) is connected to a distal end portion of the left pelvis upper belt 17LA, a lower left belt holding member 17LD (lower left adjuster) is connected to a distal end portion of the left pelvis lower belt 17LB, and the left waist fastening belt 13LA connected to the waist belt holding member 13LB (waist buckle) is passed through the upper left belt holding member 17LC (upper left adjuster) and the lower left belt holding member 17LD (lower left adjuster). When the user pulls a tensile portion 13LAH of the left waist fastening belt 13LA extending from the upper left belt holding member 17LC and the lower left belt holding member 17LD, the left pelvis upper belt 17LA, the left pelvis lower belt 17LB, the back waist belt 16A, the buttock upper belt 16B, the buttock lower belt 16C, and the waist support portion 10 can be closely fitted to the body of the user. Further, the parts located above and below the left pelvis upper end are wrapped, and thus, the waist support portion 10 can be hardly displaced. Particularly, in an object lift-up/lift-down motion, it is necessary to transmit the assist torque to the back and the legs around the waist efficiently (with a small loss), unlike bipedal upright walking (biped walking performed with the legs and the backbone being erected vertically). The structure of the waist support portion 10 can transmit the assist torque efficiently.

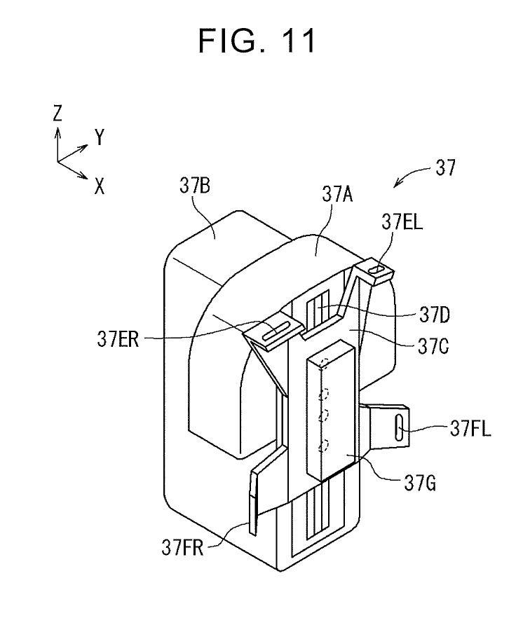

With reference to FIGS. 11 and 12, details of the structure of the back pack portion 37 will be described. As illustrated in FIG. 11, the back pack portion 37 includes a frame connecting portion 37A, a receptacle portion 37B, the back contact portion 37C, a slide rail 37D (corresponding to a sliding mechanism), a cushion 37G, and so on. As illustrated in FIG. 2, the upper end of the main frame 31 is inserted into the frame connecting portion 37A, and thus, the frame connecting portion 37A is fixed to the upper end of the frame portion 30. Note that a control device, a power supply unit, a communication unit, and so on are accommodated in the receptacle portion 37B.

As illustrated in FIG. 11, the slide rail 37D is provided to extend along the up-down direction, on a surface of the frame connecting portion 37A fixed to the frame portion 30 and a surface of the receptacle portion 37B, which faces the back of the user. The slide rail 37D is provided with the back contact portion 37C that is slidable in the up-down direction along the slide rail 37D. That is, the back contact portion 37C is connected to the frame portion 30 via a sliding mechanism (the slide rail 37D) that supports the back contact portion 37C such that the back contact portion 37C is slidable in the up-down direction relative to the frame portion 30. Further, the cushion 37G is provided on a surface of the back contact portion 37C, the surface facing the back of the user. Note that the cushion 37G may be omitted.

As illustrated in FIG. 11, the back contact portion 37C is provided with a belt connecting portion 37ER at a position around the right shoulder on the back side of the user and is also provided with a belt connecting portion 37EL at a position around the left shoulder. Further, the back contact portion 37C is provided with a belt connecting portion 37FR at a position around the right armpit on the back side of the user and is also provided with a belt connecting portion 37FL at a position around the left armpit.

As illustrated in FIG. 12, the jacket portion 20 is divided to the right chest wearing portion 21R to be worn around the right shoulder and the right chest of the user and the left chest wearing portion 21L to be worn around the left shoulder and the left chest of the user. The right chest wearing portion 21R is connectable to and separable from the left chest wearing portion 21L with the use of the fastener 21F. The right shoulder belt 24R extended from a position, in the right chest wearing portion 21R, around the right shoulder of the user is connected to the belt connecting portion 37ER. Further, the right armpit belt 25R extended from a position, in the right chest wearing portion,21R, around the right armpit of the user is connected to the belt connecting portion 37FR. Further, the left shoulder belt 24L extended from a position, in the left chest wearing portion 21L, around the left shoulder of the user is connected to the belt connecting portion 37EL. Further, the left armpit belt 25L extended from a position, in the left chest wearing portion 21L, around the left armpit of the user is connected to the belt connecting portion 37FL.

With the configuration, the back contact portion 37C to which the jacket portion 20 is connected can slide in the up-down direction relative to the frame portion 30 via the sliding mechanism (the slide rail). Accordingly, since the position, in the up-down direction, of the jacket portion 20 relative to the frame portion 30 is automatically adjusted in accordance with the body size (height) of the user, the jacket portion 20 can be closely fitted to the body of the user more appropriately, and thus, the assist torque can be transmitted efficiently. Particularly, in an object lift-up/lift-down motion, it is necessary to transmit the assist torque to the back and the legs around the waist efficiently (with a small loss), unlike bipedal upright walking (biped walking performed with the legs and the backbone being erected vertically). The structure of the back pack portion 37 can transmit the assist torque efficiently.

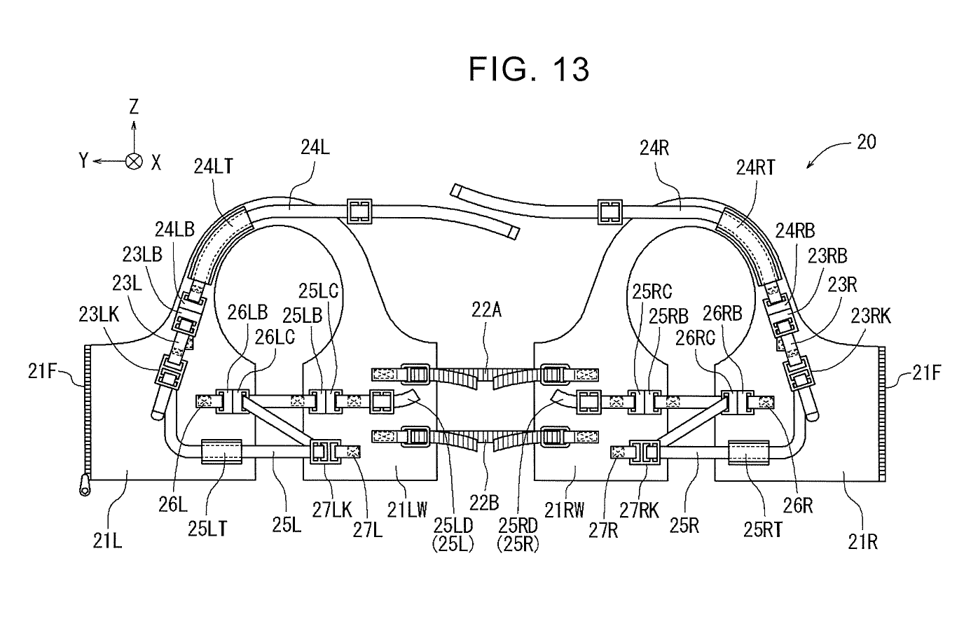

With reference to FIGS. 12 to 15, the structure of the jacket portion 20 will be described in detail. As illustrated in the developed view of FIG. 13, the jacket portion 20 to be worn around the shoulders and the chest of the user is divided into the right chest wearing portion 21R, the left chest wearing portion 21L, a right armpit wearing portion 21RW, and a left armpit wearing portion 21LW, and includes a plurality of belts. Note that the right chest wearing portion 21R and the right armpit wearing portion 21RW are connected to each other at a right shoulder portion, and the left chest wearing portion 21L and the left armpit wearing portion 21LW are connected to each other at a left shoulder portion. The right chest wearing portion 21R is worn around the right shoulder and the right chest of the user, the left chest wearing portion 21L is worn around the left shoulder and the left chest of the user, the right armpit wearing portion 21RW is worn around the right back and the right armpit of the user, and the left armpit wearing portion 21LW is worn around the left back and the left armpit of the user. The right armpit wearing portion 21RW and the left armpit wearing portion 21LW do not necessarily need to be separated and connected to each other with belts. The right armpit wearing portion 21RW and the left armpit wearing portion 21LW may be connected integrally with each other without being separated. Further, the right chest wearing portion 21R, the left chest wearing portion 21L, the right armpit wearing portion 21RW, and the left armpit wearing portion 21LW may be connected integrally with each other without being separated.

Each of the right chest wearing portion 21R, the left chest wearing portion 21L, the right armpit wearing portion 21RW, and the left armpit wearing portion 21LW has two layers including a pad portion and a cover portion such that the layer of the pad portion (e.g., an elastic member) having a predetermined thickness is provided on the side facing the body of the user, and the layer of the cover portion (e.g., cloth) is provided on the outer periphery of the pad portion, for example. Further, as illustrated in FIG. 13, the right armpit wearing portion 21RW is connected to the left armpit wearing portion 21LW with length-adjustable belts 22A, 22B.

As illustrated in FIG. 13, right shoulder belts 24R, 23R and a belt 26R are attached to the right chest wearing portion 21R. A first end portion of the right shoulder belt 24R is adjustable in length and is connected to the belt connecting portion 37ER of the back contact portion 37C as illustrated in FIG. 12. A second end portion of the right shoulder belt 24R is passed through a belt carrier 24RT, and a buckle 24RB is connected to the second end portion of the right shoulder belt 24R. A buckle 23RB connected to the buckle 24RB is connected to a first end portion of the right shoulder belt 23R, and a right shoulder belt holding member 23RK (right shoulder adjuster) is connected to a second end portion of the right shoulder belt 23R. Further, a first end portion of the belt 26R is connected to the right chest wearing portion 21R, a buckle 26RB is connected to a second end portion of the belt 26R, and a right chest belt holding member 26RC (right chest buckle) is connected to the buckle 26RB. The right chest belt holding member 26RC is disposed at a position around the right chest of the user.

Similarly, as illustrated in FIG. 13, left shoulder belts 24L, 23L and a belt 26L are attached to the left chest wearing portion 21L. A first end portion of the left shoulder belt 24L is adjustable in length and is connected to the belt connecting portion 37EL of the back contact portion 37C, as illustrated in FIG. 12. A second end portion of the left shoulder belt 24L is passed through a belt carrier 24LT, and a buckle 24LB is connected to the second end portion of the left shoulder belt 24L. A buckle 23LB connected to the buckle 24LB is connected to a first end portion of the left shoulder belt 23L, and a left shoulder belt holding member 23LK (left shoulder adjuster) is connected to a second end portion of the left shoulder belt 23L. Further, as illustrated in FIG. 13, a first end portion of the belt 26L is connected to the left chest wearing portion 21L, a buckle 26LB is connected to a second end portion of the belt 26L, and a left chest belt holding member 26LC (left chest buckle) is connected to the buckle 26LB. The left chest belt holding member 26LC is disposed at a position around the left chest of the user.

As illustrated in FIG. 13, a belt 27R is attached to the right armpit wearing portion 21RW such that a first end portion of the belt 27R is connected to the right armpit wearing portion 21RW and a right armpit belt holding member 27RK (right armpit adjuster) is connected to a second end portion of the belt 27R. The right armpit belt holding member 27RK is disposed at a position around the right armpit of the user. Similarly, as illustrated in FIG. 13, a belt 27L is attached to the left armpit wearing portion 21LW such that a first end portion of the belt 27L is connected to the left armpit wearing portion 21LW and a left armpit belt holding member 27LK (left armpit adjuster) is connected to a second end portion of the belt 27L. The left armpit belt holding member 27LK is disposed at a position around the left armpit of the user.

As illustrated in FIG. 12, a first end portion of the right shoulder belt 24R extended from a position, in the right chest wearing portion 21R, around the right shoulder of the user is adjustable in length and is connected to the belt connecting portion 37ER of the back contact portion 37C. A first end portion of the right armpit belt 25R extended from a position, in the right chest wearing portion 21R, around the right armpit of the user is connected to the belt connecting portion 37FR of the back contact portion 37C. Similarly, a first end portion of the left shoulder belt 24L extended from a position, in the left chest wearing portion 21L, around the left shoulder of the user is adjustable in length and is connected to the belt connecting portion 37EL of the back contact portion 37C. A first end portion of the left armpit belt 25L extended from a position, in the left chest wearing portion 21L, around the left armpit of the user is connected to the belt connecting portion 37FL of the back contact portion 37C.

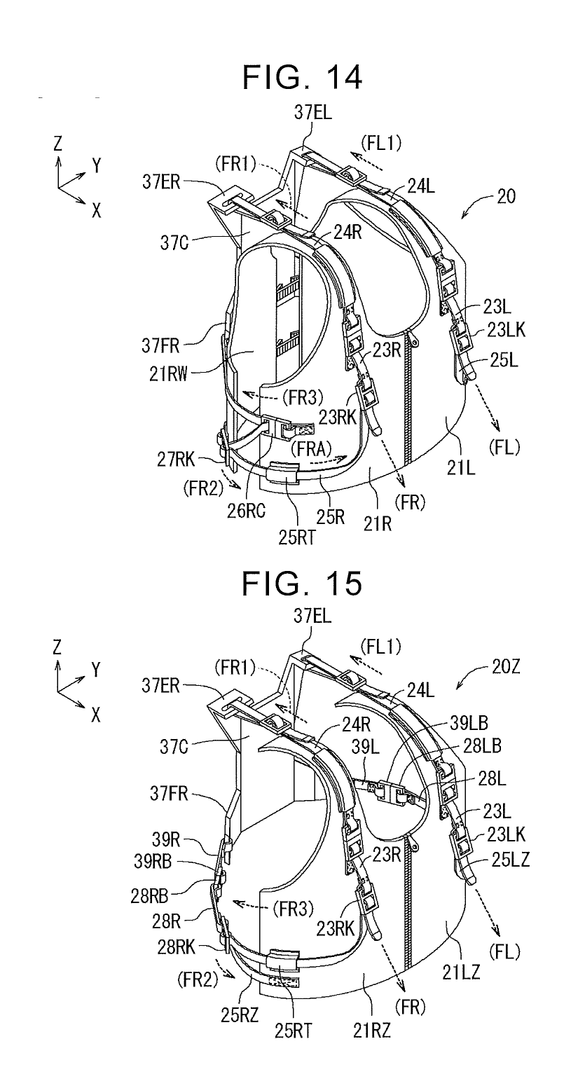

As illustrated in FIG. 13, a right chest fastening belt serves also as the right armpit belt 25R and is configured such that a first end portion thereof (i.e., a right armpit belt 25RD that is regarded as a part of the right armpit belt 25R) is connected to the back contact portion 37C (see FIG. 12) and a second end portion thereof is passed through the right chest belt holding member 26RC, the right armpit belt holding member 27RK, a belt carrier 25RT, and the right shoulder belt holding member 23RK in this order. Note that a first end portion of the right armpit belt 25RD is connected to a buckle 25RC, and a first end portion of the right armpit belt 25R is connected to a buckle 25RB. The buckle 25RC is connected to the buckle 25RB. Accordingly, the right armpit belt 25R and the right armpit belt 25RD are connected to each other via the buckles 25RB, 25RC, and thus, the right armpit belt 25RD can be regarded as a part of the right armpit belt 25R. Note that a left chest fastening belt serves also as the left armpit belt 25L and is passed through buckles and so on similarly to the right armpit belt, so descriptions thereof are omitted herein. As illustrated in FIG. 14, when the user pulls (with a force FR) a second end portion of the right chest fastening belt (in this case, the right armpit belt 25R) extending from the right shoulder belt holding member 23RK, the user can pull the right shoulder belts 24R, 23R and the right armpit belt 25R at the same time. Thus, as illustrated in FIG. 14, the right chest wearing portion 21R around the right shoulder and the right armpit of the user can be brought close to the back contact portion 37C at the same time (with a force FR1 and a force FR3) and the right armpit wearing portion 21RW can be brought close to the right chest wearing portion 21R (with a force FR2). Thus, the right chest wearing portion 21R and the right armpit wearing portion 21RW can be closely fitted to the body of the user and the right chest wearing portion 21R and the right armpit wearing portion 21RW can be brought close to the back contact portion 37C. Similarly, when the user pulls a second end portion of the left chest fastening belt (in this case, the left armpit belt 25L) (with a force FL), the left chest wearing portion 21L and the left armpit wearing portion 21LW can be closely fitted to the body of the user and the left chest wearing portion 21L and the left armpit wearing portion 21LW can be brought close to the back contact portion 37C. Further, similar adjustment can be also made by pulling, forward (in the direction of (FRA) in FIG. 14), a front part of the right armpit belt 25R, which is located ahead of the belt carrier 25RT. Even in this manner, the right chest wearing portion 21R and the right armpit wearing portion 21RW can be closely fitted to the body of the user by a simple belt adjustment operation. In this case, a second end portion of the right armpit belt 25R is pulled (in the direction of (FR) in FIG. 14) to reduce slack ahead of the belt carrier 25RT, thereby preventing interference with the work of the user.

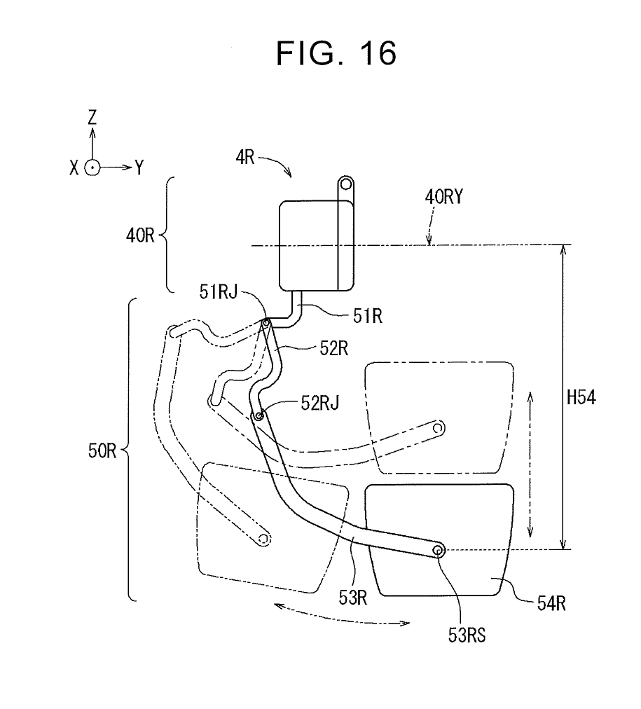

FIG. 15 illustrates an example of a jacket portion 20Z different from the jacket portion 20 illustrated in FIG. 14. The jacket portion 20Z illustrated in FIG. 15 is not provided with the right armpit wearing portion 21RW and the left armpit wearing portion 21LW (see FIG. 13) as compared with the jacket portion 20 illustrated in FIG. 14 and is different from the jacket portion 20 in arrangement of the belt holding members and in belt routing state. Hereinbelow, different points will be mainly described. As illustrated in FIG. 15, the right shoulder belts 24R, 23R, the buckles 24RB, 23RB, and the right shoulder belt holding member 23RK (right shoulder adjuster) attached to a right chest wearing portion 21RZ are the same as those attached to the right chest wearing portion 21R illustrated in FIG. 12.

As illustrated in FIG. 15, a buckle 28RB is connected to a first end portion of a right armpit belt 28R extended from a position, in the right chest wearing portion 21RZ, around the right armpit of the user, and the buckle 28RB is connected to the belt connecting portion 37FR of the back contact portion 37C via a buckle 39RB and a belt 39R. A right armpit belt holding member 28RK (right armpit adjuster) is connected to a second end portion of the right armpit belt 28R, and a right chest fastening belt 25RZ is passed through the right armpit belt holding member 28RK. Belts, buckles, belt holding members, and the like of a left chest wearing portion are configured in the same manner, so detailed descriptions thereof are omitted herein.

As illustrated in FIG. 15, a first end portion of the right chest fastening belt 25RZ is connected to the right chest wearing portion 21RZ, and a second end portion thereof is passed through the right armpit belt holding member 28RK, the belt carrier 25RT, and the right shoulder belt holding member 23RK in this order. When the user pulls (with a force FR) the second end portion of the right chest fastening belt 25RZ extending from the right shoulder belt holding member 23RK, the user can pull the right shoulder belts 24R, 23R and the right armpit belt 28R at the same time. Thus, as illustrated in FIG. 15, the right chest wearing portion 21RZ around the right shoulder and the right armpit of the user can be brought close to the back contact portion 37C at the same time (with a force FR1 and a force FR3) and the right armpit belt 28R can be brought close to the right chest wearing portion 21R (with a force FR2). Thus, the right chest wearing portion 21RZ can be closely fitted to the body of the user and the right chest wearing portion 21RZ can be brought close to the back contact portion 37C. Note that, similarly, when the user pulls a second end portion of a left chest fastening belt 25LZ (with a force FL), a left chest wearing portion 21LZ can be closely fitted to the body of the user and the left chest wearing portion 21LZ can be brought close to the back contact portion 37C. Further, when the user puts on the jacket portion 20, the user first opens the fastener 21F so that the right and left hands (arms) of the user are passed therethrough to put the body of the user in the jacket portion 20, and the user closes the fastener 21F. The frame portion 30 can be closely fitted to the body of the user with the use of the belts such as the right armpit belt 25R (the right chest fastening belt) and the left armpit belt 25L (the left chest fastening belt). Further, adjustment mechanisms such as adjusters of the jacket portion 20 under the armpits are loosened depending on the body size of the user, so as to enlarge openings into which the hands (arms) are inserted. Thus, the user can easily wear the jacket portion 20. At the time of maintenance (cleaning and the like) of the jacket portion 20, the buckles 23RB, 24RB (23LB, 24LB) are detached (the belt carrier 24RT (24LT) is also detached) and the buckles 25RB, 25RC (25LB, 25LC) are also detached, and thus, the jacket portion 20 can be detached from the back pack portion 37. Note that the belt carrier 24RT (24LT) is detachably attached, for example, with a loop fastener. Particularly, in an object lift-up/lift-down motion, it is necessary to transmit the assist torque to the back and the legs around the waist efficiently (with a small loss), unlike bipedal upright walking (biped walking performed with the legs and the backbone being erected vertically). The structure of the jacket portion 20 can transmit the assist torque efficiently.

With reference to FIGS. 3, 16 to 18, the following describes details of a link mechanism of the right actuator unit 4R. Note that a link mechanism of the left actuator unit 4L is configured in the same manner, so a description of the link mechanism of the left actuator unit 4L is omitted herein. The output link 50R (also the output link 50L) is configured such that the assist arm 51R (corresponding to the first link), the second link 52R, and the third link 53R as a plurality of connecting members, and the thigh wearing portion 54R (corresponding to the body holding portion) are connected to each other via joint portions. Further, the thigh wearing portion 54R is an elastic pad, for example, and a pad 55R is connected to the thigh wearing portion 54R via belts 55RA, 55RB.

The following also describes the degree of freedom of a joint portion. With regard to a joint portion (a coupling portion) that connects a first connecting member to a second connecting member, a connecting structure in which the second connecting member is pivotable around one axis relative to the second connecting member is defined as having one degree of freedom, and a connecting structure in which the second connecting member slidably reciprocates along one axis relative to the first connecting member is defined as having one degree of freedom. Further, a connecting structure in which the second connecting member is pivotable around two axes relative to the first connecting member (e.g., a connecting structure with the use of a universal joint, such as a propeller shaft for a vehicle) is defined as having two degrees of freedom, and a connecting structure in which the second connecting member is pivotable around three axes relative to the first connecting member (e.g., a connecting structure with the use of a spherical joint) is defined as having three degrees of freedom.

In FIG. 3, the assist arm 51R is caused to pivot around the pivot axis 40RY by combined torque obtained by combining the assist torque generated in the torque generating portion 40R and the user torque generated by the motion of the thigh of the user. The first end portion of the second link 52R is connected to the distal end portion of the assist arm 51R via a (first) joint portion 51RS so as to be pivotable around the pivot axis 51RJ. Accordingly, the (first) joint portion SIRS between the assist arm 51R and the second link 52R has one degree of freedom. Further, the first end portion of the third link 53R is connected to the second end portion of the second link 52R via a (second) joint portion 52RS so as to be pivotable around the pivot axis 52RJ. Accordingly, the (second) joint portion 52RS between the second link 52R and the third link 53R has one degree of freedom. The second end portion of the third link 53R is connected to the thigh wearing portion 54R via the third joint portion 53RS (in this case, a spherical joint). Accordingly, the (third) joint portion between the third link 53R and the thigh wearing portion 54R has three degrees of freedom. Thus, the sum of degrees of freedom of the joint portions in the output link 50R in FIG. 3 is 1+1+3=5. Note that, in the example illustrated in FIG. 3, the sum of degrees of freedom of the output link 50R is five, but the sum of degrees of freedom should be three or more. For example, the joint portion between the third link 53R and the thigh wearing portion 54R may have a connecting structure with one degree of freedom or may have a connecting structure with two degrees of freedom. That is, the joint portion between the third link 53R and the thigh wearing portion 54R may have one to three degrees of freedom. Note that the third joint portion 53RS (in this case, a spherical joint) that is a joint portion between the third link 53R and the thigh wearing portion 54R is not provided on a lateral side of the thigh wearing portion 54R, and is provided on the front side thereof. Accordingly, the thigh wearing portion 54R can transmit the assist torque more appropriately without being displaced with respect to the thigh.

As illustrated in FIG. 16, the output link 50R can freely change a distance H54, in the up-down direction, from the pivot axis 40RY to the thigh wearing portion 54R in accordance with the body size of the user (in accordance with the length of the thigh). Further, as illustrated in FIG. 16, when the user spreads the thighs in the right-left direction, the output link 50R can freely change the position, in the right-left direction (the Y-axis direction), of the thigh wearing portion 54R with respect to the torque generating portion 40R. This allows the thigh wearing portion 54R to be closely fitted to the body of the user more appropriately, thereby making it possible to transmit the assist torque efficiently. Further, when the user spreads the legs (the thighs) in the right-left direction, the position of the thigh wearing portion 54R follows the legs thus spread, appropriately, and thus, the assist torque can be transmitted efficiently.

Further, in a connecting structure where a second connecting member is pivotable around one axis relative to a first connecting member via a joint portion, a stopper that restricts a pivoting range may be provided. Although the structure of the stopper is not illustrated, a stopper that restricts the pivot angle of the second link 52R relative to the assist arm 51R may be provided or a stopper that restricts the pivot angle of the third link 53R relative to the second link 52R may be provided, in FIG. 16.

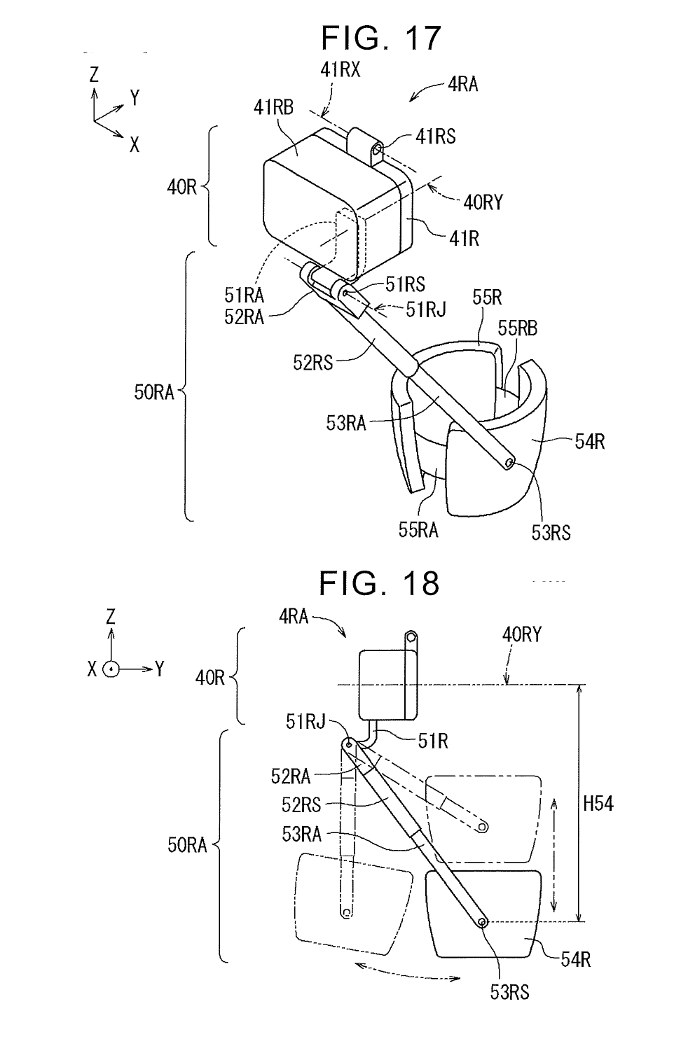

With reference to FIGS. 17 and 18, the following describes an example of an output link 50RA having a structure different from the output link 50R illustrated in FIG. 3. Note that, in FIGS. 17 and 18, the same reference signs are assigned to the same members as in FIG. 3. The output link 50RA is configured such that the assist arm 51R (corresponding to the first link), a second link 52RA, and a third link 53RA as a plurality of connecting members, and the thigh wearing portion 54R are connected to each other via joint portions.

A first end portion of the second link 52RA is connected to the distal end portion of the assist arm 51R via the (first) joint portion 51RS so as to be pivotable around the pivot axis 51RJ. Accordingly, the (first) joint portion 51RS between the assist arm 51R and the second link 52R has one degree of freedom. Further, a first end portion of the third link 53RA that slidably reciprocates along its longitudinal direction is connected to a second end portion of the second link 52RA via the (second) joint portion 52RS. Accordingly, the (second) joint portion 52RS between the second link 52RA and the third link 53RA has one degree of freedom. Further, the second end portion of the third link 53RA is connected to the thigh wearing portion 54R via the third joint portion 53RS (in this case, a spherical joint). Accordingly, the (third) joint portion between the third link 53RA and the thigh wearing portion 54R has three degrees of freedom. Thus, the sum of degrees of freedom of the joint portions in the output link 50RA in FIGS. 17 and 18 is 1+1+3=5. Note that the sum of degrees of freedom should be three or more, and for example, the joint portion between the third link 53RA and the thigh wearing portion 54R may have one to three degrees of freedom.

As illustrated in FIG. 18, the output link 50RA can freely change the distance H54, in the up-down direction, from the pivot axis 40RY to the thigh wearing portion 54R in accordance with the body size of the user (in accordance with the length of the thigh). Further, as illustrated in FIG. 18, when the user spreads the thighs in the right-left direction, the output link 50RA can freely change the position, in the right-left direction (the Y-axis direction), of the thigh wearing portion 54R relative to the torque generating portion 40R. This allows the thigh wearing portion 54R to be closely fitted to the body of the user more appropriately, thereby making it possible to transmit the assist torque efficiently. Further, when the user spreads the legs (the thighs) in the right-left direction, the position of the thigh wearing portion 54R follows the legs thus spread, appropriately, and thus, the assist torque can be transmitted efficiently. Particularly, in an object lift-up/lift-down motion, it is necessary to transmit the assist torque to the back and the legs around the waist efficiently (with a small loss), unlike bipedal upright walking (biped walking performed with the legs and the backbone being erected vertically). The structure of the link structure can transmit the assist torque efficiently.

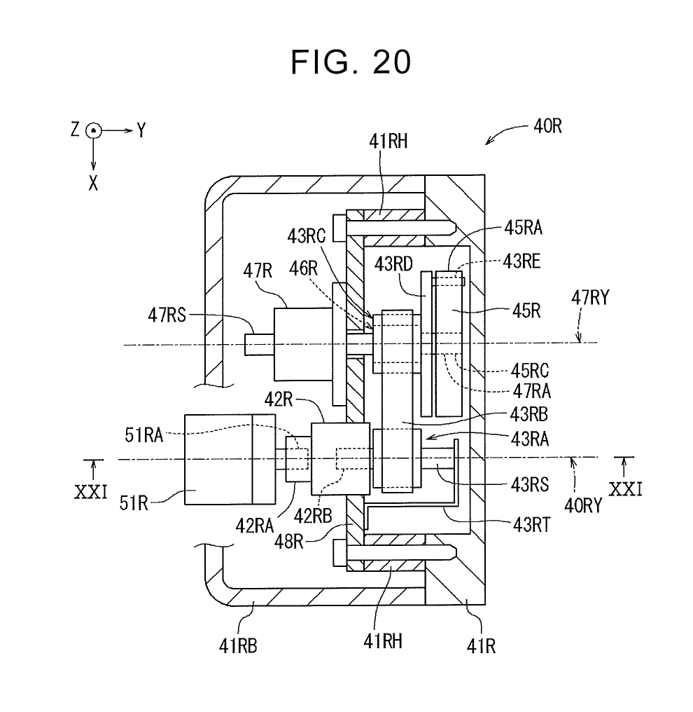

Descriptions are now provided on the inner structure of the torque generating portion 40R in the right actuator unit 4R. In other words, with reference to FIGS. 19 and 20, members accommodated in the cover 41RB of the torque generating portion 40R (see FIG. 3) will be described. Note that FIG. 20 is a sectional view taken along the line XX-XX in FIG. 19. As illustrated in FIGS. 19 and 20, the assist arm 51R having a shaft portion 51RA, a speed reducer 42R, a pulley 43RA, a transmission belt 43RB, a pulley 43RC including a flange portion 43RD, a spiral spring 45R, a bearing 46R, the electric motor 47R (corresponding to an actuator), a sub-frame 48R, and so on are accommodated inside the cover 41RB.

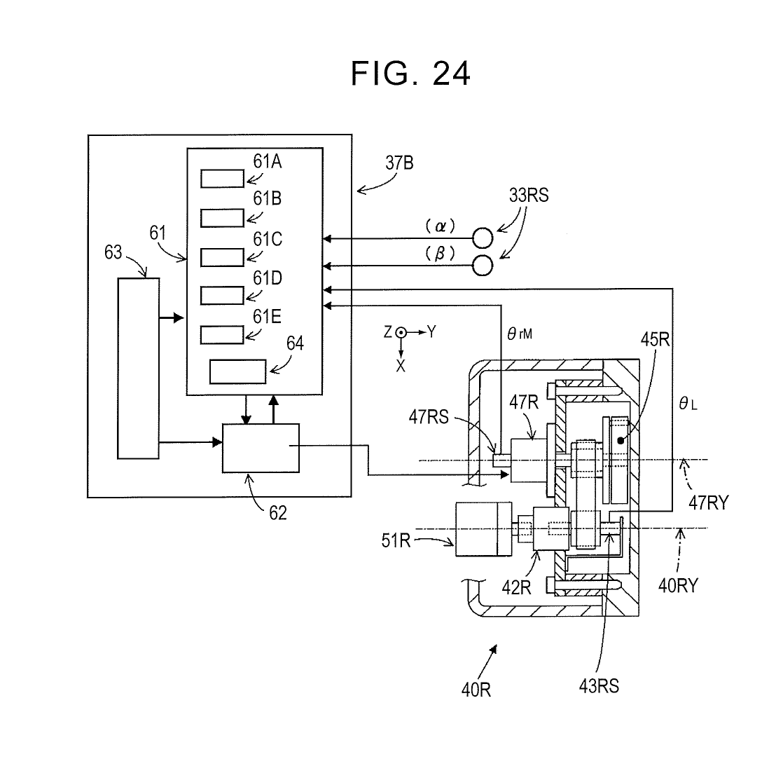

As illustrated in FIGS. 19 and 20, an output link pivot angle detection unit 43RS (a pivot angle sensor, or the like) configured to detect a pivot angle of the assist arm 51R relative to the actuator base portion 41R is connected to the pulley 43RA connected to an accelerating shaft 42RB of the speed reducer 42R. The output link pivot angle detection unit 43RS is an encoder or an angle sensor, for example, and outputs a detection signal corresponding to a rotation angle to a control device 61 (see FIG. 24). Further, the electric motor 47R is provided with a motor rotation angle detection unit 47RS that can detect a rotation angle of a motor shaft (corresponding to an output shaft). The motor rotation angle detection unit 47RS is an encoder or an angle sensor, for example, and outputs a detection signal corresponding to a rotation angle to the control device 61 (see FIG. 24).

As illustrated in FIG. 19, the actuator base portion 41R is provided with a connecting portion 41RC, and the like. The connecting portion 41RC is connected to the right motor connecting portion 35R (see FIG. 1) so that the actuator base portion 41R can pivot around the pivot axis 41RX.

As illustrated in FIG. 19, the sub-frame 48R has a through-hole 48RA to which a reducer housing 42RC of the speed reducer 42R is fixed, and a through-hole 48RB through which the output shaft 47RA of the electric motor 47R is passed. The shaft portion 51RA of the assist arm 51R is fitted to a hole 42RD of a decelerating shaft 42RA of the speed reducer 42R, and the reducer housing 42RC of the speed reducer 42R is fixed to the through-hole 48RA of the sub-frame 48R. Consequently, the assist aim 51R is supported so as to be pivotable relative to the actuator base portion 41R around the pivot axis 40RY, and pivots integrally with the decelerating shaft 42RA. Further, the electric motor 47R is fixed to the sub-frame 48R, and the output shaft 47RA is passed through the through-hole 48RB of the sub-frame 48R. The sub-frame 48R is fixed to an attachment portion 41RH of the actuator base portion 41R with a fastening member such as a bolt.

As illustrated in FIG. 19, the pulley 43RA is connected to the accelerating shaft 42RB of the speed reducer 42R, and the output link pivot angle detection unit 43RS is connected to the pulley 43RA. A support member 43RT fixed to the sub-frame 48R is connected to the output link pivot angle detection unit 43RS. Thus, the output link pivot angle detection unit 43RS can detect a pivot angle of the accelerating shaft 42RB relative to the sub-frame 48R (that is, the actuator base portion 41R). Further, the pivot angle of the assist arm 51R is a pivot angle increased by the accelerating shaft 42RB of the speed reducer 42R. Accordingly, the output link pivot angle detection unit 43RS and the control device can detect the pivot angle of the assist arm 51R with a higher resolution. By detecting the pivot angle of the output link with a higher resolution, the control device can execute a control with higher accuracy. Note that the shaft portion 51RA of the assist arm 51R, the speed reducer 42R, the pulley 43RA, and the output link pivot angle detection unit 43RS are disposed coaxially along the pivot axis 40RY.

The speed reducer 42R has a reduction ratio n (1<n). When the decelerating shaft 42RA is caused to pivot by a pivot angle θ, the speed reducer 42R pivots the accelerating shaft 42RB by a pivot angle nθ. Further, when the accelerating shaft 42RB is caused to pivot by the pivot angle nθ, the speed reducer 42R pivots the decelerating shaft 42RA by the pivot angle θ. The transmission belt 43RB is provided over the pulley 43RA to which the accelerating shaft 42RB of the speed reducer 42R is connected, and the pulley 43RC. Accordingly, the user torque from the assist arm 51R is transmitted to the pulley 43RC via the accelerating shaft 42RB and the assist torque from the electric motor 47R is transmitted to the accelerating shaft 42RB via the spiral spring 45R and the pulley 43RC.

The spiral spring 45R has a spring constant Ks and has a spiral shape with an inner end portion 45RC on the center side and with an outer end portion 45RA on the outer peripheral side. The inner end portion 45RC of the spiral spring 45R is fitted in a groove 47RB formed in the output shaft 47RA of the electric motor 47R. The outer end portion 45RA of the spiral spring 45R is wound cylindrically. A transmission shaft 43RE provided in the flange portion 43RD of the pulley 43RC is fitted in the outer end portion 45RA, and thus, the outer end portion 45RA is supported by the transmission shaft 43RE (i.e., the pulley 43RC is configured such that the flange portion 43RD is integrated with the transmission shaft 43RE). The pulley 43RC is supported so as to be pivotable around a pivot axis 47RY, and the transmission shaft 43RE projecting toward the spiral spring 45R is provided near the outer peripheral edge of the flange portion 43RD integrated with the pulley 43RC. The transmission shaft 43RE is fitted in the outer end portion 45RA of the spiral spring 45R, so as to move the position of the outer end portion 45RA around the pivot axis 47RY. Further, the bearing 46R is provided between the output shaft 47RA of the electric motor 47R and the pulley 43RC. That is, the output shaft 47RA is not fixed to the pulley 43RC, and thus, the output shaft 47RA can rotate freely relative to the pulley 43RC. The pulley 43RC is rotationally driven by the electric motor 47R via the spiral spring 45R. With the configuration, the output shaft 47RA of the electric motor 47R, the bearing 46R, the pulley 43RC having the flange portion 43RD, and the spiral spring 45R are disposed coaxially along the pivot axis 47RY.

The spiral spring 45R stores the assist torque transmitted from the electric motor 47R, and also stores the user torque transmitted by the motion of the thigh of the user via the assist arm 51R, the speed reducer 42R, the pulley 43RA, and the pulley 43RC. As a result, the spiral spring 45R stores the combined torque obtained by combining the assist torque and the user torque. The combined torque thus stored in the spiral spring 45R pivots the assist arm 51R via the pulley 43RC, the pulley 43RA, and the speed reducer 42R. With the configuration, the output shaft 47RA of the electric motor 47R is connected to the output link (in the case of FIG. 19, the assist arm 51R) via the speed reducer 42R that reduces the rotation angle of the output shaft 47RA.

The combined torque stored in the spiral spring 45R is calculated based on an angle change amount from a no-load state and the spring constant. For example, the combined torque stored in the spiral spring 45R is calculated based on the pivot angle of the assist arm 51R (detected by the output link pivot angle detection unit 43RS), the rotation angle of the output shaft 47RA of the electric motor 47R (detected by the motor rotation angle detection unit 47RS), and the spring constant Ks of the spiral spring 45R. Then, the user torque is extracted from the calculated combined torque, and the assist torque in accordance with the user torque is output from the electric motor. Calculation of the angle change amount, calculation of the combined torque, extraction of the user torque, calculation of the assist torque, output of a control signal to the electric motor, and so on are performed by the control device housed in the back pack portion 37 (see FIG. 2). Particularly, in an object lift-up/lift-down motion, a relatively large torque is output as the assist torque (a speed reducing ratio is also relatively large), unlike bipedal upright walking (biped walking performed with the legs and the backbone being erected vertically). Therefore, it is necessary to perform a control without giving the user any discomfort feeling (i.e., it is necessary to perform a control such that the user feels that the assist torque is smoothly changed). The actuator unit structure (the rotation angle (pivot angle) detection unit) can improve the accuracy of the control, thereby making it possible to perform a control such that the user feels that the assist torque is smoothly changed.

Next, a description will be provided on the structure (FIG. 21) of a pivot mechanism configured to pivot the frame portion 30 relative to the waist support portion 10, and pivoting states (FIGS. 22, 23). With reference to a sectional view illustrated in FIG. 21, details of the pivot mechanism that supports the frame portion 30 such that the frame portion 30 is pivotable relative to the waist support portion 10 around the virtual pivot axis 15Y will be described first. FIG. 21 is a sectional view of the right actuator unit 4R and the waist support portion 10, taken along the ZY plane passing through the virtual pivot axis 15Y in FIG. 1, and the right actuator unit 4R is illustrated in a sectional view taken along a line XXI-XXI in FIG. 20. The following describes a pivot mechanism including the pivot shaft portion 15R provided in the right waist wearing portion 11R with reference to FIG. 21. A pivot mechanism including the pivot shaft portion 15L (see FIG. 2) provided in the left waist wearing portion 11L (see FIG. 2) also has the same configuration, so the pivot mechanism including the pivot shaft portion 15L is not described herein.

The pivot mechanism includes the pivot shaft portion 15R, and the shaft hole 36RC (see FIG. 5) provided in the right waist connecting portion 36R so that the pivot shaft portion 15R is fitted in the shaft hole 36RC. The pivot shaft portion 15R is provided (fixed), at a position crossing the virtual pivot axis 15Y, on the core 12B of the right waist wearing portion 11R having three layers of the pad portion 12A, the core 12B, and the cover portion 12C, and thus, the pivot shaft portion 15R projects outwardly from the right waist wearing portion 11R along the virtual pivot axis 15Y. The pivot shaft portion 15R is fitted into the shaft hole 36RC formed in the lower part of the right waist connecting portion 36R of the frame portion 30 via the bearing 15RB. The coming-off preventing ring 15RC is fitted around a distal end portion of the pivot shaft portion 15R, the distal end portion protruding from the bearing 15RB. While the pivot shaft portion 15R is fixed to the right waist wearing portion 11R and the shaft hole 36RC is provided in the right waist connecting portion 36R in the present embodiment, the pivot shaft portion 15R may be fixed to the right waist connecting portion 36R and the shaft hole may be provided in the right waist wearing portion 11R. By the pivot mechanism described above, as illustrated in FIGS. 22 and 23, the frame portion 30 (the frame portion 30 and the jacket portion 20) is caused to pivot around the virtual pivot axis 15Y relative to the waist support portion 10 in accordance with a motion of the user. As a result, as illustrated in FIGS. 22 and 23, for example, when the posture of the user is changed from an upright posture to a forward-bent posture, the waist support portion 10 does not move in the up-down direction from the position of the waist of the user. Thus, the assist torque can be efficiently transmitted via the third link 53R and so on. When the inclination angle of the upper half of the body of the user with respect to the vertical direction illustrated in FIG. 23 is a pivot angle (that is an actual link angle θ_{L}, and in this case, corresponds to a posture angle), the pivot angle can be detected by the output link pivot angle detection unit 43RS (see FIG. 19).

Next will be described an opening angle imparting mechanism configured to cause the right actuator unit 4R to pivot (open) in the right-left direction relative to the frame portion 30. Hereinbelow, while the opening angle imparting mechanism for the right actuator unit 4R that is attached to the right side of the waist support portion 10 will be described, an opening angle imparting mechanism for the left actuator unit 4L (see FIG. 1) that is attached to the left side of the waist support portion 10 is the same as that for the right actuator unit 4R and therefore a description of the opening angle imparting mechanism for the left actuator unit 4L will be omitted. The opening angle imparting mechanism includes a first opening angle imparting mechanism and a second opening angle imparting mechanism. The first opening angle imparting mechanism includes the right motor connecting portion 35R and the connecting portion 41RC in FIG. 21, and the second opening angle imparting mechanism includes the output link 50R, 50RA in FIGS. 16 and 18.

In FIG. 21, the first opening angle imparting mechanism includes the right motor connecting portion 35R, and the connecting portion 41RC provided in the actuator base portion 41R of the right actuator unit 4R. The connecting portion 41RC is supported so as to be pivotable relative to the right motor connecting portion 35R around the pivot axis 41RX extending in the front-rear direction. Therefore, the right actuator unit 4R is pivotable relative to the waist support portion 10 around the pivot axis 41RX. By this pivoting, when, for example, the user opens the thigh to the right or left, a first opening angle as an angle formed between the longitudinal direction of the right waist connecting portion 36R and the longitudinal direction of the actuator base portion 41R in FIG. 21 changes. That is, the first opening angle imparting mechanism is a mechanism that opens (pivots) the entire right actuator unit 4R in the right-left direction (a mechanism that opens (pivots) the entire left actuator unit 4L in the right-left direction) relative to the waist support portion 10.

The second opening angle imparting mechanism is a mechanism that opens (pivots) the output link 50R, 50RA in the right-left direction in FIGS. 16 and 18 and the structure thereof has been already described in the description of the degree of freedom, so the second opening angle imparting mechanism is not described herein. For example, when the user opens the thigh to the right or left, the output link 50R, 50RA pivots in the right-left direction so as to follow the thigh thus opened to the right or left as illustrated in FIGS. 16 and 18. That is, the second opening angle imparting mechanism is a mechanism for opening (pivoting) the output link 50R, 50RA in the right-left direction relative to the torque generating portion 40R of the right actuator unit 4R (the same also applies to the left actuator unit 4L). Further, the allowable opening degrees (allowable opening angles) of the first opening angle imparting mechanism and the second opening angle imparting mechanism are adjustable so as to allow the user to make an outward rotation motion and an outward pivoting (outward moving) motion of the hip joint of the thigh of the user, and in addition, an inward rotation motion and an inward pivoting (inward moving) motion of the hip joint of the thigh of the user. Consequently, the output link 50R, 50RA can operate so as not to impede the motion of the user, and thus, the assist torque can be efficiently transmitted to the thigh.

The opening angle imparting mechanism may include both the first opening angle imparting mechanism and the second opening angle imparting mechanism or may include only one of them. When the opening angle imparting mechanism includes both the first opening angle imparting mechanism and the second opening angle imparting mechanism, the sum of the first opening angle and the second opening angle is given as an opening angle.

When the connecting portion 41RC and the actuator base portion 41R that are supported by the right motor connecting portion 35R are parallel to the right waist connecting portion 36R (i.e., when the first opening angle is zero) as illustrated in FIG. 21, the pivot axis 40RY of the right actuator unit 4R is set to coincide with the virtual pivot axis 15Y. Therefore, in the state where the actuator base portion 41R is parallel to the right waist connecting portion 36R (the first opening angle is zero), no matter how the frame portion 30 is caused to pivot relative to the waist support portion 10 around the virtual pivot axis 15Y, the virtual pivot axis 15Y and the pivot axis 40RY are maintained to coincide with each other (see FIGS. 22 and 23). When, for example, the user spreads the thighs in the right-left direction so as to stand firm for lifting up a heavy thing (heavy object), there occurs at least one of pivoting of the (right and left) actuator units 4R, 4L (see FIG. 1) around the pivot axes 41RX, 41LX (see FIG. 1) and pivoting of the output link 50R, 50RA to open to the right or left. In this way, the right and left actuator units are opened in the right-left direction, following the thighs thus spread in the right-left direction. Accordingly, in the state where the user spreads the thighs in the right-left direction, it is possible to appropriately transmit the assist torques to the thighs.

The input and output of the control device 61 will be described with reference to FIG. 24. The control device 61 is accommodated in the receptacle portion 37B (see FIG. 12) of the back pack portion 37, as illustrated in FIG. 24. In the example illustrated in FIG. 24, the control device 61, a motor driver 62, a power supply unit 63, and so on are housed in the receptacle portion 37B. The control device 61 includes, for example, a CPU and a storage device (storing control programs, etc.). The control device 61 includes a torque determination unit 61A (a torque determination unit), a motion kind determination unit 61B (a motion kind determination unit), an assist torque calculation unit 61C (an assist torque calculation unit), a correction unit 61D (a correction unit), a pivot angle control unit 61E (a pivot angle control unit), a communication unit 64, and so on, which will be described later. The motor driver 62 is an electronic circuit that outputs a drive current for driving the electric motor 47R, based on a control signal from the control device 61. The power supply unit 63 is, for example, a lithium battery and supplies electric power to the control device 61 and the motor driver 62. The operation and so on of the communication unit 64 will be described later.

Input signals from the input portions 33RS, a detection signal from the motor rotation angle detection unit 47RS (a detection signal corresponding to an actual motor shaft angle θ_{rM} of the electric motor 47R), a detection signal from the output link pivot angle detection unit 43RS (a detection signal corresponding to an actual link angle θ_{L} of the assist arm 51R), and so on are input to the control device 61. The control device 61 calculates a rotation angle of the electric motor 47R based on the input signals and outputs a control signal corresponding to the calculated rotation angle to the motor driver 62. The input portions 33RS are, for example, a power supply switch configured to allow the user to provide instructions regarding the operation and stop of the control device 61, an adjustment dial configured to allow the user to set an assist multiplying factor α (0<α), and an adjustment dial configured to allow the user to set a differential correction gain β (0≤β). The assist multiplying factor α and the differential correction gain β are determined based on an assist torque output and a spring constant, and when a large assist torque is required, a large value (e.g., α>1) is set.

The motor rotation angle detection unit 47RS, the output link pivot angle detection unit 43RS, and the spiral spring 45R correspond to a torque detection unit that outputs torque-related signals about the combined torque obtained by combining the user torque and the assist torque. A detection signal from the motor rotation angle detection unit 47RS (a detection signal corresponding to a rotation angle of the motor shaft of the electric motor 47R), and a detection signal from the output link pivot angle detection unit 43RS (a detection signal corresponding to a pivot angle of the assist arm 51R) correspond to the torque-related signals.

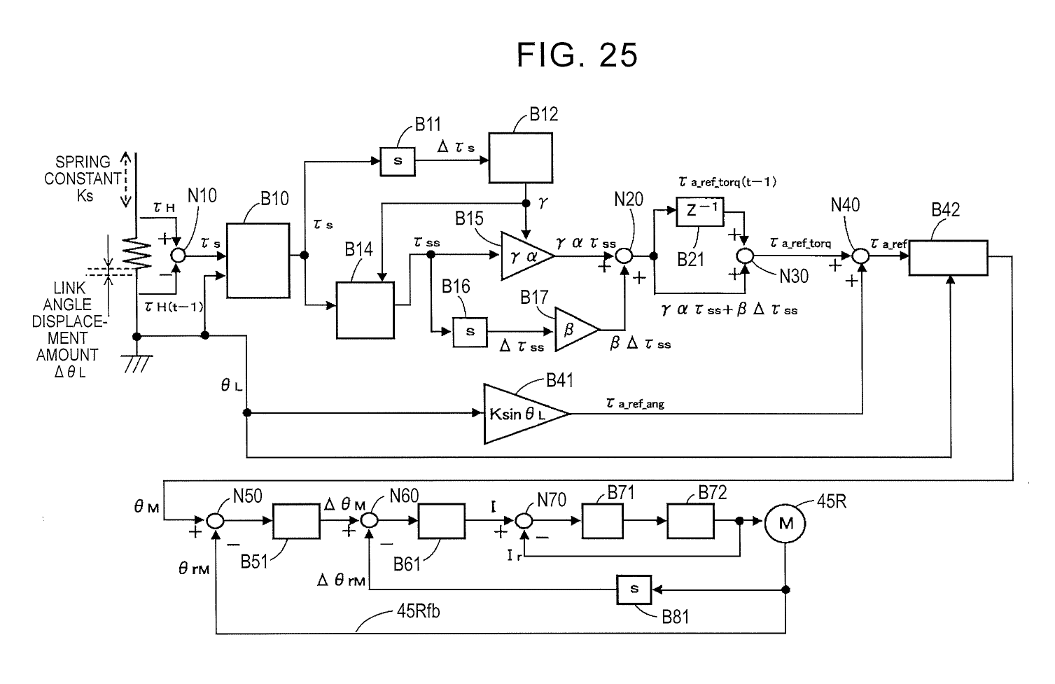

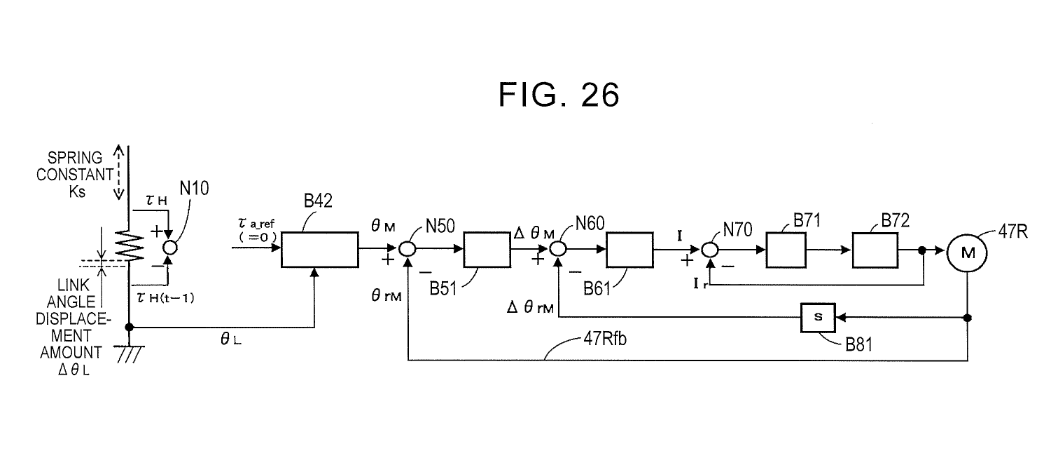

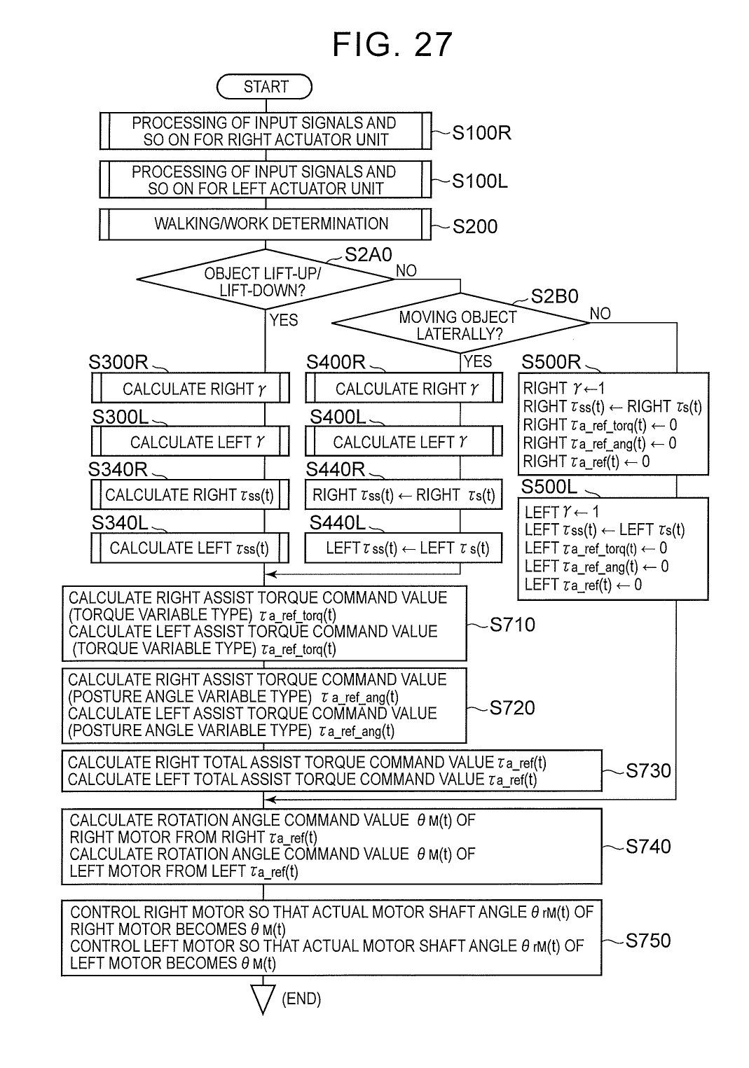

The processing sequence of the control device 61 will be described using the flowchart illustrated in FIG. 27 and the control blocks illustrated in FIGS. 25 and 26. The control blocks illustrated in FIG. 25 are control blocks when the result of walking/work determination is “object lift-up/lift-down” or “moving object laterally” at step S200 in FIG. 27. The control blocks illustrated in FIG. 26 are control blocks when the result of walking/work determination is “walking” at step S200 in FIG. 27. The control blocks illustrated in FIGS. 25 and 26 are blocks for controlling the (right) actuator unit 4R (see FIG. 1). Since blocks for controlling the (left) actuator unit 4L (see FIG. 1) are the same control blocks as those illustrated in FIGS. 25 and 26, an illustration thereof is omitted. The flowchart illustrated in FIG. 27 shows the processing sequence of controlling the (right) actuator unit 4R and the (left) actuator unit 4L. Processing illustrated in FIG. 27 is started at a predetermined time interval (e.g., a time interval of several ms), and when the processing is started, the control device 61 proceeds to step S100R.

At step S100R, the control device 61 performs processing of input signals and so on for the (right) actuator unit 4R and proceeds to step S100L. At step S100L, the control device 61 performs processing of input signals and so on for the (left) actuator unit 4L and proceeds to step S200. The processing of steps S100R and S100L will be described in detail later. The processing of steps S100R, S100L corresponds to processing of node N10 in FIG. 25. The control device 61 performing the processing of steps S100R, S100L functions as a torque determination unit (the torque determination unit 61A illustrated in FIG. 24) that determines torque-related information including the combined torque and the user torque based on torque-related signals (a detection signal corresponding to a rotation angle of the motor shaft of the electric motor 47R and a detection signal corresponding to a pivot angle of the assist arm 51R) from the torque detection unit.

At step S200, the control device 61 determines the kind of motion of the user based on the determined torque-related information and proceeds to step S2A0. While details of the processing of step S200 will be described later, the determined kind of motion is “walking”, “object lift-up/lift-down”, or “moving object laterally”. Here, “walking” is a walking motion of the user, “object lift-up/lift-down” is a motion in which the user lifts up a heavy object or a motion in which the user lowers a heavy object held by the user, and “moving object laterally” is a motion in which the user holds and moves a heavy object from the right to the left or from the left to the right. The processing of step S200 corresponds to processing of block B10 in FIG. 25. The control device 61 performing the processing of step S200 functions as a motion kind determination unit (the motion kind determination unit 61B illustrated in FIG. 24) that determines the kind of motion of the user based on the determined torque-related information.

At step S2A0, the control device 61 determines whether the determined kind of motion is “object lift-up/lift-down”. When the determined kind of motion is “object lift-up/lift-down” (Yes), the control device 61 proceeds to step S300R, and when it is not “object lift-up/lift-down” (No), the control device 61 proceeds to step S2B0. When the control device 61 has proceeded to step S2B0, the control device 61 determines whether the determined kind of motion is “moving object laterally”. When the determined kind of motion is “moving object laterally” (Yes), the control device 61 proceeds to step S400R, and when it is not “moving object laterally” (No), the control device 61 proceeds to step S500R.

Steps S300R, S300L, S340R, and S340L define processing when the kind of motion is “object lift-up/lift-down”. When the control device 61 has proceeded to step S300R, the control device 61 calculates (right) γ and proceeds to step S300L. The control device 61 calculates (left) γ at step S300L and proceeds to step S340R. Details of calculation of (right) γ and calculation of (left) γ will be described later. Here, (right) γ is a gain (coefficient) for correcting the magnitude of the assist torque of the (right) actuator unit. Likewise, (left) γ is a gain (coefficient) for correcting the magnitude of the assist torque of the (left) actuator unit. The calculation of (right) γ, (left) γ corresponds to processing of blocks B11 and B12 in FIG. 25.

At step S340R, the control device 61 calculates (right) τₛₛ(t) and proceeds to step S340L. The control device 61 calculates (left) τₛₛ(t) at step S340L and proceeds to step S710. Details of calculation of (right) τₛₛ(t) and calculation of (left) τₛₛ(t) will be described later. Here, (right) τₛₛ(t) is for making correction so as to shorten the time until the assist torque of the (right) actuator unit reaches its peak (to advance the phase), while (left) τₛₛ(t) is for making correction so as to shorten the time until the assist torque of the (left) actuator unit reaches its peak (to advance the phase). The calculation of (right) τₛₛ(t), (left) τₛₛ(t) corresponds to processing of block B14 in FIG. 25.

Steps S400R, S400L, S440R, and S440L define processing when the kind of motion is “moving object laterally”. After the control device 61 has proceeded to step S400R, the control device 61 calculates (right) γ and proceeds to step S400L. The control device 61 calculates (left) γ at step S400L and proceeds to step S440R. Calculation of (right) γ and calculation of (left) γ are the same as steps S300R and S300L, details of which will be described later. Then, at step S440R, the control device 61 substitutes (right) τₛ(t) for (right) τₛₛ(t) and stores it, and then at step S440L, the control device 61 substitutes (left) τₛ(t) for (left) τₛₛ(t) and stores it. The control device 61 then proceeds to step S710.

Steps S500R and S500L define processing when the kind of motion is “walking”. In the present embodiment, a description will be provided on an example in which the assist torque is generated by the control blocks illustrated in FIG. 25 in the case of “object lift-up/lift-down” or “moving object laterally”, while, in the case of “walking”, control is performed by the control blocks illustrated in FIG. 26 such that the assist torque is not generated (τₐ_{_}_{ref}=0). In the case of “walking”, the control device 61 controls the rotation angle of the electric motor 47R in accordance with a pivot angle of the assist arm 51R such that the spiral spring 45R is not expanded or contracted.

When the control device 61 has proceeded to step S500R, the control device 61 substitutes 1 for (right) γ and stores it, and substitutes (right) τₛ(t) for (right) τₛₛ(t) and stores it. Further, the control device 61 substitutes zero for (right) τₐ_{_}_{ref}_{_}_{torq}(t), (right) τₐ_{_}_{ref}_{_}_{ang}(t), and (right) τₐ_{_}_{ref}(t) and stores them. The control device 61 then proceeds to step S500L. At step S500L, the control device 61 substitutes 1 for (left) γ and stores it, and substitutes (left) τₛ(t) for (left) τₛₛ(t) and stores it. Further, the control device 61 substitutes zero for (left) τₐ_{_}_{ref}_{_}_{torq}(t), (left) τₐ_{_}_{ref}_{_}_{ang}(t), and (left) τₐ_{_}_{ref}(t) and stores them. The control device 61 then proceeds to step S740.

At step S710, the control device 61 calculates a (right) assist torque command value (torque variable type) τₐ_{_}_{ref}_{_}_{torq}(t) by Expression 1 given below and stores it, and calculates a (left) assist torque command value (torque variable type) τₐ_{_}_{ref}_{_}_{torq}(t) by Expression 2 given below and stores it. Then, the control device 61 proceeds to step S720. The processing of step S710 corresponds to processing of blocks B15, B16, and B17, node N20, block B21, and node N30 in FIG. 25.

(right) τₐ_{_}_{ref}_{_}_{torq}(t)=(right) τₐ_{_}_{ref}_{_}_{torq}(t−1)+(right) γ*α*(right) τₛₛ(t)+β*(right) Δτₛₛ(t) Expression 1

(left) τₐ_{_}_{ref}_{_}_{torq}(t)=(left) τₐ_{_}_{ref}_{_}_{torq}(t−1)+(left) γ*α*(left) τₛₛ(t)+β*(left) Δτₛₛ(t) Expression 2
(right) τₐ_{_}_{ref}_{_}_{torq}(t): (right) assist torque command value (torque variable type)
(left) τₐ_{_}_{ref}_{_}_{torq}(t): (left) assist torque command value (torque variable type)
(right) γ: (right) torque correction gain
(left) γ: (left) torque correction gain
α: (right/left) assist multiplying factor
β: (right/left) differential correction gain
(right) τₛₛ(t): (right) torque change amount (after phase correction)
(left) τₛₛ(t): (left) torque change amount (after phase correction)

At step S720, the control device 61 calculates a (right) assist torque command value (posture angle variable type) τₐ_{_}_{ref}_{_}_{ang}(t) using Expression 3 given below and stores it, and calculates a (left) assist torque command value (posture angle variable type) τₐ_{_}_{ref}_{_}_{ang}(t) using Expression 4 given below and stores it. Then, the control device 61 proceeds to step S730. The processing of step S720 corresponds to processing of block B41 in FIG. 25. A posture correction gain K is, for example, a value within a range of 0 to 10 (0≤K≤10) and is a gain (a constant) that is set in accordance with the required assist amount, the time interval of the processing (sampling time), the detection resolution of the output link pivot angle detection unit, the detection resolution of the motor rotation angle detection unit, the height and weight of the user, and so on.

(right) τₐ_{_}_{ref}_{_}_{ang}(t)=K*sin (right) θ_{L}(t) Expression 3

(left) τₐ_{_}_{ref}_{_}_{ang}(t)=K*sin (left) θ_{L}(t) Expression 4
(right) τₐ_{_}_{ref}_{_}_{ang}(t): (right) assist torque command value (posture angle variable type)
(left) τₐ_{_}_{ref}_{_}_{ang}(t): (left) assist torque command value (posture angle variable type)
K: (right/left) posture correction gain
(right) θ_{L}(t): (right) actual link angle
(left) θ_{L}(t): (left) actual link angle

At step S730, the control device 61 calculates a (right) total assist torque command value τₐ_{_}_{ref}(t) using Expression 5 given below and stores it, and calculates a (left) total assist torque command value τₐ_{_}_{ref}(t) using Expression 6 given below and stores it. Then, the control device 61 proceeds to step S740. The processing of step S730 corresponds to processing of node N40 in FIG. 25.

(right) τₐ_{_}_{ref}(t)=(right) τₐ_{_}_{ref}_{_}_{torq}(t)+(right) τₐ_{_}_{ref}_{_}_{ang}(t) Expression 5

(left) τₐ_{_}_{ref}(t)=(left) τₐ_{_}_{ref}_{_}_{torq}(t)+(left) τₐ_{_}_{ref}_{_}_{ang}(t) Expression 6
(right) τₐ_{_}_{ref}(t): (right) total assist torque command value
(left) τₐ_{_}_{ref}(t): (left) total assist torque command value

The control device 61 performing the processing from steps S2A0 and S2B0 to step S730 described above functions as an assist torque calculation unit (the assist torque calculation unit 61C illustrated in FIG. 24) that calculates an assist torque based on the determined torque-related information, and as a correction unit (the correction unit 61D illustrated in FIG. 24) that corrects the calculated assist torque based on the determined kind of motion.

At step S740, the control device 61 calculates a (right) motor rotation angle command value θ_{M}(t) from (right) τₐ_{_}_{ref}(t) using Expression 8 obtained by rearranging Expression 7 given below and stores it, and calculates a (left) motor rotation angle command value θ_{M}(t) from (left) τₐ_{_}_{ref}(t) using Expression 10 obtained by rearranging Expression 9 given below and stores it. Then, the control device 61 proceeds to step S750. The processing of step S740 corresponds to processing of block B42 in FIG. 25.

(right) τₐ_{_}_{ref}(t)=na*Ks*[na*(right) θ_{L}(t)−((right) θ_{M}(t)/nb)] Expression 7

(right) θ_{M}(t)=[(na²*Ks*(right) θ_{L}(t)−(right) τₐ_{_}_{ref}(t))*nb]/(na*Ks) Expression 8

(left) τₐ_{_}_{ref}(t)=na*Ks*[na*(left) θ_{L}(t)−((left) θ_{M}(t)/nb)] Expression 9

(left) θ_{M}(t)=[(na²*Ks*(left) θ_{L}(t)−(left) τₐ_{_}_{ref}(t))*nb]/(na*Ks) Expression 10
Ks: spring constant of the spiral spring 45R
(right) θ_{M}(t): (right) motor rotation angle command value
(left) θ_{M}(t): (left) motor rotation angle command value
na and nb: when the decelerating shaft 42RA of the speed reducer 42R is rotated by na, the accelerating shaft 42RB is rotated by nb (na<nb)

At step S750, the control device 61 controls the (right) electric motor 47R so that (right) θ_{rM}(t) as an actual motor shaft angle of the (right) electric motor 47R becomes (right) θ_{M}(t), and controls a (left) electric motor so that (left) θ_{rM}(t) as an actual motor shaft angle of the (left) electric motor becomes (left) θ_{M}(t). Then, the control device 61 ends the processing. The control device 61 performing the processing of steps S740 and S750 described above functions as a pivot angle control unit (the pivot angle control unit 61E illustrated in FIG. 24) that controls the pivot angle (rotation angle) of the output shaft of each electric motor based on the assist torque corrected by the correction unit. The processing of step 5750 corresponds to processing of node N50, block B51, node N60, blocks B61 and B81, node N70, and blocks B71 and B72 in FIG. 25. The processing of step S750 is feedback control performed such that, when a rotation angle command value is converted into a command current and the command current is output by converting it into a PWM-output duty cycle, proportional integral derivative (PID) control is performed based on a deviation between the command value and an actual value. Since the control is the same as the existing control, a description thereof will be omitted.

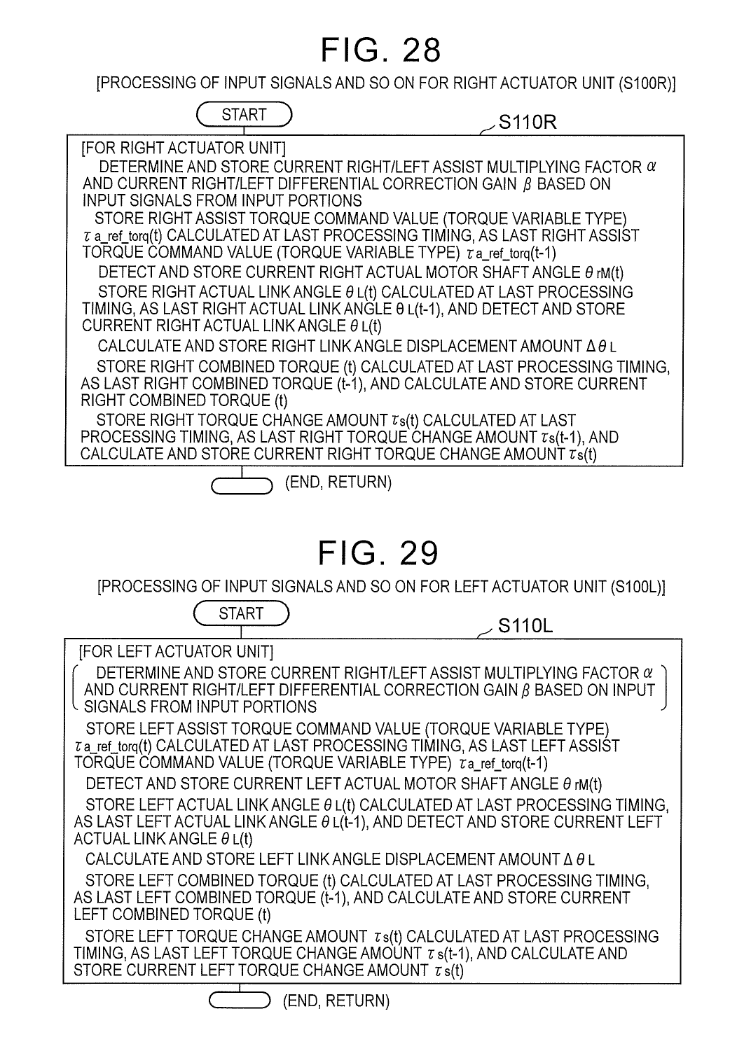

FIG. 28 illustrates processing of step S110R that is details of the processing of step S100R (processing of input signals and so on for the (right) actuator unit 4R) (see FIG. 27). As illustrated in FIG. 28, at step S110R, based on input signals from the input portions 33RS (see FIG. 2), the control device 61 determines and stores a current (right/left) assist multiplying factor α and a current (right/left) differential correction gain β. The assist multiplying factor α and the differential correction gain β are used commonly for the right and left actuator units.

Further, the control device 61 stores a (right) assist torque command value (torque variable type) τₐ_{_}_{ref}_{_}_{torq}(t) calculated at the last processing timing, as a last (right) assist torque command value (torque variable type) τₐ_{_}_{ref}_{_}_{torq}(t−1). Further, the control device 61 stores a (right) motor shaft angle detected at the current processing timing, as a (right) actual motor shaft angle θ_{rM}(t).

Further, the control device 61 stores a (right) actual link angle θ_{L}(t) calculated at the last processing timing, as a last (right) actual link angle θ_{L}(t−1) and stores a pivot angle of the output link (the assist arm 51R) detected at the current processing timing, as a (right) actual link angle θ_{L}(t). Then, the control device 61 calculates a (right) link angle displacement amount Δθ_{L}(t) using Expression 11 given below and stores it.

(right) Δθ(t)=(right) θ_{L}(t)−(right) θ_{L}(t−1) Expression 11
(right) θ_{L}(t): (right) actual link angle
(right) Δθ_{L}(t): (right) link angle displacement amount

Further, the control device 61 stores a (right) combined torque (t) calculated at the last processing timing, as a last (right) combined torque (t−1), calculates a current (right) combined torque (t) with the use of Expression 12 given below using the spring constant Ks of the spiral spring 45R (see FIG. 19), the current (right) actual link angle θ_{L}(t), and the current (right) actual motor shaft angle θ_{rM}(t), and stores it. The combined torque can be calculated based on the actual motor shaft angle θ_{rM}(t) of the electric motor 47R, the actual link angle θ_{L}(t) of the output link (the assist arm 51R), the spring constant Ks of the spiral spring 45R, the reduction ratio of the speed reducer 42R, and the like.

(right) combined torque (t)=Ks*(expanded/contracted amount of the spiral spring 45R) Expression 12

Further, the control device 61 stores a (right) torque change amount τₛ(t) calculated at the last processing timing, as a last (right) torque change amount τₛ(t−1), calculates a current (right) torque change amount τₛ(t) using Expression 13 given below, and stores it.

(right) τₛ(t)=Ks*(right) Δθ_{L}(t) Expression 13
(right) τₛ(t): (right) torque change amount

Step S100L (see FIG. 27) is processing that is performed subsequently to step S100R and is processing of input signals and so on for the (left) actuator unit 4L. FIG. 29 illustrates processing of step S110L that is details of the processing of step S100L (processing of input signals and so on for the (left) actuator unit 4L). Since the processing of step S110L is the same as step S100R that is the processing of input signals and so on for the (right) actuator unit 4R, a description thereof will be omitted.

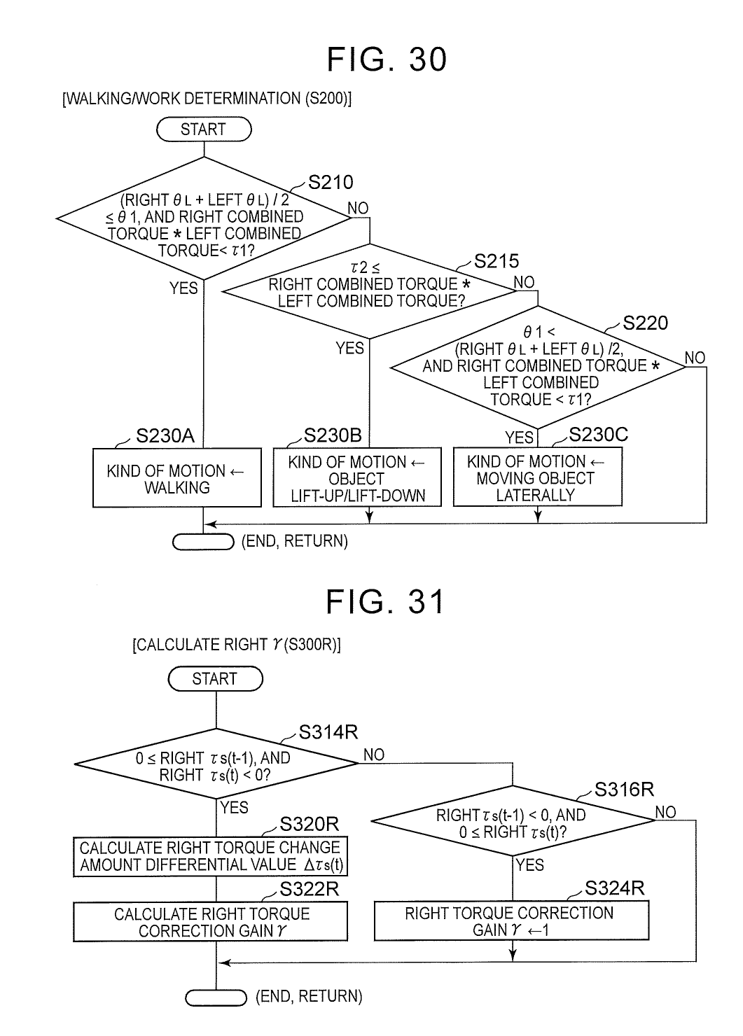

Step S200 (see FIG. 27) is processing of determining the kind of motion of the user, i.e., processing of determining which of “walking”, “object lift-up/lift-down”, and “moving object laterally (moving an object from the right to the left (or from the left to the right))” the motion of the user is. FIG. 30 illustrates processing of steps S210 to S230C as details of the processing of step S200 (walking/work determination).

At step S210 (see FIG. 30), the control device 61 determines whether [(right) θ_{L}(t)+(left) θ_{L}(t)]/2 is equal to or less than a preset first angle threshold value θ1, and further, (right) combined torque (t)*(left) combined torque (t) is less than a preset first torque threshold value τ1. If the determination is affirmative (Yes), the control device 61 determines that the motion of the user is “walking”, and proceeds to step S230A, but if the determination is negative (No), the control device 61 proceeds to step S215.

When the control device 61 has proceeded to step S215, the control device 61 determines whether (right) combined torque (t)*(left) combined torque (t) is equal to or greater than a preset second torque threshold value τ2. When it is equal to or greater than the second torque threshold value τ2 (Yes), the control device 61 determines that the motion of the user is “object lift-up/lift-down”, and proceeds to step S230B, but when it is not equal to or greater than the second torque threshold value τ2 (No), the control device 61 proceeds to step S220.

When the control device 61 has proceeded to step S220, the control device 61 determines whether [(right) θ_{L}(t)+(left) θ_{L}(t)]/2 is greater than the preset first angle threshold value θ1, and further, (right) combined torque (t)*(left) combined torque (t) is less than the preset first torque threshold value τ1. If the determination is affirmative (Yes), the control device 61 determines that the motion of the user is “moving object laterally”, and proceeds to step S230C, but if the determination is negative (No), the control device 61 ends the processing.

When the control device 61 has proceeded to step S230A, the control device 61 stores “walking” as the kind of motion and ends the processing. When the control device 61 has proceeded to step S230B, the control device 61 stores “object lift-up/lift-down” as the kind of motion and ends the processing. When the control device 61 has proceeded to step S230C, the control device 61 stores “moving object laterally” as the kind of motion and ends the processing.

Step S300R (see FIG. 27) corresponds to the processing of blocks B11 and B12 illustrated in FIG. 25 and is processing of calculating y that is used in block B15. FIG. 31 illustrates processing of steps S314R to S324R that are details of the processing of step S300R (CALCULATE RIGHT γ). While step S300R is the processing for the (right) actuator unit, step S300L is the processing for the (left) actuator unit. Since step S300L is the same as step S300R, a description of the processing of step S300L will be omitted.

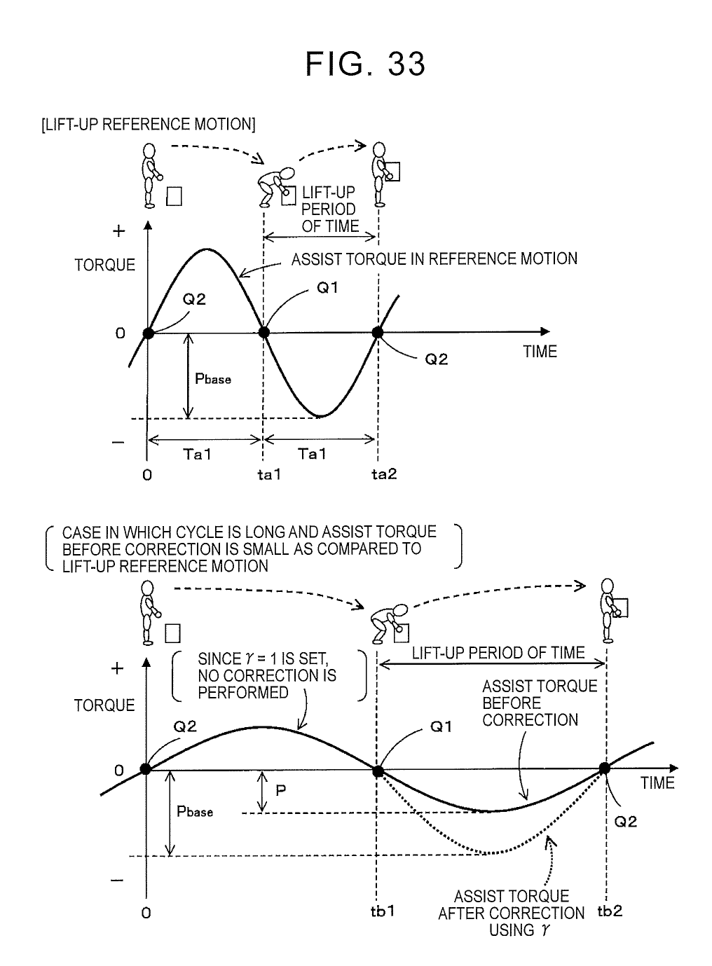

At step S314R (see FIG. 31), the control device 61 determines whether (right) τₛ(t−1) is equal to or greater than zero, and further, (right) τₛ(t) is less than zero. This determination determines whether a current point of time is Q1 at which the assist torque changes from positive to negative in FIG. 33 having the abscissa axis representing time and the ordinate axis representing the assist torque, and illustrating an example of an object lift-up motion. If the determination is affirmative (Yes), the control device 61 proceeds to step S320R, but if the determination is negative (No), the control device 61 proceeds to step S316R.

Note that, [LIFT-UP REFERENCE MOTION] illustrated in FIG. 33 indicates an example of a reference motion set in advance for an object lift-up motion. FIG. 33 illustrates a state of change in the assist torque (in the reference motion) with the passage of time in a case where the user bends the waist from an upright posture and lays hands on an object at the user's feet in a preset first reference time Ta1, and then, the user lifts up the object and takes an upright posture in another first reference time Ta1. Further, the assist torque on the positive side (+ side) represents a torque that assists a motion of bending the waist forward, while the assist torque on the negative side (− side) represents a torque that assists a motion of stretching the forward-bent waist. Further, [CASE IN WHICH CYCLE IS LONG AND ASSIST TORQUE BEFORE CORRECTION IS SMALL AS COMPARED TO LIFT-UP REFERENCE MOTION] illustrated in FIG. 33 indicates an example when the motion of the user is slower than preset [LIFT-UP REFERENCE MOTION], and further, the assist torque before correction is smaller than the assist torque in [LIFT-UP REFERENCE MOTION].

When the control device 61 has proceeded to step S316R, the control device 61 determines whether (right) τₛ(t−1) is less than zero, and further, (right) τₛ(t) is equal to or greater than zero. This determination determines whether a current point of time is Q2 at which the assist torque changes from negative to positive in FIG. 33. If the determination is affirmative (Yes), the control device 61 proceeds to step S324R, but if the determination is negative (No), the control device 61 ends the processing.

When the control device 61 has proceeded to step S320R (in the case of the position of Q1 in FIG. 33), the control device 61 calculates a (right) torque change amount differential value Δτₛ(t) using Expression 14 given below and stores it, and proceeds to step S322R.

(right) Δτₛ(t)=(right) τₛ(t)−(right) τₛ(t−1) Expression 14

At step S322R, the control device 61 calculates a (right) torque correction gain γ using Expression 15 given below and stores it, and ends the processing. A (right) torque correction gain γ may be calculated using Expression 16 given below and stored. In Expression 15, (right) Δτ_{s,max} is an inclination, at the position of Q1, of a graph of τₛ(t) corresponding to [LIFT-UP REFERENCE MOTION] illustrated in FIG. 33. In Expression 15, (right) Δτₛ is an inclination, at the position of Q1, of a graph of τₛ(t) corresponding to an actual motion of the user. In Expression 16, (d/dt) (right) Δθ_{L,max} is a differential value of (right) Δθ_{L} at the position of Q1 corresponding to [LIFT-UP REFERENCE MOTION] illustrated in FIG. 33. In Expression 16, (d/dt) (right) Δθ_{L} is a differential value of (right) Δθ_{L} at the position of Q1 corresponding to an actual motion of the user.

(right) γ=√((right) Δτ_{s,max}/(right) Δτₛ) Expression 15

(right) γ=√[((d/dt) (right) Δθ_{L,max})/((d/dt) (right) Δθ_{L})] Expression 16

Note that (right) γ is a gain for making correction such that, in [CASE IN WHICH CYCLE IS LONG AND ASSIST TORQUE BEFORE CORRECTION IS SMALL AS COMPARED TO LIFT-UP REFERENCE MOTION] illustrated in FIG. 33, an assist torque maximum value (P) before correction from time tb1 to time tb2 becomes an assist torque maximum value (P_{base}) in [LIFT-UP REFERENCE MOTION].

When the control device 61 has proceeded to step S324R (in the case of the position of Q2 in FIG. 33), the control device 61 substitutes 1 for (right) γ and stores it, and ends the processing. When the value of (right) γ is 1, correction of an assist torque maximum value is not performed.

Using (right) γ calculated by the sequence described above, assist torque amount correction for correcting the magnitude of the assist torque is performed from time tb1 to time tb2, i.e., during a lift-up period of time from the start of lift-up until the completion of lift-up, in [CASE IN WHICH CYCLE IS LONG AND ASSIST TORQUE BEFORE CORRECTION IS SMALL AS COMPARED TO LIFT-UP REFERENCE MOTION] illustrated in FIG. 33. When this assist torque amount correction is performed, the value of (right) γ changes depending on the inclination of (right) τₛ(t) at the position of Q1 as shown by Expression 15 or Expression 16. The inclination of (right) τₛ(t) at the position of Q1 changes in accordance with the length of the lift-up period of time such that when the length of the lift-up period of time is short, the inclination of (right) τₛ(t) at the position of Q1 becomes large, and when the length of the lift-up period of time is long, the inclination of (right) τₛ(t) at the position of Q1 becomes small. Accordingly, the rate of increase caused by the assist torque amount correction is adjusted by changing of the value of (right) γ in accordance with the length of the lift-up period of time. Specifically, when the actual lift-up period of time is longer than the lift-up period of time (Ta1) in the reference motion illustrated in FIG. 33, (right) γ>1 is established, and thus, the assist torque is increased. On the other hand, when the actual lift-up period of time is shorter than the lift-up period of time (Ta1) in the reference motion illustrated in FIG. 33, (right) γ<1 is established, and thus, the assist torque is reduced. Consequently, regardless of the length of the actual lift-up period of time, the assist torque maximum value in the lift-up period of time becomes the assist torque maximum value (P_{base}) in the lift-up period of time in the reference motion of FIG. 33.

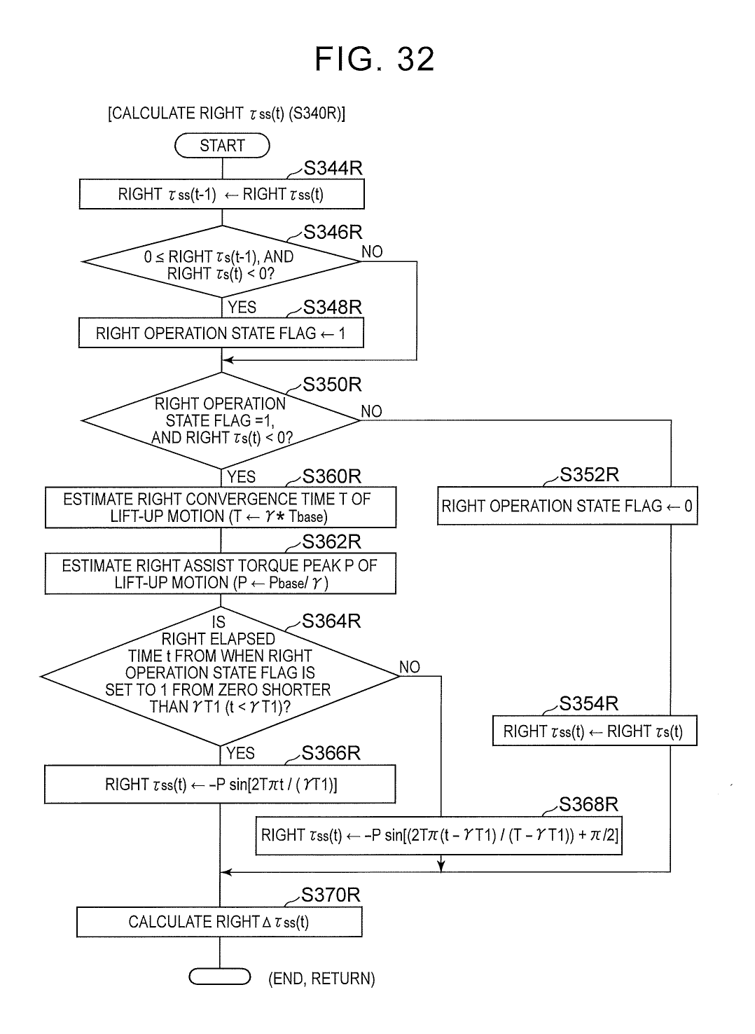

Step S340R (see FIG. 27) corresponds to the processing of block B14 illustrated in FIG. 25 and is processing of calculating a (right) torque change amount τₛₛ(t) that will be used thereafter. FIG. 32 illustrates processing of steps S344R to 5370R that are details of the processing of step S340R (CALCULATE RIGHT τₛₛ(t)). While step S340R is the processing for the (right) actuator unit, step S340L is the processing for the (left) actuator unit. Since step S340L is the same as step S340R, a description of the processing of step S340L will be omitted.

At step S344R (see FIG. 32), the control device 61 substitutes (right) τₛₛ(t) for (right) τₛₛ(t−1) and stores (right) τₛₛ(t−1).

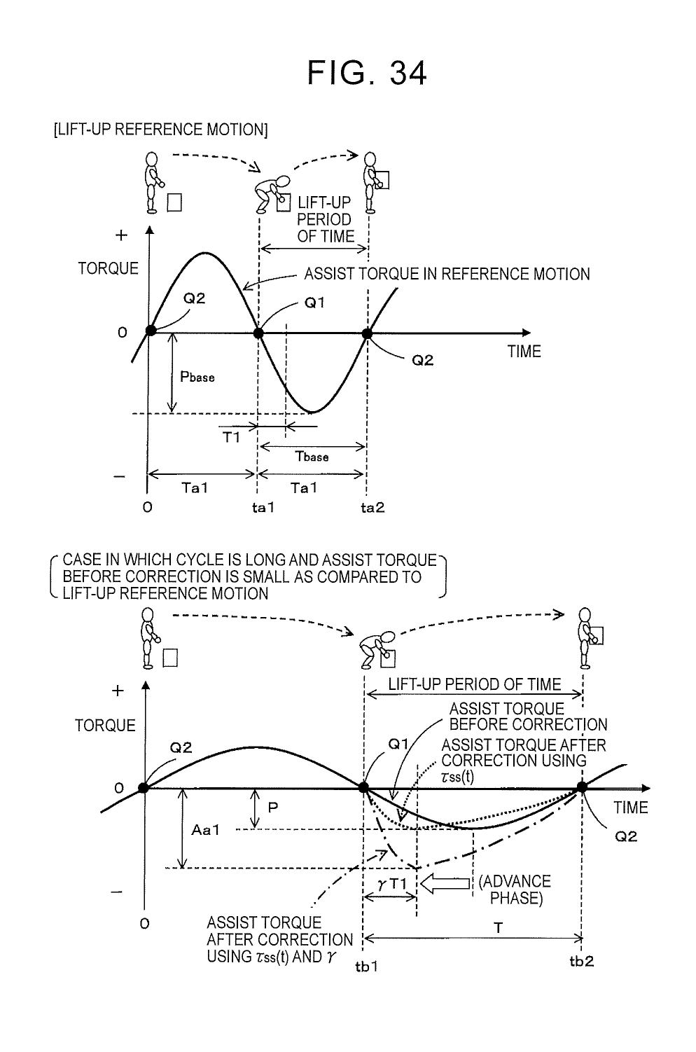

At step S346R, the control device 61 determines whether (right) τₛ(t−1) is equal to or greater than zero, and further, (right) τₛ(t) is less than zero (negative). This determination determines whether a current point of time is Q1 at which the assist torque changes from positive to negative in FIG. 34 illustrating an example of an object lift-up motion. If the determination is affirmative (Yes), the control device 61 proceeds to step S348R, but if the determination is negative (No), the control device 61 proceeds to step S350R.

When the control device 61 has proceeded to step S348R, the control device 61 substitutes 1 for a (right) operation state flag and stores it, and proceeds to step S350R.

When the control device 61 has proceeded to step S350R, the control device 61 determines whether the (right) operation state flag is 1, and further, (right) τₛ(t) is less than zero (negative). This determination determines whether a current point of time is a “lift-up period of time” in which the assist torque is in a negative state in FIG. 34 having the abscissa axis representing time and the ordinate axis representing the assist torque, and illustrating an example of an object lift-up motion. If the determination is affirmative (Yes), the control device 61 proceeds to step S360R, but if the determination is negative (No), the control device 61 proceeds to step S352R.

Note that [LIFT-UP REFERENCE MOTION] illustrated in FIG. 34 indicates, like [LIFT-UP REFERENCE MOTION] illustrated in FIG. 33, an example of a reference motion set in advance for an object lift-up motion. FIG. 34 illustrates a state of change in the assist torque with the passage of time in a case where the user bends the waist from an upright posture and lays hands on an object at the user's feet in a preset first reference time Ta1, and then, the user lifts up the object and takes an upright posture in another first reference time Ta1. Further, the assist torque on the positive side (+ side) represents a torque that assists a motion of bending the waist forward, while the assist torque on the negative side (− side) represents a torque that assists a motion of stretching the forward-bent waist. Further, [CASE IN WHICH CYCLE IS LONG AND ASSIST TORQUE BEFORE CORRECTION IS SMALL AS COMPARED TO LIFT-UP REFERENCE MOTION] illustrated in FIG. 33 indicates an example when the motion of the user is slower than preset [LIFT-UP REFERENCE MOTION], and further, the assist torque before correction is smaller than the assist torque in [LIFT-UP REFERENCE MOTION].

When the control device 61 has proceeded to step S352R (in the case of a period of time from the position of Q2 to the position of Q1 in FIG. 34), the control device 61 substitutes zero for the (right) operation state flag and stores it, and proceeds to step S354R. Then, at step S354R, the control device 61 substitutes (right) τₛ(t) for (right) τₛₛ(t) and stores it, and proceeds to step S370R.

When the control device 61 has proceeded to step S360R (in the case of a lift-up period of time from the position of Q1 to the position of Q2 in FIG. 34), the control device 61 calculates (estimates) a (right) convergence time T of a lift-up motion of the user using Expression 17 given below and stores it, and proceeds to step S362R. Note that T_{base} is the length of “LIFT-UP PERIOD OF TIME” illustrated in [LIFT-UP REFERENCE MOTION] of FIG. 34 that is the preset reference motion of the lift-up motion. The (right) convergence time T represents a time from when the user holds an object and starts lift-up of the object until the completion of lift-up of the object, while T_{base} represents a time from the start of lift-up of an object until the completion of lift-up of the object in the reference motion.

(right) T=(right) γ*T_{base} Expression 17
(right) T: estimated time ((right) convergence time) from when the user actually starts lift-up of an object until the completion of lift-up of the object
T_{base}: time from the start of lift-up of an object until the completion of lift-up of the object in the reference motion (=lift-up period of time in the reference motion)

At step S362R, the control device 61 calculates (estimates) a (right) assist torque peak value P in the lift-up period of time of the user using Expression 18 given below and stores it, and proceeds to step S364R. Note that P_{base} is a maximum value of the magnitude of the assist torque in “LIFT-UP PERIOD OF TIME” illustrated in [LIFT-UP REFERENCE MOTION] of FIG. 34.

(right) P=P_{base}/(right) γ Expression 18
(right) P: maximum value (estimated maximum value) of the assist torque in an actual lift-up period of time of the user
P_{base}: maximum value of the assist torque in a lift-up period of time in the reference motion

At step S364R, the control device 61 determines whether a (right) elapsed time t from when the (right) operation state flag is set to 1 from 0 is shorter than a value (γT1) obtained by multiplying a preset peak reaching reference time T1 by (right) γ. If the determination is affirmative (Yes), the control device 61 proceeds to step S366R, and if the determination is negative (No), the control device 61 proceeds to step S368R. The peak reaching reference time T1 is a time that is determined by various experiments and so on. As a result of various experiments, the inventors have found that when the user starts lift-up of an object, it is effective to adjust the position of a peak value of the assist torque in accordance with the length of a lift-up motion time (the slowness of a lift-up motion). The peak reaching reference time T1 is set as an optimal time from the start of a lift-up motion until the assist torque reaches its peak in the reference motion.

When the control device 61 has proceeded to step S366R, the control device 61 calculates (right) τₛₛ(t) using Expression 19 given below and stores it, and proceeds to step S370R.

(right) τₛₛ(t)=−(right) P*sin [2*(right) T*π*(right) t/(γ*T1)] Expression 19
(right) t: elapsed time from when the (right) operation state flag is set to 1 from 0
T1: peak reaching reference time

When the control device 61 has proceeded to step S368R, the control device 61 calculates (right) τₛₛ(t) using Expression 20 given below and stores it, and proceeds to step S370R.

(right) τₛₛ(t)=−(right) P*sin {[2*(right) T*π*((right) t−γ*T1)]/[(right) T−γ*T1]+π/2} Expression 20

When the control device 61 has proceeded to step S370R, the control device 61 calculates (right) Δτₛₛ(t) using Expression 21 given below and stores it, and ends the processing.

(right) Δτₛₛ(t)=(right) τₛₛ(t)−(right) τₛₛ(t−1) Expression 21

Using (right) τₛₛ(t) calculated by the sequence described above, assist torque phase correction for correcting the position of the peak of the assist torque in a lift-up period of time so as to move the position of the peak to a position after the lapse of γT1 from the start of lift-up is performed in [CASE IN WHICH CYCLE IS LONG AND ASSIST TORQUE BEFORE CORRECTION IS SMALL AS COMPARED TO LIFT-UP REFERENCE MOTION] illustrated in FIG. 34. When the assist torque phase correction is performed, since the value of (right) y changes in accordance with the estimated lift-up period length (T), the time (γT1) from the start of lift-up to the assist torque peak is adjusted in accordance with the estimated lift-up period length (T).

As described above, the assist device 1 according to the present embodiment can generate an assist torque that is appropriately corrected in accordance with the motion of the user (“walking”, “object lift-up/lift-down”, or “moving object laterally”). For example, when the motion of the user is slow in “object lift-up”, the assist torque can be appropriately increased by a torque correction gain γ. Further, for example, when the motion of the user is slow in “object lift-up”, the position of the peak of the assist torque can be set to an appropriate timing by shortening the time to the peak of the assist torque using τₛₛ(t).

When the body wearing unit 2 (see FIG. 2) has an appropriate structure, the user can easily wear it. Further, the right actuator unit 4R (and the left actuator unit 4L) has the simple structure as illustrated in FIG. 19, and it is not necessary to attach biological signal detection sensors to the user. The control performed by the control device 61 of the right actuator unit 4R (and the left actuator unit 4L) is also relatively simple control as described using FIGS. 25 to 34.

In the description of the present embodiment, the kinds of motions to be determined are three kinds, i.e., “walking”, “object lift-up/lift-down”, and “moving object laterally”. However, determination on work that includes “object lift-up/lift-down”, and does not include “walking” may be performed. Alternatively, determination on work that includes “object lift-up/lift-down” and “moving object laterally”, and does not include “walking” may be performed.

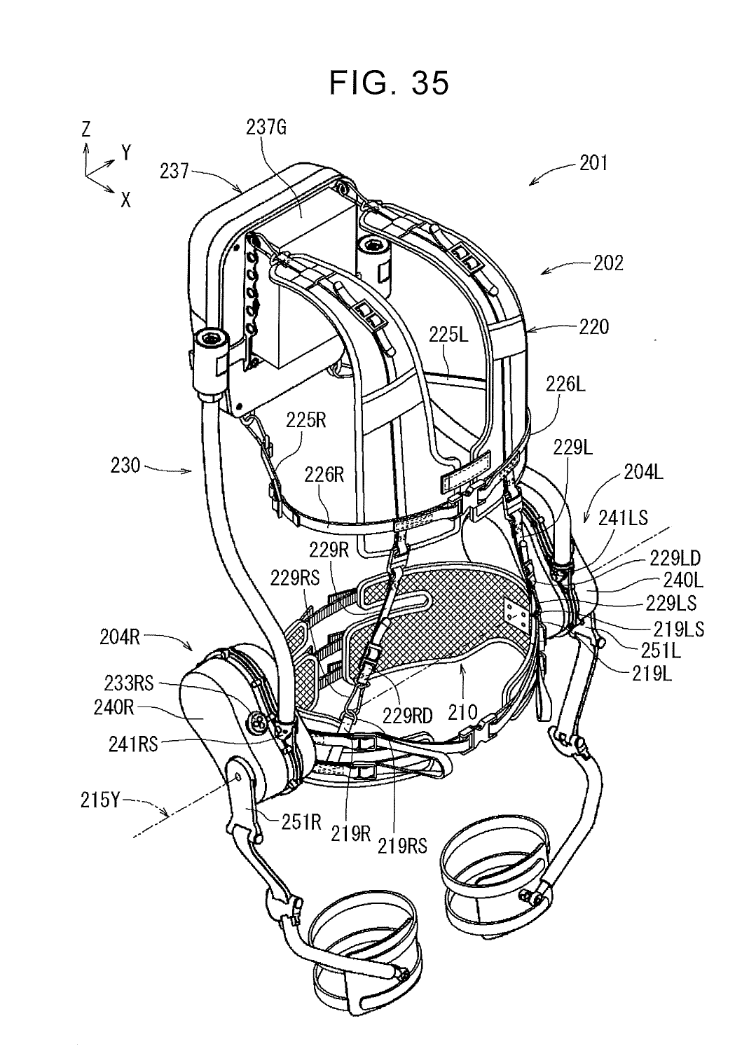

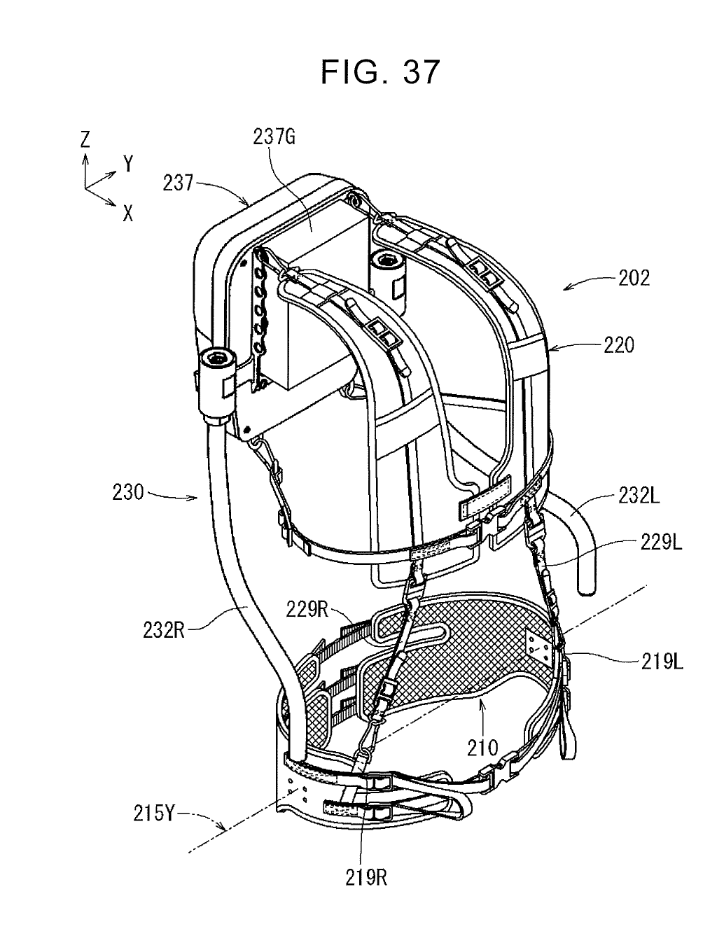

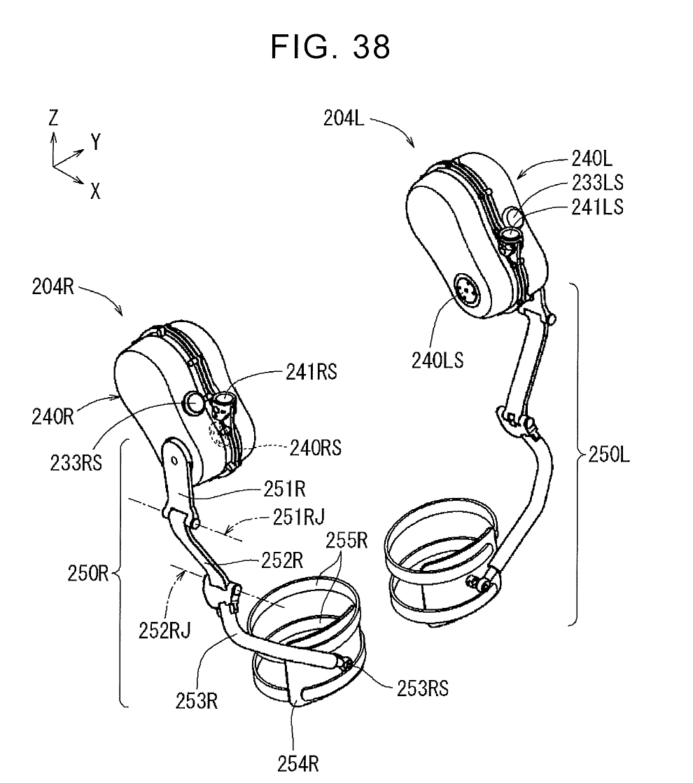

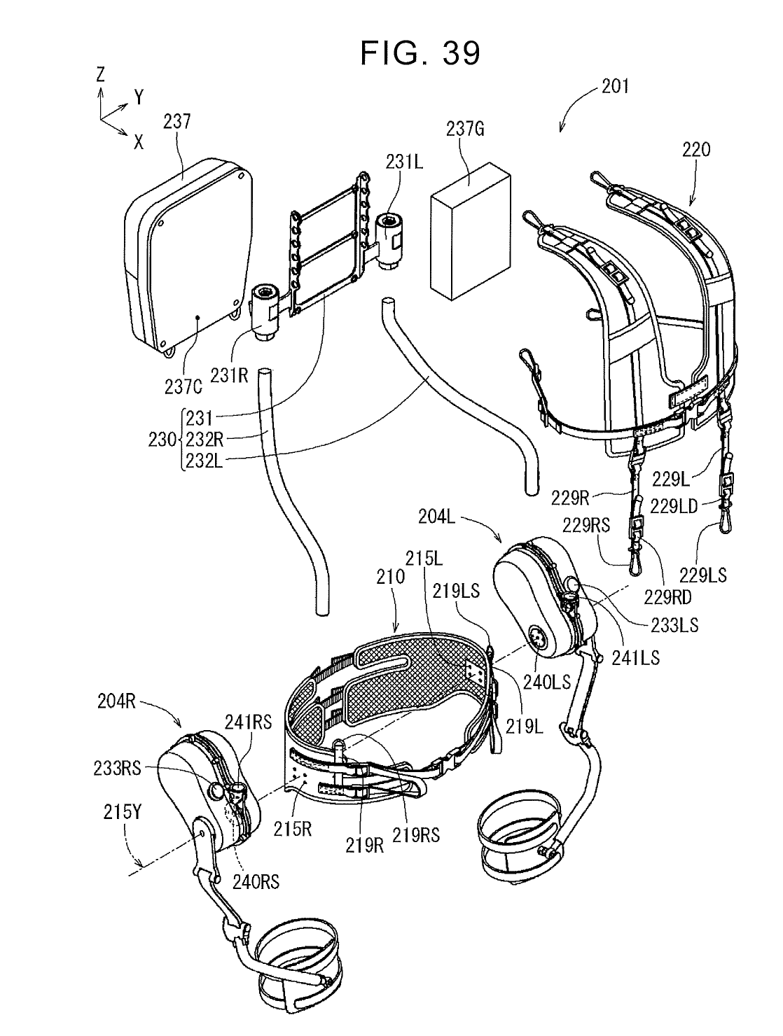

Next, a second embodiment will be described with reference to FIGS. 35 to 51. The overall structure of an assist device 201 will be described with reference to FIGS. 35 to 39. FIG. 35 illustrates the overall external appearance of the assist device 201 of the second embodiment. Further, FIG. 39 is an exploded perspective diagram in which the assist device 201 is disassembled into constituents. The assist device 201 includes a body wearing unit 202 (see FIG. 37), a right actuator unit 204R (see FIG. 38), and a left actuator unit 204L (see FIG. 38). The body wearing unit 202 is configured to be worn on the body including regions around assist target body parts (the thighs in an example of the present embodiment) of a user. The right actuator unit 204R and the left actuator unit 204L are attached to the body wearing unit 202 and to the assist target body parts so as to assist the motion of the assist target body parts. Note that the assist device 201, the body wearing unit 202, the right actuator unit 204R, and the left actuator unit 204L in the second embodiment illustrated in FIGS. 35 to 51 correspond to the assist device 1, the body wearing unit 2, the right actuator unit 4R, and the left actuator unit 4L in the first embodiment illustrated in FIGS. 1 to 34, respectively.

The external appearance of the body wearing unit 202 will be described with reference to FIGS. 37, 39. As illustrated in FIGS. 37 and 39, similarly to the first embodiment, the body wearing unit 202 includes a waist support portion 210 to be worn around the waist of the user, a jacket portion 220 to be worn around the shoulders and the chest of the user, a frame portion 230 to which the jacket portion 220 is connected, and a back pack portion 237 attached to the frame portion 230. The frame portion 230 is disposed around the back and the waist of the user, and a cushion 237G is disposed at a position between the back pack portion 237 and the back of the user. Details of each part will be described later.

The external appearances of the right actuator unit 204R and the left actuator unit 204L will be described with reference to FIGS. 38, 39. Similarly to the torque generating portions 40R, 40L and the output links 50R, 50L of the first embodiment illustrated in FIG. 3, the right actuator unit 204R and the left actuator unit 204L of the second embodiment illustrated in FIG. 38 include torque generating portions 240R, 240L and output links 250R, 250L. Similarly to the first embodiment, the left actuator unit 204L is bilaterally symmetric to the right actuator unit 204R, and thus, the left actuator unit 204L is not described in the following description. Note that the inner structure, the processing sequence of control, and so on of the torque generating portions 240R, 240L are the same as the inner structure and the processing sequence of control of the torque generating portions 40R, 40L in the first embodiment, and thus, descriptions thereof are omitted. Further, outlets 233RS, 233LS (connection openings) for cables for driving the actuators, controlling the actuators, and communication of the actuators are provided in respective parts, in the actuator units (204R, 204L), near the frame portion 230. The cables (not shown) connected to the outlets 233RS, 233LS for cables are disposed along the frame portion 230 so as to be connected to the back pack portion 237. Further, the arrangement positions of the outlets 233RS, 233LS are changed depending on the shapes of the actuator units (204R, 204L), the arrangements of the actuators inside the actuator units (204R, 204L), and so on. Thus, the outlets 233RS, 233LS are disposed at appropriate positions that do not impede the motion of the user. Further, the cables (not shown) connected to the outlets 233RS, 233LS may be housed inside the frame portion 230, and the outlets 233RS, 233LS may be disposed at appropriate positions that do not impede the motion of the user, taking into account the shapes of the actuator units (204R, 204L), the arrangements of the actuators provided therein, and so on.

Similarly to the first embodiment, the output link 250R includes an assist arm 251R (corresponding to a first link), a second link 252R, a third link 253R, and a thigh wearing portion 254R (corresponding to a body holding portion). Details of the output link 250R will be described later. Further, the input portions 33RS of the first embodiment illustrated in FIG. 2 are not illustrated in the second embodiment illustrated in FIG. 35.

Further, as illustrated in FIGS. 35, 39, a connecting portion 241RS of the right actuator unit 204R is fixed to the lower end of a right sub-frame 232R. Accordingly, in the second embodiment, the right actuator unit 204R does not pivot in the right-left direction relative to the right sub-frame 232R, and the right actuator unit 204R does not pivot in the up-down direction relative to the right sub-frame 232R. This makes it possible to prevent a decrease in transmission efficiency due to unnecessary pivoting of the actuator unit in work (movement) in a state where the assist torque is large or a rapid change of the assist torque is required. Further, pivoting of the upper part of the right actuator unit 204R in the up-down direction is also prohibited in the state where the assist torque is large or a change of the assist torque is fast. This makes it possible to further prevent a decrease in transmission efficiency. That is, when the assist torque is large or a change of the assist torque is fast, the right actuator unit 204R is supported appropriately, without unnecessary pivoting, by the right sub-frame 232R, the back contact portion 237C (the cushion 237G), and the back (the upper body) of the user. By outputting the assist torque (the assist torque from the output link 250R (see FIG. 38)) from the right actuator unit 204R thus supported appropriately, the assist torque can be transmitted to the thigh of the user appropriately (the same applies to the left actuator unit 204L).

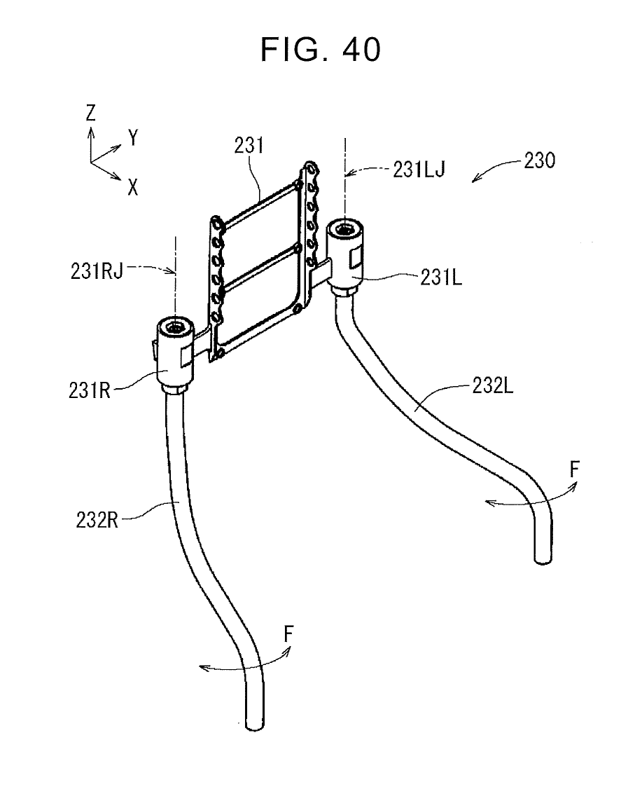

Details of the structure of the frame portion 230 will be described with reference to FIGS. 39, 40. As illustrated in FIGS. 39 and 40, the frame portion 230 includes a main frame 231, the right sub-frame 232R, a left sub-frame 232L, and the like, similarly to the first embodiment. Further, a first end portion (the upper end portion) of the right sub-frame 232R is connected to a connecting portion (a right pivot shaft portion) 231R provided on the right side of the main frame 231, and a first end portion (the upper end portion) of the left sub-frame 232L is connected to a connecting portion (a left pivot shaft portion) 231L provided on the left side of the main frame 231. The connecting portion 231R is a so-called cylindrical damper. The connecting portion 231R includes an inner cylinder and an outer cylinder disposed coaxially with each other, and a tubular elastic body is disposed between the inner cylinder and the outer cylinder. The outer cylinder is fixed to the main frame 231, and the first end portion of the right sub-frame 232R is fixed to the inner cylinder. Similarly, an outer cylinder of the connecting portion 231L is fixed to the main frame 231, and the first end portion of the left sub-frame 232L is fixed to an inner cylinder of the connecting portion 231L.

The tubular elastic body having a great friction is disposed between the inner cylinder and the outer cylinder of the connecting portion (the right pivot shaft portion) 231R. Accordingly, when a turning force F (see FIG. 40) greater than the friction is applied, the right sub-frame 232R pivots around a pivot axis 231RJ. That is, in order to cause the right sub-frame 232R to pivot around the pivot axis 231RJ relative to the main frame 231, it is necessary to apply a greater turning force F (it is necessary to input a load equal to or greater than a load threshold set in advance, to the right sub-frame 232R), and the load threshold is set so that the right sub-frame 232R is not caused to pivot by a reaction force at the time of transmission of the assist torque. This accordingly makes it possible to restrain the right sub-frame 232R from pivoting more than necessary, and thus, the assist torque can be stably transmitted to the user. That is, it is possible to prevent a decrease in transmission efficiency due to unnecessary pivoting of the right sub-frame and the left sub-frame at the time when the assist torque is transmitted. The same can also apply to the connecting portion (the left pivot shaft portion) 231L and the left sub-frame 232L, and thus, detailed descriptions thereof are omitted herein.

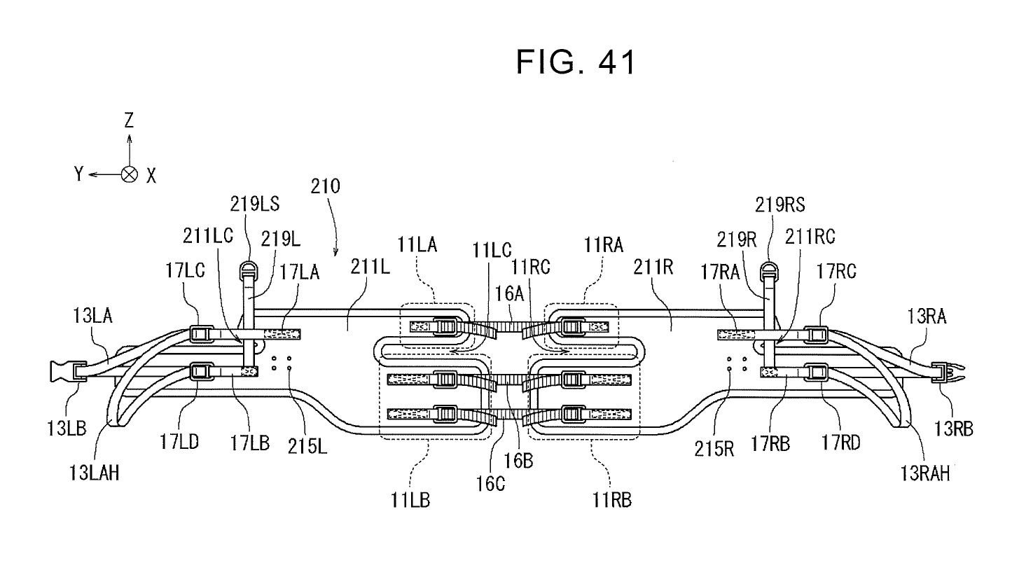

Next, details of the structure of a waist support portion 210 will be described with reference to FIG. 41. In the waist support portion 210 of the second embodiment illustrated in FIG. 41, the same reference signs are given to the same constituents as in the waist support portion 10 of the first embodiment illustrated in FIG. 8. As compared to the waist support portion 10 of the first embodiment illustrated in FIG. 8, the waist support portion 210 of the second embodiment illustrated in FIG. 41 is configured such that a notch 211RC, a coupling belt 219R, and a coupling ring 219RS are additionally provided in a right waist wearing portion 211R, and coupling holes 215R are provided instead of the pivot shaft portion 15R (see FIG. 8). Similarly, a notch 211LC, a coupling belt 219L, and a coupling ring 219LS are additionally provided in a left waist wearing portion 211L, and coupling holes 215L are provided instead of the pivot shaft portion 15L (see FIG. 8).

The coupling holes 215R are holes to be coupled to a coupling portion 240RS of the right actuator unit 204R illustrated in FIG. 38 with the use of connecting members such as screws. Similarly, the coupling holes 215L of the waist support portion 210 are holes to be coupled to a coupling portion 240LS of the left actuator unit 204L illustrated in FIG. 38 with the use of connecting members such as screws. Thus, the waist support portion 210 is firmly fixed to the right actuator unit 204R and the left actuator unit 204L. This accordingly makes it possible to restrain displacement of the waist support portion 210 with respect to the user, thereby making it possible to transmit the assist torque efficiently.

As illustrated in FIG. 41, a first end portion of the coupling belt 219R is connected to the right waist wearing portion 211R, and the coupling ring 219RS is connected to a second end portion of the coupling belt 219R. As illustrated in FIG. 35, the coupling ring 219RS is connected to a coupling portion 229RS provided in the lower ends of coupling belts 229R, 229RD provided in the jacket portion 220. Similarly, a first end portion of the coupling belt 219L is connected to the left waist wearing portion 211L, and the coupling ring 219LS is connected to a second end portion of the coupling belt 219L. As illustrated in FIG. 35, the coupling ring 219LS is connected to the coupling portion 229LS provided in the lower ends of coupling belts 229L, 229LD provided in the jacket portion 220. Thus, the waist support portion 210 and the jacket portion 220 are connected to each other via the coupling belts 219R, 219L on the front face or the side faces of the user. This makes it possible to prevent the jacket portion 220 from being displaced upward with respect to the waist support portion 210, and to prevent the waist support portion 210 from being displaced downward with respect to the jacket portion 220. That is, the displacement of the waist support portion 210 and the jacket portion 220 with respect to the user is restrained during transmission of the assist torque, thereby making it possible to transmit the assist torque efficiently. Note that, on the back face of the user, the waist support portion 210 and the jacket portion 220 are connected to each other via the frame portion 230, the right actuator unit 204R, and the left actuator unit 204L.

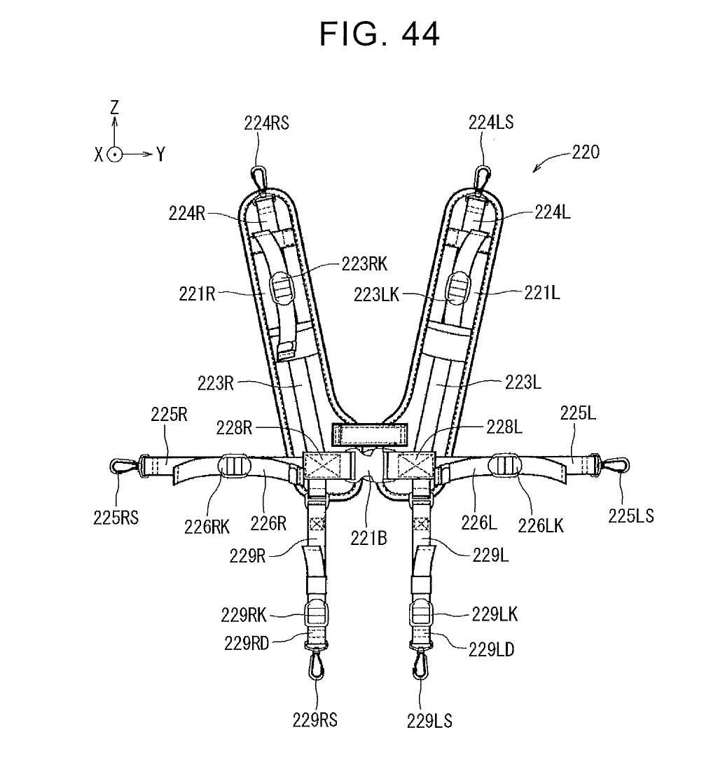

As illustrated in FIG. 35, the coupling portion 229RS (see FIG. 44) of the jacket portion 220 is connected to the coupling ring 219RS (see FIG. 41) of the waist support portion 210 in an attachable and detachable manner, and the coupling portion 229LS (see FIG. 44) of the jacket portion 220 is connected to the coupling ring 219LS (see FIG. 41) of the waist support portion 210 in an attachable and detachable manner. Accordingly, the coupling portions 229RS, 229LS correspond to a jacket-waist support attaching/detaching mechanism that enables connection and separation of the jacket portion 220 to/from the waist support portion 210 (via the coupling rings 219RS, 219LS and the coupling belts 219R, 219L provided in the waist support portion 210). In a case where the jacket portion 220 is configured to be connected only to the waist support portion 210 without being connected to the back contact portion 237C (or the frame portion 230), when the jacket-waist support attaching/detaching mechanism is provided, it is possible to easily change the jacket portion such that the jacket portion has an appropriate size and shape in accordance with the body size and the body shape of the user. Accordingly, it is possible to further improve ease with which the user can wear the jacket portion.

Further, the notch 211RC and the notch 211LC reduce resistance to the motion of the user, for example, when the user greatly inclines the upper body forward.

In the second embodiment, the right actuator unit 204R and the left actuator unit 204L are fixed to the lower part of the frame portion 230 so as not to pivot relative to the frame portion 230. Further, the back pack portion 237 is fixed to the upper part of the frame portion 230, and the jacket portion 220 is connected to the upper part of the frame portion 230 via belts. The waist support portion 210 is fixed to the right actuator unit 204R and the left actuator unit 204L so as not to pivot relative to the right actuator unit 204R and the left actuator unit 204L. The waist support portion 210 and the jacket portion 220 are connected to each other via the coupling belts. Thus, when the assist torque is transmitted to the user from the right actuator unit 204R and the left actuator unit 204L, a reaction force against the assist torque can be reliably received by the frame portion 230 and the waist support portion 210 to which the right actuator unit 204R and the left actuator unit 204L are fixed, and thus, it is possible to transmit the assist torque efficiently.

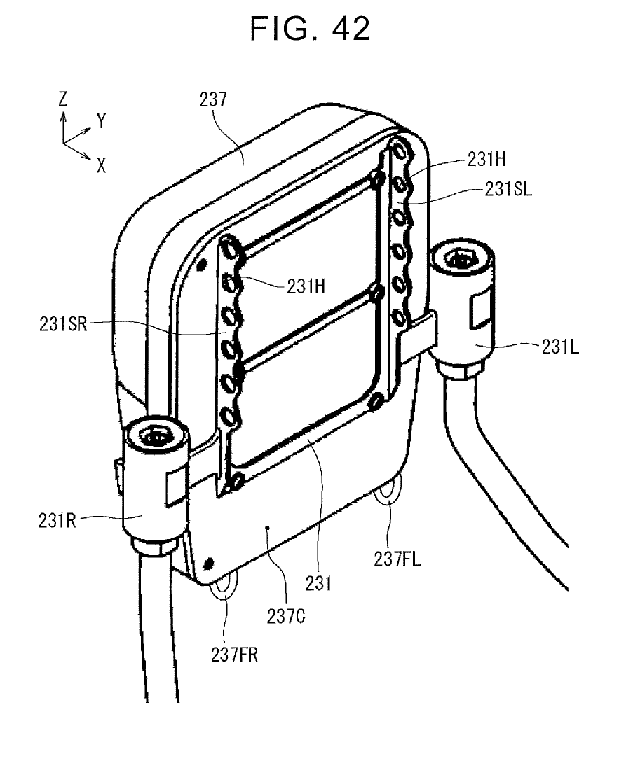

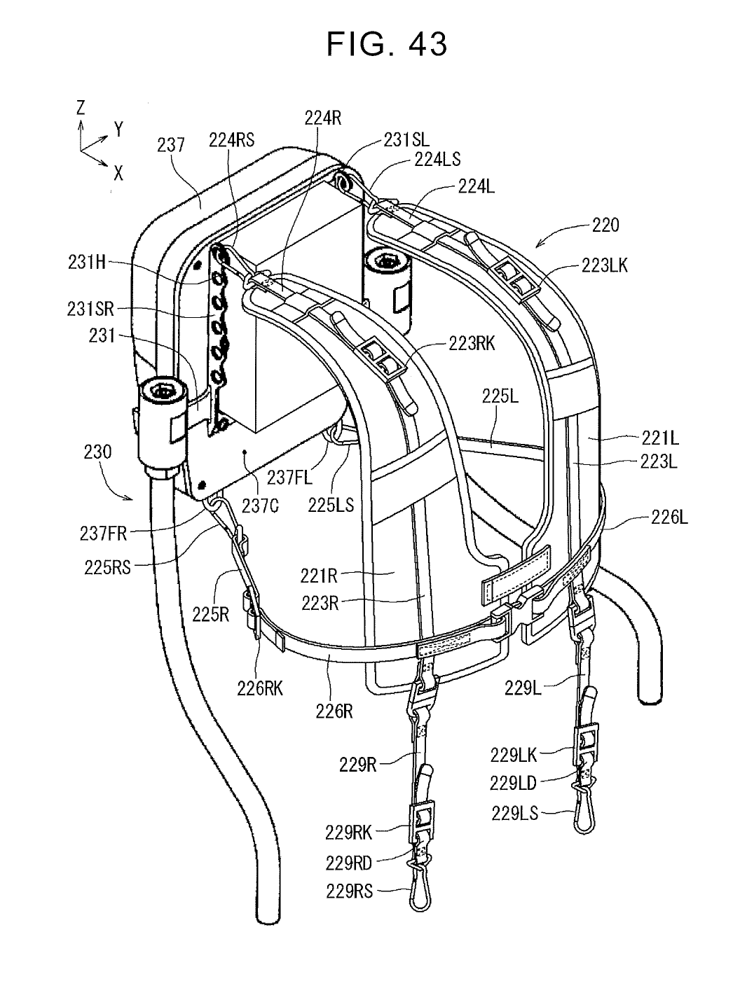

Details of the structure around the back pack portion 237 will be described with reference to FIGS. 42 and 43. The back pack portion 237 has a simple box shape, and a control device, a power supply unit, a communication unit, and so on are accommodated in the back pack portion 237, similarly to the receptacle portion 37B of the first embodiment. The back pack portion 237 includes a back contact portion 237C on the side of the main frame 231 as illustrated in FIG. 42. The back contact portion 237C is fixed to the main frame 231 so as not to move in the up-down direction relative to the main frame 231. In the main frame 231, at positions that face the shoulders on the back side of the user, support bodies 231SR, 231SL are provided. Each of the support bodies 231SR, 231SL has a plurality of belt connecting holes 231H (corresponding to belt connecting portions) disposed in the up-down direction. That is, the belt connecting holes 231H (belt connecting portions) are provided such that the position, in the height direction, of the jacket portion 220 relative to the frame portion 230 can be adjusted in accordance with the body size of the user. Accordingly, the height of the jacket portion 220 can be adjusted to an appropriate position in accordance with the body size of the user. As compared to the back contact portion 37C (see FIG. 11) in the first embodiment, the back contact portion 237C does not require an up-down sliding mechanism, and a range between adjustment limits for the user can be widened or an adjustment interval can be narrowed by adjusting the length of a part of the main frame 231, which faces the back pack portion 237, the number of belt connecting holes 231H, and/or the positions of the belt connecting holes 231H. Accordingly, the height of the jacket portion 220 can be easily adjusted particularly for a tall person or a short person. In the case of the up-down sliding mechanism, the adjustment amount is determined by the stroke limit of the sliding mechanism, and it is difficult to change the stroke limit. Thus, with the simple structure without any complicated mechanism, the position, in the height direction, of the jacket portion 220 relative to the frame portion 230 is adjusted simply and accurately. Further, since the cushion 237G (the back contact portion 237C) making contact with the back of the user is made long in a direction from the shoulders to the waist of the user, when the upper body of the user is inclined forward, the actuator units (204R, 204L) that output the assist torque can be supported appropriately. Furthermore, when the upper body of the user is inclined rightward or leftward, the cushion 237G (the back contact portion 237C) comes into contact with the bending center of the back of the user, and thus, the actuator units (204R, 204L) that output the assist torque can be supported more appropriately (support rigidity becomes high). Since components inside the back pack portion 237 are disposed planarly, the thickness of the back pack portion 237 (in the direction perpendicular to the surface of the back of the user) can be reduced. This makes it possible to reduce interference with the back of the user in a small workplace or the like, and to improve work efficiency.

Further, a belt connecting portion 224RS of a right shoulder belt 224R is connected to any of the belt connecting holes 231H (the belt connecting portions) of the support body 231SR, as illustrated in FIG. 43. Similarly, a belt connecting portion 224LS of a left shoulder belt 224L is connected to any of the belt connecting holes 231H (the belt connecting portions) of the support body 231SL, as illustrated in FIG. 43. By selecting the belt connecting holes 231H at appropriate positions in accordance with the body size of the user, the jacket portion that is closely fitted to the shoulders and the chest of the user can be closely attached to the frame portion appropriately. Accordingly, it is possible to restrain the jacket portion and the frame portion from being displaced with respect to the user, thereby making it possible to transmit the assist torque efficiently. Note that the support bodies 231SR, 231SL may be provided in the back pack portion 237.

Belt connecting portions 237FR, 237FL are provided on the right and left sides in the lower end of the back pack portion 237. As illustrated in FIG. 43, a belt connecting portion 225RS of a right armpit belt 225R is connected to the belt connecting portion 237FR. Similarly, as illustrated in FIG. 43, a belt connecting portion 225LS of a left armpit belt 225L is connected to the belt connecting portion 237FL. Note that the belt connecting portions 237FR, 237FL may be provided in the main frame 231.

Next, details of the structure of the jacket portion 220 will be described with reference to FIGS. 43, 44. As illustrated in FIG. 44, the jacket portion 220 includes a right chest wearing portion 221R and a left chest wearing portion 221L to be worn around the shoulders and the chest of the user. The right chest wearing portion 221R and the left chest wearing portion 221L can be easily connected to and separated from each other with a buckle 221B.

A fixed portion 228R is provided below the right chest wearing portion 221R, and a first end portion of a right shoulder belt 223R is fixed to the fixed portion 228R. Further, a first end portion of a right armpit belt 226R and a first end portion of the coupling belt 229R are fixed to the fixed portion 228R. A second end portion of the right shoulder belt 223R is connected to a first end portion of the right shoulder belt 224R via a right shoulder belt holding member 223RK (a right shoulder adjuster). The belt connecting portion 224RS is connected to a second end portion of the right shoulder belt 224R. The distance from the fixed portion 228R to the belt connecting portion 224RS is adjustable by the right shoulder belt holding member 223RK. Similarly, a second end portion of the right armpit belt 226R is connected to a first end portion of the right armpit belt 225R via a right armpit belt holding member 226RK (a right armpit adjuster). The belt connecting portion 225RS is connected to a second end portion of the right armpit belt 225R. The distance from the fixed portion 228R to the belt connecting portion 225RS is adjustable by the right armpit belt holding member 226RK. Similarly, a second end portion of the coupling belt 229R is connected to a first end portion of the coupling belt 229RD via a coupling belt holding member 229RK (a coupling adjuster). The coupling portion 229RS is connected to a second end portion of the coupling belt 229RD. The distance from the fixed portion 228R to the coupling portion 229RS is adjustable by the coupling belt holding member 229RK. Note that left shoulder belts 223L, 224L in the left chest wearing portion 221L, left armpit belts 226L, 225L, and the coupling belts 229L, 229LD are configured similarly to the above, so descriptions thereof are omitted herein.

As illustrated in FIG. 43, the belt connecting portion 225RS of the right armpit belt 225R is connected to the belt connecting portion 237FR of the back pack portion 237, and the belt connecting portion 225LS of the left armpit belt 225L is connected to the belt connecting portion 237FL of the back pack portion 237. Further, appropriate belt connecting holes are selected from among the belt connecting holes 231H disposed in the up-down direction in accordance with the position of the shoulders of the user wearing the assist device, and thus, the belt connecting portion 224RS of the right shoulder belt 224R and the belt connecting portion 224LS of the left shoulder belt 224L are connected to the belt connecting holes 231H thus selected. The lengths of the right shoulder belts 223R, 224R and the left shoulder belts 223L, 224L are adjusted and the lengths of the right armpit belts 225R, 226R and the left armpit belts 225L, 226L are adjusted so that the right chest wearing portion 221R and the left chest wearing portion 221L are closely fitted to the shoulders and the chest of the user. Further, the coupling portion 229RS of the coupling belt 229RD and the coupling portion 229LS of the coupling belt 229LD are connected to the coupling ring 219RS and the coupling ring 219LS (see FIG. 41) provided in the waist support portion 210, as illustrated in FIG. 35. Then, the lengths of the coupling belts 229R, 229L are adjusted.

Note that, as illustrated in FIG. 43, the belt connecting portions 224RS, 224LS are connected to the belt connecting holes 231H (corresponding to the belt connecting portions) in an attachable and detachable manner. Further, the belt connecting portion 225RS is connected to the belt connecting portion 237FR in an attachable and detachable manner, and the belt connecting portion 225LS is connected to the belt connecting portion 237FL in an attachable and detachable manner. Accordingly, the belt connecting portions 224RS, 224LS, 225RS, 225LS correspond to a jacket-frame attaching/detaching mechanism that enables connection and separation of the jacket portion 220 to/from the belt connecting portions (231H, 237FR, 237FL) provided in the back contact portion 237C (or the frame portion 230). Further, the coupling portion 229RS illustrated in FIG. 43 is connected to the coupling ring 219RS (see FIG. 41) of the waist support portion 210 in an attachable and detachable manner as illustrated in FIG. 35, and the coupling portion 229LS illustrated in FIG. 43 is connected to the coupling ring 219LS (see FIG. 41) of the waist support portion 210 in an attachable and detachable manner as illustrated in FIG. 35. Accordingly, the coupling portions 229RS, 229LS correspond to the jacket-waist support attaching/detaching mechanism that enables connection and separation of the jacket portion 220 to/from the waist support portion 210 (the coupling rings 219RS, 219LS provided in the waist support portion 210). Since the jacket-frame attaching/detaching mechanism and the jacket-waist support attaching/detaching mechanism are provided, it is possible to easily change the jacket portion such that the jacket portion has an appropriate size and shape in accordance with the body shape and body size of the user. Accordingly, it is possible to further improve ease with which the user can wear the jacket portion.

The jacket portion 220 is configured to be closely fitted to the right shoulder, the left shoulder, the right armpit, and the left armpit of the user with a very simple and lightweight structure (with the right shoulder belt, the left shoulder belt, the right armpit belt, and the left armpit belt) and is also restrained from being displaced with respect to the waist support portion 210 (with the coupling belts). Accordingly, the jacket portion 220 can be closely fitted to the user appropriately and the assist torque can be transmitted more efficiently.

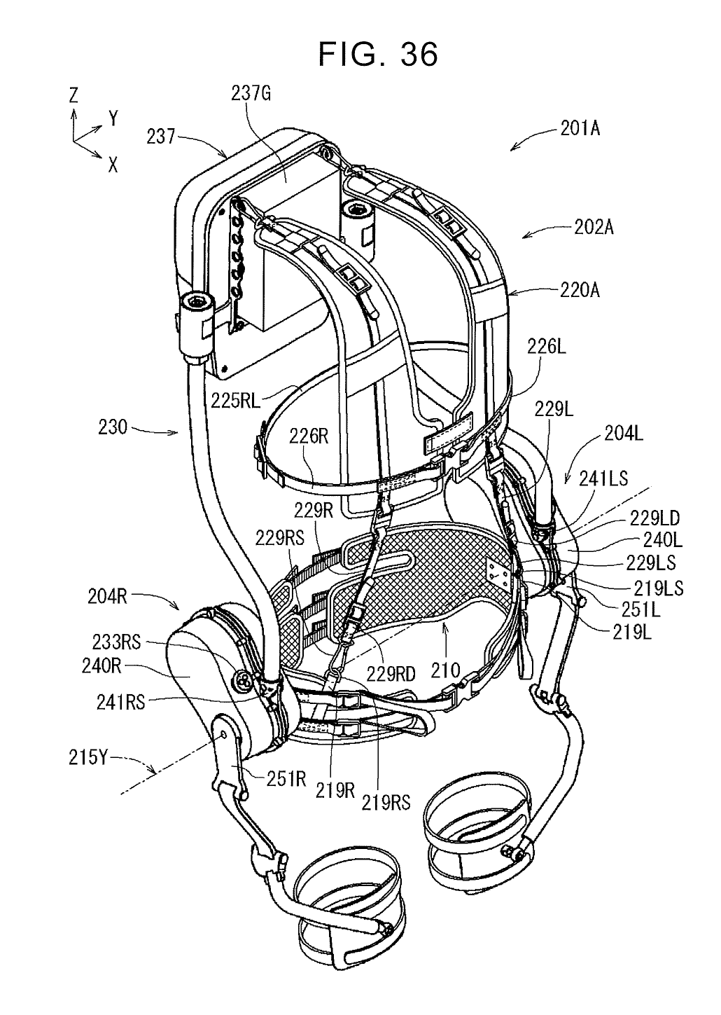

Further, an assist device 201A illustrated in FIG. 36 illustrates an example in which the right armpit belt 225R and the left armpit belt 225L in the jacket portion 220 of the assist device 201 illustrated in FIG. 35 are changed to a close contact belt 225RL.

As illustrated in FIG. 36, the right armpit belt 225R (see FIG. 43), the left armpit belt 225L (see FIG. 43), the belt connecting portions 225RS, 225LS (see FIG. 43), and the belt connecting portions 237FR, 237FL (see FIG. 43) are omitted, and the close contact belt 225RL obtained by unifying the right armpit belt 225R and the left armpit belt 225L is provided. Alternatively, the close contact belt 225RL may be formed by connecting the right armpit belt 225R and the left armpit belt 225L instead of unifying the right armpit belt 225R and the left armpit belt 225L. The close contact belt 225RL is wound around the trunk part between the chest and the abdomen of the user so that the jacket portion 220A is closely fitted to the trunk part of the user.

The close contact belt 225RL illustrated in FIG. 36 is connected to the right armpit belt 226R via the right armpit belt holding member 226RK (see FIG. 43), and is connected to the left armpit belt 226L via a left armpit belt holding member 226LK (on the back side of the left chest wearing portion 221L in FIG. 43, see FIG. 44). The belt length of the close contact belt 225RL is adjusted by adjusting the right armpit belt holding member 226RK and the left armpit belt holding member 226LK. The close contact belt 225RL causes the lower periphery of the jacket portion 220A to be closely fitted around the trunk part of the user. Accordingly, when the user leans forward (bends forward) or leans backward (bends backward) in an object lift-up/lift-down motion of the user, for example, it is possible to curb a decrease in the degree of contact of the jacket portion 220A with the trunk part of the user. Accordingly, with the close contact belt 225RL, it is possible to restrain the jacket portion 220A from flapping due to the decrease in the degree of contact of the jacket portion 220A, and to transmit the assist torque efficiently. Further, the position of the trunk part of the user around which the close contact belt 225RL is closely fitted may be between the chest and the abdomen of the user (around the trunk of the body). The close contact belt 225RL may be closely fitted around the lower part of the chest of the user (around the lower ribs). In this case, the close contact belt 225RL holds the bones (the lower ribs) around the chest of the user below the back pack portion 237, and thus, the user does not feel a pressure for tightening the abdomen of the user. Further, since the jacket portion 220A is held at a position near the back pack portion 237, it is possible to achieve a good wearing feeling and to transmit the assist torque efficiently. Note that when the user has less feeling of pressure, the wearing feeling is better. Also, when the assist torque is maintained in a lift-down motion, it is possible to curb a decrease in the degree of contact of the jacket portion 220A with the trunk part of the user and to transmit the assist torque efficiently with a good wearing feeling.

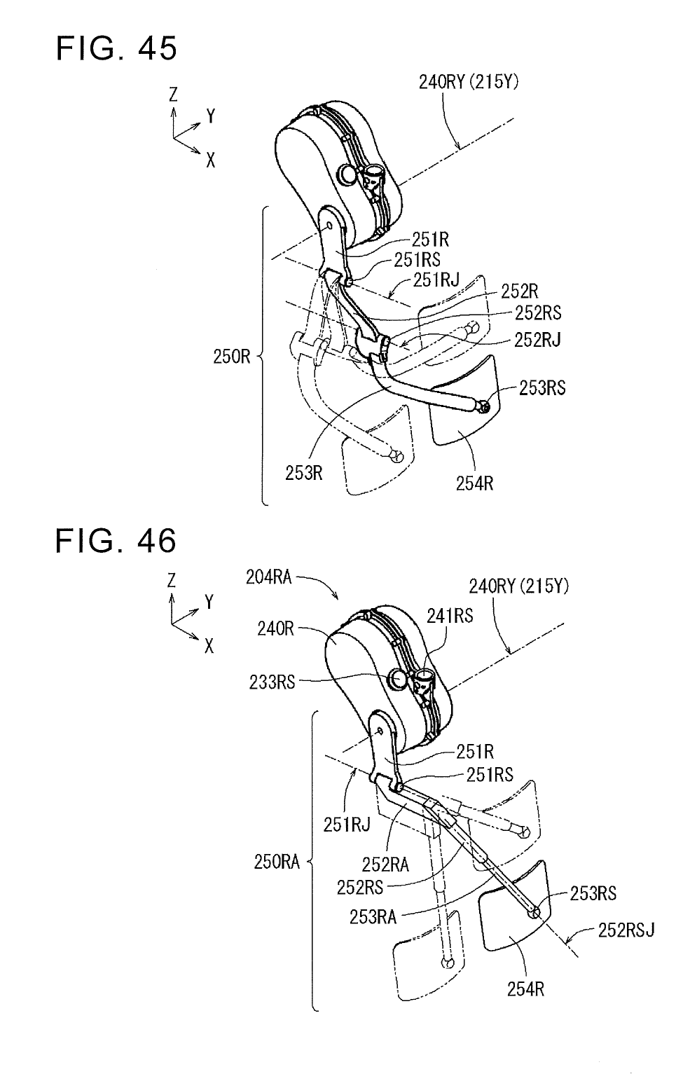

A link mechanism of the right actuator unit 204R (the left actuator unit 204L) will be described in detail with reference to FIGS. 38, 45 to 51. Note that a link mechanism of the left actuator unit 204L is configured in the same manner, so a description of the link mechanism of the left actuator unit 204L is omitted. As an example of the link mechanism, an example of an output link 250R illustrated in FIG. 45 and an example of an output link 250RA illustrated in FIG. 46 will be described.

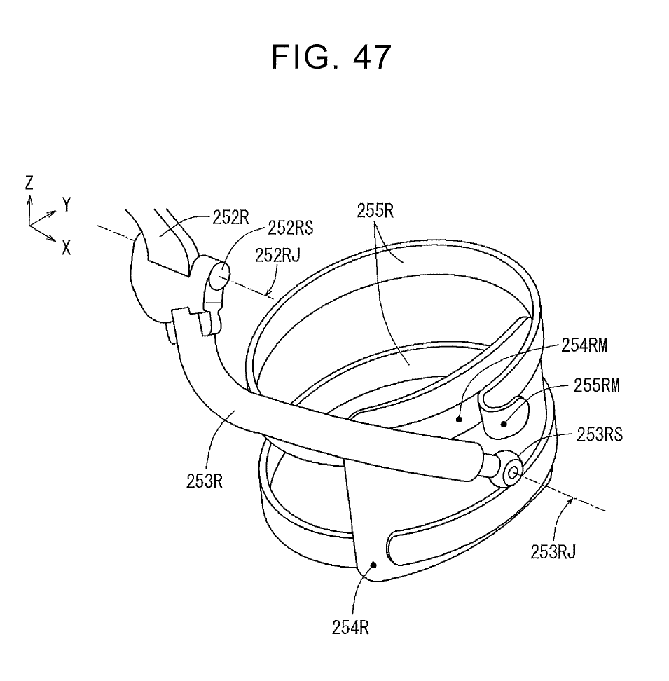

The output link 250R illustrated in FIG. 45 includes a plurality of connecting members such that the assist arm 251R (corresponding to a first link), the second link 252R, the third link 253R, and the thigh wearing portion 254R (corresponding to a body holding portion) are connected to each other via joint portions. In the thigh wearing portion 254R illustrated in FIG. 45, a thigh belt 255R illustrated in FIG. 47 is not illustrated. The assist arm 251R is caused to pivot around a pivot axis 240RY (a pivot axis 215Y, see FIG. 35) passing through the assist target body part (in this case, the hip joint) by the combined torque obtained by combining the assist torque generated in the torque generating portion 240R and the user torque generated by the motion of the thigh of the user. The assist arm 251R corresponds to the assist arm 51R illustrated in FIG. 19 and is pivotable around the pivot axis 40RY with the use of the electric motor 47R (actuator) shown in FIG. 19.

A first end portion of the second link 252R is connected to a distal end portion of the assist arm 251R via a first joint portion 251RS so as to be pivotable around a pivot axis 251RJ. That is, the first joint portion 251RS has a connecting structure having one degree of freedom in which the second link 252R is pivotable, relative to the assist arm 251R, around the pivot axis 251RJ (corresponding to a first joint pivot axis) set in the assist arm 251R. Further, a first end portion of the third link 253R is connected to a second end portion of the second link 252R via a second joint portion 252RS so as to be pivotable around a pivot axis 252RJ. That is, the second joint portion 252RS has a connecting structure having one degree of freedom in which the third link 253R is pivotable, relative to the second link 252R, around the pivot axis 252RJ (corresponding to a second joint pivot axis) set in the second link 252R. Further, a second end portion of the third link 253R is connected to the thigh wearing portion 254R via a third joint portion 253RS (in the example of FIG. 45, a spherical joint). Accordingly, the third joint portion 253RS between the third link and the thigh wearing portion 254R (the body holding portion) has a connecting structure having three degrees of freedom. Thus, the sum of degrees of freedom of the output link 250R illustrated in FIG. 45 is 1+1+3=5. In a case where the third joint portion 253RS is a spherical joint having three degrees of freedom, the body holding portions closely fitted to the thighs of the user are easily allowed to follow the thighs appropriately at the time when, for example, the user spreads the legs, while the body holding portions is kept closely fitted to the thighs thus spread.

Note that the sum of degrees of freedom of the output link 250R should be three or more. For example, as illustrated in FIG. 47, the third joint portion 253RS may be configured to allow the thigh wearing portion 254R to pivot around a pivot axis 253RJ relative to the second end portion of the third link 253R. In the example of FIG. 47, the third joint portion 253RS has a connecting structure having one degree of freedom in which the thigh wearing portion 254R is pivotable, relative to the third link 253R, around the pivot axis 253RJ (corresponding to a third joint pivot axis) set in the third link 253R. Since the degree of freedom of the first joint portion 251RS is “1” and the degree of freedom of the second joint portion 252RS is “1”, the sum of degrees of freedom of the output link in this case is 1+1+1=3. In a case where the third joint portion 253RS is a joint having one degree of freedom, the positions of the body holding portions closely fitted to the thighs of the user are hardly displaced at the time when, for example, the user spreads the legs, as compared to a case where the third joint portion is a joint having three degrees of freedom. Thus, it is possible to transmit the assist torque efficiently.

When the sum of degrees of freedom is three or more, the position of the thigh wearing portion 254R can be moved in the up-down direction and the right-left direction in accordance with the body size and the motion (for example, a motion of spreading the right and left legs) of the user as illustrated in FIG. 45, and also the thigh wearing portion 254R can be rotated or inclined. Thus, the thigh wearing portion 254R can be closely fitted to the thigh of the user. This accordingly makes it possible to transmit the assist torque efficiently. Note that a stopper that limits a pivoting range of the second link or the third link may be provided.

Note that, as illustrated in FIG. 47, the body holding portion includes the thigh wearing portion 254R connected to the third link 253R and worn on the thigh of the user, and the thigh belt 255R that is extendable and provided in the thigh wearing portion 254R so as to surround the thigh of the user. The thigh belt 255R is made of an expanding and contracting (stretchable) elastic body and is configured such that a first end portion thereof is fixed to the thigh wearing portion 254R and a second end portion thereof is formed as a loop fastener 255RM. Further, a loop fastener 254RM is provided at a position in the thigh wearing portion 254R, the position facing the second end portion of the thigh belt 255R. Accordingly, the user wearing the thigh wearing portion 254R on the thigh slightly pulls the thigh belt 255R and winds it around the thigh so as to place the loop fastener 255RM on the second end portion of the thigh belt 255R on the loop fastener 254RM of the thigh wearing portion 254R. Thus, the user can easily fit the thigh wearing portion 254R closely to the thigh such that the thigh wearing portion 254R is not displaced.

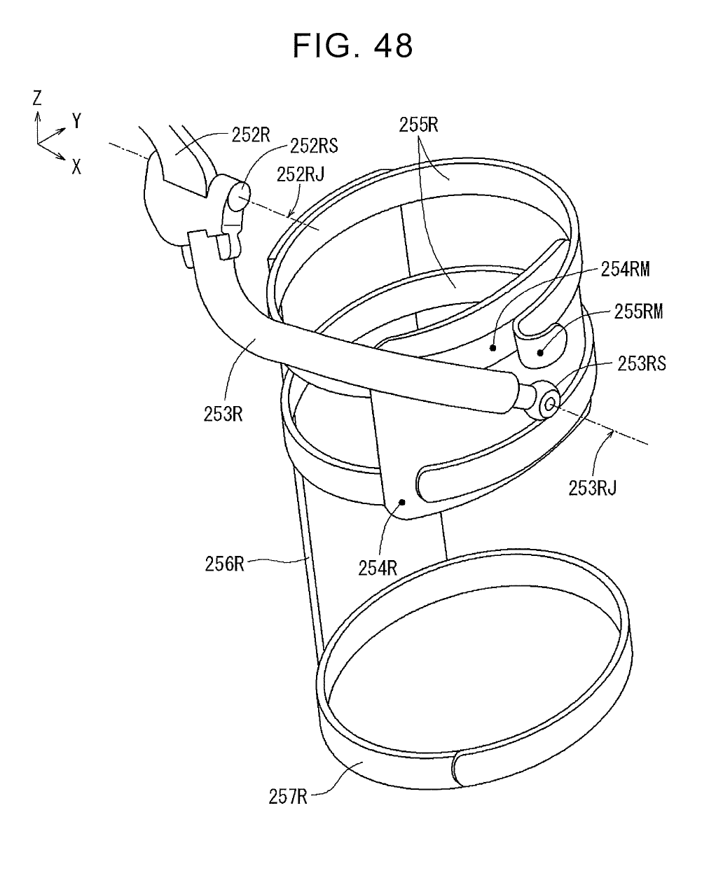

Further, FIG. 47 illustrates an example in which the body holding portion includes the thigh wearing portion 254R and the thigh belt 255R, while FIG. 48 illustrates an example in which the body holding portion includes the thigh wearing portion 254R, the thigh belt 255R, and a below-knee belt 257R. As illustrated in FIG. 48, the thigh belt 255R is provided in the thigh wearing portion 254R so as to surround the thigh that is the above-knee portion of the user. Further, the below-knee belt 257R is provided so as to surround the below-knee portion of the user. Further, the below-knee belt 257R is made of the same material as the material of the thigh belt 255R, and includes a loop fastener so as to be closely fitted to the below-knee portion, similarly to the thigh belt 255R. The thigh belt 255R and the below-knee belt 257R are connected to each other via a connecting member 256R extending from the thigh of the user in the direction toward the toe, on the back side of the knee of the user. The connecting member 256R is disposed on the back of the knee of the user and is made of a material that allows the connecting member 256R to bend following bending and straightening of the knee of the user. Thus, the thigh belt 255R is held so as to be closely fitted to the above-knee portion of the user, and the below-knee belt 257R is held so as to be closely fitted to the below-knee portion of the user. That is, the body holding portion is closely fitted to the user such that the knee of the user is sandwiched from the upper side and the lower side by the thigh belt 255R and the below-knee belt 257R. Accordingly, in a case where a rapid movement (bending and straightening) of the knee occurs or a large assist torque is required in a walking or object lift-up/lift-down motion of the user, the displacement of the body holding portion closely fitted to the thigh (the above-knee portion) and the below-knee portion of the user can be restrained, and thus, it is possible to transmit the assist torque efficiently.

The output link 250RA illustrated in FIG. 46 includes a plurality of connecting members such that the assist arm 251R (corresponding to a first link), a second link 252RA (and the second joint portion 252RS), a third link 253RA, and the thigh wearing portion 254R (corresponding to a body holding portion) are connected to each other via joint portions. In the thigh wearing portion 254R illustrated in FIG. 46, the thigh belt 255R illustrated in FIG. 47 is not illustrated. The assist arm 251R is caused to pivot around the pivot axis 240RY (the pivot axis 215Y, see FIG. 35) passing through the assist target body part (in this case, the hip joint) by the combined torque obtained by combining the assist torque generated in the torque generating portion 240R and the user torque generated by the motion of the thigh of the user. The assist arm 251R corresponds to the assist arm 51R illustrated in FIG. 19 and is pivotable around the pivot axis 40RY with the use of the electric motor 47R (actuator) illustrated in FIG. 19.

An end portion of the second link 252RA is connected to the distal end portion of the assist arm 251R via the first joint portion 251RS so as to be pivotable around the pivot axis 251RJ. That is, the first joint portion 251RS has a connecting structure having one degree of freedom in which the second link 252RA is pivotable, relative to the assist arm 251R, around the pivot axis 251RJ (corresponding to a first joint pivot axis) set in the assist arm 251R. Further, the second link 252RA and the second joint portion 252RS are integrated with each other, and a first end portion of the third link 253RA that slidably reciprocates along a slide axis 252RSJ provided along the longitudinal direction of the third link 253RA is connected to the second link 252RA via the second joint portion 252RS. That is, the second joint portion 252RS has a connecting structure having one degree of freedom in which the third link 253RA is slidable, relative to the second link 252RA, along the slide axis 252RSJ (corresponding to a second joint slide axis) set in the second link 252RA. Further, the third link 253RA is connected to the thigh wearing portion 254R via the third joint portion 253RS (a spherical joint in the example of FIG. 46). Accordingly, the third joint portion 253RS between the third link and the thigh wearing portion 254R (the body holding portion) has a connecting structure having three degrees of freedom. Thus, the sum of degrees of freedom of the output link 250RA illustrated in FIG. 46 is 1+1+3=5. The sum of degrees of freedom should be three or more, and therefore, as illustrated in FIG. 47, the third joint portion may have a connecting structure having one degree of freedom so that the thigh wearing portion 254R is pivotable around the pivot axis 253RJ.

When the sum of degrees of freedom is three or more, the position of the thigh wearing portion 254R can be moved in the up-down direction and the right-left direction in accordance with the body size and the motion (for example, a motion of spreading the right and left legs) of the user as illustrated in FIG. 46, and also the thigh wearing portion 254R can be rotated or inclined. Thus, the thigh wearing portion 254R can be closely fitted to the thigh of the user. This accordingly makes it possible to transmit the assist torque efficiently. A stopper that limits a pivoting range of the second link or a slide range of the third link may be provided. Further, in the case of the output link 250R illustrated in FIG. 45, when the user spreads the legs and bends the knees to lower the waist (squat down), the second joint portion 252RS, the third link 253R, and so on protrude outside the legs of the user. However, in the case of the output link 250RA illustrated in FIG. 46, the second joint portion 252RS, the third link 253RA, and so on are restrained from protruding outside. Accordingly, when the user works in a small workplace, interference of the output link 250RA is restrained and the user can work efficiently.

Further, as described above with reference to FIG. 47, the thigh belt 255R is provided in the thigh wearing portion 254R, and the thigh wearing portion 254R can be easily closely fitted to the thigh of the user with the use of the thigh belt 255R such that the thigh wearing portion 254R is not displaced.

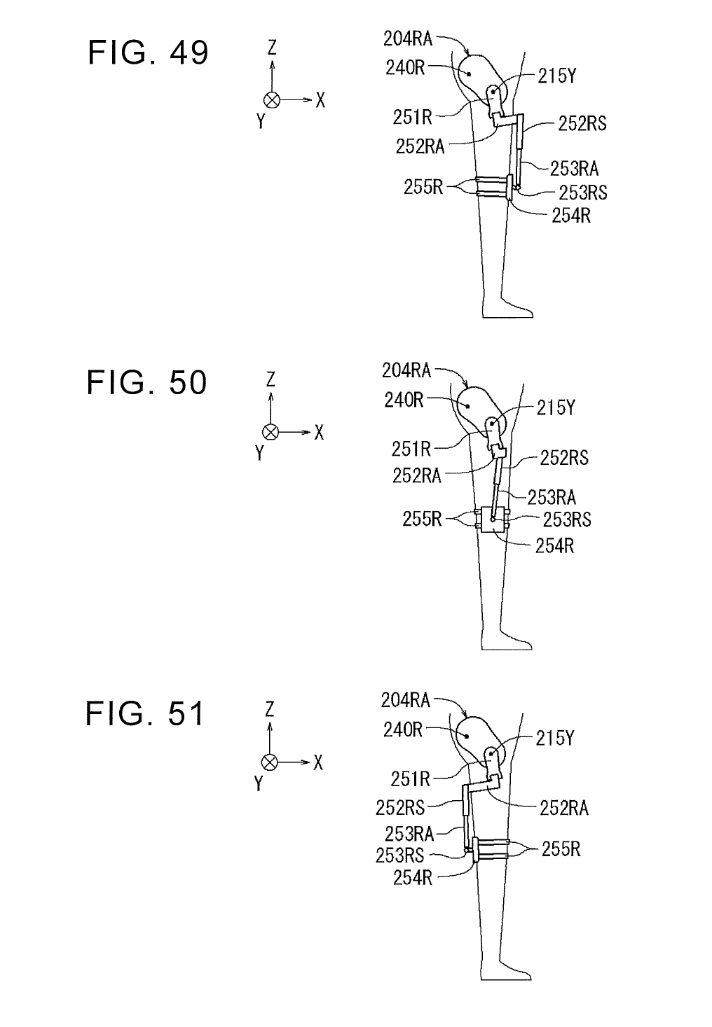

FIGS. 49 to 51 are views for illustrating, with regard to the link mechanism illustrated in FIG. 46, an example (FIG. 49) in which the position of the third joint portion 253RS that is a coupling portion between the third link 253RA and the thigh wearing portion 254R is disposed on the front face of the thigh of the user, an example (FIG. 50) in which the position of the third joint portion 253RS is disposed on the outer side face of the thigh of the user, and an example (FIG. 51) in which the position of the third joint portion 253RS is disposed on the back face of the thigh of the user.

In the example of FIG. 49, the lower part of the second link 252RA is extended toward the front side of the user, and thus, the second joint portion 252RS and the third link 253RA are disposed on the front face of the user so as to place the position of the third joint portion 253RS on the front face of the thigh of the user. In this case, at the time when the assist torque is transmitted, the third joint portion 253RS (the point of effort to which the assist torque is applied) disposed on the front face of the user is pressed toward the back-face side from the front-face side or pulled toward the front-face side from the back-face side, and thus, it is possible to transmit the assist torque efficiently. However, depending on the kind of motion (e.g., an object lift-up/lift-down motion) of the user, the second joint portion 252RS and the third link 253RA disposed on the front face of the user may hinder the motion.

In the example of FIG. 50, the second joint portion 252RS and the third link 253RA are disposed on the side face of the user so as to place the position of the third joint portion 253RS on the outer side face of the thigh of the user. In this case, at the time when the assist torque is transmitted, the third joint portion 253RS (the point of effort to which assist torque is applied) disposed on the side face of the user is pressed toward the back-face side from the front-face side or pulled toward the front-face side from the back-face side. As compared to the example of FIG. 49, for example, in the case of an object lift-up/lift-down motion, the second joint portion 252RS and the third link 253RA disposed on the side face of the user are less likely to hinder the motion of the user. However, since the point of effort to which the assist torque is applied is on the side face of the user, the thigh wearing portion 254R worn on the thigh of the user may rotate around the thigh of the user at the time when the assist torque is applied. This may cause a decrease in transmission efficiency of the assist torque.

In the example of FIG. 51, the lower part of the second link 252RA is extended toward the rear side of the user, and thus, the second joint portion 252RS and the third link 253RA are disposed on the back face of the user so as to dispose the position of the third joint portion 253RS on the back face of the thigh of the user. In this case, at the time when the assist torque is transmitted, the third joint portion 253RS (the point of effort to which assist torque is applied) disposed on the back face of the user is pulled from the front-face side toward the back-face side or pressed toward the front-face side from the back-face side, and thus, it is possible to transmit the assist torque efficiently. However, for example, in the case of an object lift-up/lift-down motion, the second joint portion 252RS and the third link 253RA disposed on the back face of the user are less likely to hinder the motion of the user, but may be obstructive at the time when the user sits on a chair or the like.

Various modifications, additions and deletions may be made on the structure, configuration, shape, external appearance, processing sequence, and so on of the assist device of the disclosure without departing from the scope of the disclosure. For example, the processing sequence of the control device is not limited to the flowcharts illustrated in FIGS. 27 to 32. Further, while the example using the spiral spring 45R (see FIG. 19) has been described in the present embodiment, a torsion spring (a torsion bar or a torsion-bar spring) may alternatively be used instead of the spiral spring.

In the assist device 1 described in the present embodiment, an adjuster or a buckle may be used as a belt holding member. The example in which the connection and separation of the belt and the like are performed with the use of a buckle has been described. However, the belt and the like may be connected and separated with the use of a belt holding member different from the buckle. Further, the belt is passed through an adjuster, so as to prevent the pulled belt from being loosened, but a belt holding member other than the adjuster may be used. Further, a belt holding member having functions of the adjuster and the buckle may be used.

In the assist device 1 described in the present embodiment, instructions regarding the assist multiplying factor α and the differential correction gain β are provided from the input portions 33RS. However, the communication unit 64 (see FIG. 24) (configured to perform wireless or wired communication) may be provided in the control device 61 so as to allow the user to set the assist multiplying factor α and the differential correction gain β by communication from a smartphone or the like. Alternatively, the communication unit 64 (see FIG. 24) (configured to perform wireless or wired communication) may be provided in the control device 61, and various data may be collected by the control device 61 and then transmitted to an analysis system at a predetermined timing (for example, constantly, at a predetermined time interval, or after the end of assist operation). For example, the collected data includes user information and assist information. The user information includes, for example, the user torque, the user's posture, and so on, i.e., information about the user. The assist information includes, for example, the assist torque, the rotation angle of the electric motor (the actuator) (an actual motor shaft angle θ_{rM} in FIG. 24), the pivot angle of the output link (an actual link angle θ_{L} in FIG. 24), the assist multiplying factor α, the differential correction gain β, and so on, i.e., information about the input and output of the right and left actuator units. The analysis system is a system provided separately from the assist device, and the analysis system is, for example, an external embedded system, such as a personal computer, a server, a programmable logic controller (PLC), or a computerized numerical control (CNC) device, which is connected via a network (LAN). Optimal setting values (optimal values of the assist multiplying factor α, the differential correction gain β, and so on) unique to the assist device 1 (i.e., unique to the user) may be analyzed (calculated) by the analysis system, and analysis information including the optimal setting values as analyzed results (calculated results) may be transmitted to the control device 61 (the communication unit 64) of the assist device 1. By analyzing the motion of the user, assist force, and so on with the use of the analysis system, an optimal assist torque in consideration of the kind of work (repetition, lifting height, or the like) and the ability of the user can be output. Based on the analysis information (e.g., the assist multiplying factor α and the differential correction gain β) received from the analysis system, the right and left actuator units adjust their own operations (e.g., the right and left actuator units change the assist multiplying factor α and the differential correction gain β to the received assist multiplying factor α and differential correction gain β).

What is claimed is:

1. An assist device comprising:
a body wearing unit configured to be worn on a body of a user including a region around an assist target body part of the user; and
an actuator unit configured to be attached to the body wearing unit and to the assist target body part so as to assist a motion of the assist target body part, wherein:
the body wearing unit includes a main frame having a pivot shaft portion, and a sub-frame connected to the pivot shaft portion and configured to pivot around an axis of the pivot shaft portion; and
the sub-frame is pivotable so as to fit a body size of the user.

2. The assist device according to claim 1, wherein:
the main frame includes a right pivot shaft portion as the pivot shaft portion disposed at a right side of a back side of the user, and a left pivot shaft portion as the pivot shaft portion disposed at a left side of the back side of the user;
the sub-frame includes a right sub-frame connected to the right pivot shaft portion and a left sub-frame connected to the left pivot shaft portion; and
the sub-frame is pivotable so as to fit a width of a waist of the user.

3. The assist device according to claim 2, wherein:
the actuator unit includes a right actuator unit to be worn on the assist target body part at a right side of the user, and a left actuator unit to be worn on the assist target body part at a left side of the user;
the right sub-frame is configured such that a first end portion of the right sub-frame is connected to the right pivot shaft portion and a second end portion of the right sub-frame is provided with a right sub pivot shaft portion;
the right actuator unit is connected to the right sub pivot shaft portion via a right connecting portion configured to pivot around a pivot axis of the right sub pivot shaft portion;
the left sub-frame is configured such that a first end portion of the left sub-frame is connected to the left pivot shaft portion and a second end portion of the left sub-frame is provided with a left sub pivot shaft portion; and
the left actuator unit is connected to the left sub pivot shaft portion via a left connecting portion configured to pivot around a pivot axis of the left sub pivot shaft portion.

4. The assist device according to claim 2, wherein:
the actuator unit includes a right actuator unit to be worn on the assist target body part at a right side of the user, and a left actuator unit to be worn on the assist target body part at a left side of the user;
the right sub-frame is configured such that a first end portion of the right sub-frame is connected to the right pivot shaft portion and the right actuator unit is connected to a second end portion of the right sub-frame;
the right actuator unit is fixed to the right sub-frame without pivoting relative to the right sub-frame;
the left sub-frame is configured such that a first end portion of the left sub-frame is connected to the left pivot shaft portion and the left actuator unit is connected to a second end portion of the left sub-frame; and
the left actuator unit is fixed to the left sub-frame without pivoting relative to the left sub-frame.

5. The assist device according to claim 2, wherein:
the right pivot shaft portion that allows the right sub-frame to pivot relative to the main frame and the left pivot shaft portion that allows the left sub-frame to pivot relative to the main frame are cylindrical dampers each of which is configured to pivot when a load equal to or greater than a load threshold set in advance is input.
